(19) United States
(12) Patent Application Publication
(10) Pub. No.: US 2024/0180204 A1
(43) Pub. Date: Jun. 6, 2024

(54) PODS OF SUPPLEMENTS THAT DISSOLVE IN LIQUID SOLUTIONS AND MANUFACTURING METHODS THEREOF

(71) Applicant: REPS JAPAN Co., Ltd., Onna-son (JP)

(72) Inventors: Zachary Wayne Bell, Okinawa-ken (JP); Alistair James Brock, Okinawa-ken (JP); Fosca Mirata, Mineo (IT); Claire Hoa Levitt, Denver, CO (US); Brooke Alina Wieczorek, Fredericksburg, VA (US)

(21) Appl. No.: 18/401,591

(22) Filed: Dec. 31, 2023

Related U.S. Application Data
(63) Continuation-in-part of application No. 16/666,135, filed on Oct. 28, 2019.
(60) Provisional application No. 62/750,840, filed on Oct. 26, 2018.

(51) Int. Cl. A23L 2/395; A23L 2/40; A23L 2/66; A23L 33/17; A23P 10/25; A23P 10/30; B65D 65/42; B65D 65/46

(52) U.S. Cl. CPC A23L 2/395; A23L 2/40; A23L 2/66; A23L 33/17; A23P 10/25; A23P 10/30; B65D 65/42; B65D 65/463

(57) ABSTRACT

Method of engineering supplement particles to have varying properties, optimally combining the supplement particles with an additive(s) into a formula, and converting the formula into a pod, via compaction or encapsulation; which may be further modified through coating. The pod may be dissolved into a beverage and/or eaten directly.

### PRIORITY CLAIM

This application is a continuation-in-part of U.S. patent application Ser. No. 16/666,135 filed Oct. 28, 2019; which claims the benefit of priority from U.S. Provisional Patent Application No. 62/750,840 filed Oct. 26, 2018, the entire contents of which are incorporated by reference.

### FIELD OF THE INVENTION

The invention described here details methods for engineering supplement particles to have varying properties, which includes nutrients, and converting these particles into pods that can be dissolved into beverages. The invention of this pod is comprised of (a) supplements, with particles of varying properties, (b) combining “a” with additives to create a formula; additives are any particles that maintain the pod's structure, such as imparting cohesion and/or adhesion properties; and/or any particles that aid in regulating dissolution/disintegration of the pod when its placed into a beverage, (c) processes for converting “a” into a pod, or (d) processes for converting “a+b” into a pod, and (e) adding to the outside of the pod, such as a coating, coloring, texts, labels, embossments, films, capsules, capsule components, hard shells, or packaging. Step “c” can stand alone as the invention because it is sufficient to create a pod, with steps “d” and “e” being optional but still part of the invention as they may be necessary. The resulting pod uses compaction and/or encapsulation in a way that allows for the creation of a solid structure (the pod) that is strong enough to be held and manipulated in the hand and/or can withstand a one-meter drop without breaking, while still dissolving/disintegrating (like a bath bomb or effervescent tablet) in a liquid; and/or the pod may be eaten directly, allowing for dissolving/disintegration to occur in the mouth. This is distinct from compacting particles that are (i) nearly uniform in size (those having a normal distribution curve) and (ii) nearly spherical in shape into a pod using known equipment for manufacturing tablets, e.g., pill-presses, molds, and/or punch-and-dies. This application covers the techniques/methods/processes of creating pods for all forms and all types of supplements. The resulting pod remains a solid structure when dry but dissolves/disintegrates and/or forms a suspension when placed into an aqueous solution(s) and/or with other liquid(s). Pods can be made in a range of sizes (volume), weights (e.g., 0.1-25,000 grams), and in any 3-dimensional shape to suit their intended purpose. Pods may also be made and further segmented into smaller units (i.e., smaller pods).

### BACKGROUND OF THE INVENTION

### Tablets

A tablet is a compaction of particles (e.g., powders, granules, and granulated powders) into a larger solid. Compaction is the compression and consolidation of two phases, particulate solid and gas, due to an applied force. Compression is the reduction in the bulk volume of the material (e.g., powder particles) as a result of displacement of the gaseous phase. Consolidation is an increase in the mechanical strength of the material, resulting from particle-particle-interaction. Resulting tablets are commonly used for delivering/dosing an active pharmaceutical ingredient (“API”), normally a medication.

APIs may include health supplements such as those contained in effervescent tablet products, e.g., the Nuun brand (Sports Tablets, Daily Tablets, Immunity Tablets, Energy Tablets, Vitamins Tablets, Rest Tablets), the Berocca brand (Effervescent Tablets with Magnesium, Vitamin C, B12, and Vitamin B Complex; Orange, Vitamin C), the Higher Nature brand (e.g., Fizzy Effervescent Multivitamin), the Pharmaton brand (Advance Fizz Multivitamins and Minerals With Ginseng), the Tonic brand (High Strength Multivitamin With Vitamin C, Vitamin D, Zinc and Reishi), the Swiss Energy brand (Kids Multivitamin+Calcium), the Voost brand (Multivitamin Effervescent Tablets), the Boots brand (Multivitamin Effervescent Tablets), the Natures Aid brand (Daily Multivitamin Effervescent), the Mivolis brand (Multi-Mineral, Multivitamin, Vitamin C, Vitamin D3, Iron+Vitamin C, Magnesium, Calcium Vitamins), the Vita HEIM brand (Multivitamin—Orange, Vitamin C—Lemon, Vitamin C+Zinc—Lemon, Calcium+Magnesium+Vitamin D—Grape), and the Phizz brand (Phizz Electrolyte Multivitamin Rehydration Tablets).

There are a variety of tablet categories, including: uncoated, coated, dispersible, modified release, enteric coated, prolonged release, soluble, tablets that are for mouth use (e.g., buccal and sublingual), implantable/other route (e.g., rectal or vaginal tablets), and effervescent.

Tablets meant for swallowing tend to be capsule shaped (i.e., oblong) to ease swallowing, opposed to consolidating the volume into a spherical shape. According to one resource, a recommended suitable dimension for a tablet meant for swallowing should be less than 21 mm, which is the sum of length+width+depth. (Kabeya et al., 2020. Threshold Size of Medical Tablets and Capsules: Based on Information Collected by Japanese Medical Wholesaler.) If the tablet needs to exceed this size, the tablet should be split or designed into a dissolvable tablet, e.g., an effervescent tablet, which is meant to be dissolved in water and drunk. Regardless, tablets meant for swallowing or dissolving are compacted in similar ways.

In many cases, APIs are required by the body in small amounts and require accurate dosing to be effective. APIs are commonly manufactured into small particles (powders or granulated powders), and compacting them into tablets resolves the issue of handling small amounts of loose particles, and allows for accurate dosing. API particles are commonly combined and mixed/blended with other ingredients (e.g., excipients) prior to tableting the final drug formula. The purpose of excipients include, but are not limited to, (a) stabilizing the API, (b) providing adhesion of the various types of particles or cohesion of similar particles, e.g., a binder/binding agent, (c) bulking up the solid formula given the small amounts of APIs required, e.g., a bulking agent, a filler, or a diluent, (d) allowing the tablet to achieve a desired volume, (e) providing therapeutic enhancement on the API in the final dosage form, e.g., facilitating absorption, reducing viscosity, or enhancing solubility, (f) improving handling during the manufacturing process, e.g., facilitating powder flowability and non-stick properties and reducing dusty conditions, (g) preventing denaturation of the API, (h) preventing aggregation of the API over the expected shelf life, and (i) optimizing dissolution and/or disintegration rates of the tablet.

### Particle Processing

The traditional method of compressing particles as part of the manufacturing process of tablets is well known. A key part of the process is creating a specific particle size range, which may be achieved through milling larger particles (e.g., powders, granules, slugs) into smaller ones, or granulating smaller particles into larger ones. Common tablet compression manufacturing processes/methods include wet granulation, dry granulation, and direct compression.

Granulation is the process of creating larger granules from smaller particles (e.g., powders). This process removes most of the fine particles (e.g., dust). Granules, generated from granulation, are clusters of individual particles. Thus, granules are larger in size/volume than the individual starting particles. Granulation is performed on the blended/mixed formula. A formula may consist of multiple ingredients (e.g., API(s)+excipient(s)), but may also consist of a single ingredient (e.g., one API). The formula prior to granulation typically excludes any lubricants.

The final formula is granulated, which achieves similar sized particles and similar shaped particles (e.g., nearly spherical in shape); results in a normal distribution curve with respect to particle size. This near uniformity in particle size provides several benefits, for example, improving the manufacturing process, e.g., flowability, compressibility, and API consistency. According to one resource ((https://thomasprocessing.com/how-tablets-are-manufactured/), wet granulation, dry granulation, and direct compaction are described as follows:

1. Wet Granulation

Wet granulation steps typically include:
Weigh, mill, and blend APIs with powdered excipients.
Prepare the binder solution.
Mix binder solution with powders to create a damp mass.
Wet screen the dampened powder into pellets or granules using a mesh screen.
Dry the moist granules.
Use dry screening to size granulation.
Mix/Blend the dried granules with lubricant and disintegrants.
Compress the granules into tablets.

Various types of equipment may be used for wet granulation, for example, fluidized bed granulator, planetary mixer granulators, rotating shape granulators, rotary fluid-bed processor, mechanical agitator granulators, dry granulators, high-shear granulators, and rapid high shear granulator.

2. Dry Granulation

Dry granulation is suitable for formulas sensitive to moisture or heat and can be used if the formula has sufficient binding properties without the need for a binding agent/binder. Steps typically include:
Weigh and mill formula ingredients, e.g., APIs and excipients.
Blend the milled powders.
Compress the blended powders into slugs.
Mill and sieve the slugs.
Compress the resulting granules into tablets.

3. Direct Compression

Direct compression, unlike wet and dry granulation, requires no modification to physical properties and steps typically include:
Mill API(s) and excipients.
Mix the milled powders, disintegrants, and lubricants.
Compress the tablets.

The mixing step for all three methods may require melting the API(s) with the proper biocompatible polymers/excipients (e.g., such as in hot melt extrusion method) into pellets or granules, which are then resized (e.g., milling and/or granulating) to the appropriate size particles required for tablet compaction.

### Particle Size Distribution

Particle size distribution (“PSD”) is important to assess when making tablets. PSD represents the relative amount of particles present in a sample according to size/size range. Size may include diameters for more spherical shaped particles or vertical and horizontal projections for irregular shaped particles. The particle size ranges (also called layers, intervals, size classes, bins, sections, and fractions) will vary depending on the particle size analysis method/analyzer being used. The PSD may be represented in multiple ways depending on the method used, e.g., as a percent of volume, bulk volume, volume fraction, volume distribution, weight, particle number, total particles, frequency, frequency volume weighted, cumulative distribution, differential distribution, probability density, probability, area, weight intensity, and/or particle concentration, although others may exist. Examples of particle size characterization analysis methods include number-based distributions (e.g., Dynamic Image Analysis), mass-based (e.g., Sieve Analysis and cumulative PSD), volume-based PSDs (e.g., Laser Diffraction), intensity-based (e.g., Dynamic Light Scattering), and other direct, indirect, and scanning methods.

PSD commonly references three values: D50, D90, and D10. The D50 is the median diameter, or the medium value, in a PSD and is the value of the particle diameter at 50% in the cumulative distribution. The D90 in the distribution is where 90% of particles are smaller, 10% of the particles are larger. The D10 in the distribution is where 10% of particles are smaller, 90% of the particles are larger. D90/D10 equals the PSD, and a higher value is considered wider, whereas a lower value is considered narrow. The role of initial particle size in the compaction process is known in the industry. Particle size is known to influence flowability, tabletability, content uniformity, tablet weight variation, drug release, and dissolution properties. In the pharmaceutical industry, and in the food industry, it is difficult to maintain an even mixture/blend when particles vary in physical properties, e.g., size, which results in the phenomenon known as granular convection, or the Brazil Nut Effect. One method for maintaining a relatively homogeneous particle size (with a normal distribution curve in a PSD) is to granulate the final formula, which results in granules that are nearly uniform in particle size and shape. PSD analysis has historical significance as it is an important parameter for FDA process validation, namely, a narrower normal distribution curve results in more products that will meet the particle size specifications for the formula and bioavailability. Accordingly, there is a strong historical and industry emphasis on using homogeneous particles (minimizing finer and coarser particles) when compacting particles in tablet production.

There is no typical particle size used in tablets, particularly for effervescent tablets. Historically, tablets are made by grinding down the ingredients (trituration) into fine particles using a mortar and pestle, although exact particle sizes are rarely cited. Both historical application and industry teaching emphasizes the value of a narrow PSD. In other words, although the average and/or median and/or mode particle size may be found to vary between samples, the PSD should be normally distributed (show a normal distribution curve) for a sample being prepared for tableting and thus should have a homogeneous particle size and shape (e.g., sphere shaped). It is also known that compacting uniform particles (shape and size) results in straighter paths of water penetration compared to compacting non-uniform particles, which results in preferential paths for water penetration. This is important to consider for tablets as they dissolve/disintegrate.

### Effervescent Tablets

When an effervescent tablet is put into water, it sinks and dissolves, releasing gaseous carbon dioxide. Such tablets dissolve well in water because they contain an organic acid(s) and (bi)carbonate salt(s) (i.e., effervescent ingredients or Seidlitz powder), two chemicals that react to produce gaseous carbon dioxide (the effervescent effect), which in turn aids in the dissolution/disintegration of the tablet into a suspension/solution. Effervescent tablets may also be formulated to produce oxygen gas and hydrogen gas, although carbon dioxide is the more common type. The chemical reaction between an organic acid and (bi)carbonate salt is as follows: organic acid+(bi)carbonate salt→salt+water+carbon dioxide.

In general, the APIs and excipients used in effervescent tablet formulas should be water soluble. The contents of these tablets are meant to be consumed by drinking Benefits to effervescent tablet products include solution uniformity, rapid delivery of benefits, stable environment, convenience, well tolerated, lighter environmental footprint compared to liquid versions, and fun/entertaining for the user. One additional benefit, related to solution uniformity, is that effervescent ingredients forcefully disperse the other formula ingredients in the tablet, which reduces particle clumping. Clumping in solution is considered undesirable and occurs in non-effervescent tablets and/or tablets not containing suitable dissolution agents/disintegrants/dispersants. Clumps are clusters of particles not well dispersed/dissolved in the solution, which may even be made up of dry particles that are undesirable to chew or swallow whole.

Effervescent tablets are particularly useful in the following circumstances:
an API needs to be consumed orally as a liquid for proper absorption;
an API requires rapid onset of action (e.g., analgesics);
a standard medicine tablet is difficult to digest;
a standard medicine tablet induces stomach or esophageal irritation (e.g., aspirin);
an API is moisture sensitive;
an API is pH sensitive;
if users have trouble swallowing tablets whole;
if users want a more enjoyable method compared to swallowing tablets; and
if an API requires a large dose that would require swallowing multiple tablets.

Effervescent tablets may include a variety of excipients, but the two main types producing the effervescent effect are acid(s) and bicarbonate salt(s)/carbonate salt(s), for examples as follows:
Acids: may include citric acid, Citrocoat® N, ascorbic acid, malic acid, fumaric acid, tartaric acid, succinic acid, adipic acid, lactic acid and acetic acid.
Bicarbonate salts/carbonate salts: may include sodium bicarbonate, sodium carbonate, sodium sesquicarbonate, potassium carbonate, potassium bicarbonate, potassium sesquicarbonate, magnesium carbonate, magnesium bicarbonate, calcium carbonate, ammonium bicarbonate, and ammonium sesquicarbonate.

Additional chemicals used in effervescent tablets may include magnesium oxide, magnesium sulfate dihydrate, zinc citrate trihydrate, calcium pantothenate, potassium chloride, carbonate chloride, lactate, gluconate, citrate, anhydride and salts of acid.

Effervescent ingredients (e.g., acids and bicarbonate salts/carbonate salts) are sensitive to water, and thus all methods and processes minimize use of water and/or contact with water.

Effervescent tablets are commonly sold as a flat cylindrical-shape/puck-shape/disk-shape and are of sizes meant for dissolving in a glass and/or cup and/or bottle with a large-mouth opening and are not small enough to fit into the opening of a standard single-use PET bottle, such as bottled water (e.g., those with a diameter of ˜20 mm) This common size used across industries (pharmaceuticals, Over-The-Counter drugs, and supplements), suggests the commercially available equipment for manufacturing effervescent tablets is limited and other tablet shapes are unavailable from contract manufacturers, i.e., those companies who can manufacture at scale and at the most competitive price.

Methods used to achieve higher effervescent tablet solubility often include:
the inclusion of more effervescent ingredients (although this may negatively impact flavor);
using more soluble bicarbonate salt/carbonate salts, e.g., using potassium bicarbonate in place of sodium bicarbonate;
increasing the ratio of acid to bicarbonate salt/carbonate salt in order to drive the reaction more vigorously;
adding wicking materials, e.g., microcrystalline cellulose and/or soy polysaccharides, to help bring water into a tablet where it can make contact with the effervescent ingredients more rapidly;
decreasing the amount of particles compacted, i.e., reducing the density of the tablet; and/or
increasing particle size of the powder being compacted, while maintaining a narrow PSD with a normal distribution curve.

There is a wide range of variability in effervescent tablet dissolution/disintegration rates. For example, assuming room temperature tap water, see the following:
a whole Alka-Seltzer Antacid tablet, containing aspirin, dissolves in less than 1 minutes;
a whole Nuun tablet, containing water soluble supplements like micronutrients and/or a carbohydrate source, dissolves between 3.5 and 10 minutes; and
a whole Organika tablet, containing hydrolyzed collagens (i.e., peptides, not a protein), dissolves in 15+ minutes.

All of these tablets sink in water, and are thus denser than water Sinking to the bottom likely improves solubility rate as it provides more surface area for the water molecules to interact with on the tablet. After a majority of the effervescent tablet dissolves, the last bit may float to the surface to finish dissolving.

Effervescent tablets contain varying percentages of effervescent ingredients (acids and bicarbonate salts/carbonate salts). For example, see the following:
Drug formulas were found to contain 71.2% and 81.3% effervescent ingredients with 1.4% and 12.7% of the API, respectively. (See, e.g., Jacob S, Shirwaikar A, Nair A. Preparation and evaluation offast-disintegrating effervescent tablets of glibenclamide. Drug Dev Ind Pharm. 2009 March, 35(3):321-8. DOI: 10.1080/03639040802337021. PMID: 18821151; DOI: 10.35629/7781-070419491971, Volume 7, Issue 4 July-August 2022, pp: 1949-1971; Mishra et al. Formulation and Evaluation of Effervescent Tablets Paracetamol)
A drug formula containing Aspirin was found to be as high as 61% and 25% effervescent ingredients. (See, e.g., WO2015061521A1; Jon Merrills BPharm, BA, BA (Law), FRPharmS, Jonathan Fisher BA, LLB (Cantab), in Pharmacy Law and Practice (Fifth Edition), 2013)
Nutraceutical formulas were found to contain 50-70% effervescent ingredients while maintaining 1.1% of the API. (See, e.g., Surini et al. Evaluating of effervescent tablets containing grape seed (Vitis vinifera L.) extract as a nutraceutical. International Journal of Applied Pharmaceutics. 2017, 9:150. DOI:10.22159/ijap.2017.v9s1.76_83)
Electrolyte formulas were found to contain 13-23% effervescent ingredients, with highly water-soluble carbohydrates (glucose, glucose polymer, and sucrose) being 71.2%-83% of the formula. (See, e.g., US20070059362A1)

### Supplement Particles

Supplement particles or simply “supplements” (commonly called supplement powders) are consumed for a variety of reasons, including (i) for health, (ii) as complementary and/or alternative medicine, (iii) as medications/pharmaceuticals/over-the-counter drugs and biologic drugs, (iv) to enhance performance/act as an ergogenic aid (e.g., for muscular growth and/or strength; creatine and anabolic steroids; to improve aerobic and/or anaerobic capacity), (v) for functional effects/need states (e.g., improved sleep and/or relaxation, and/or decrease pain and/or decrease anxiety levels), (vi) to supplement a diet (e.g., dietary supplements/nutritional supplements/food supplements, which may include proteins, amino acids, carbohydrates, nucleic acids, vitamins, and minerals), (vii) to substitute a meal (e.g., baby formula, instant formula, or meal replacement formula), or (viii) to make it easier to consume whole foods and beverages that have been dried and converted (e.g., via grounding or milling) into particles such as powders and granules (e.g., vegetable powders, animal derived powders such as muscle and connective tissues, insect powders, and bone powders). Supplements/supplement particles are commonly sold in dry forms such as powders, granulated powders, pellets, meal, nanopowders, nanoparticles, micropowders, microparticles, crystals, fibers, flakes, freeze-dried emulsions, and emulsions/micelles/liposomes/pro-liposomes that may have been cross-linked and freeze dried, although other forms exist. Collectively, “supplements” may include dietary supplements/nutritional supplements/food supplements/nutrients (those that supplement the diet, including macronutrients and micronutrients), sports nutritional supplements/sports supplements (those that aid in performance or act as an ergogenic aids), and health supplements (for treating diseases or supporting health, e.g., herbal supplements, hydration supplements, and weight management supplements). These dry forms of supplements may be solubilized in liquid forms and used in a liquid, hydrogel, or gel type formats as well. In addition, some supplements that commonly exist in liquid forms, such as oils, can be converted into dry particles e.g., powders, granulated powders, and pellets. Supplement particles meant for consumption in small quantities are commonly sold in pill format, such as capsules, soft gels, and tablets. Similar to APIs in medication formulas, supplements can be formulated and compacted into effervescent tablets.

Supplement particles, particularly nutrient-containing particles (e.g., whey protein, soy protein, baby formula, meal replacement powder, and weight gainer powder), are commonly mixed into a beverage of choice and consumed to supplement a diet or to add calories to an existing diet. Supplement particles may also be dissolved in liquids and used for non-human organisms (e.g., nonhuman animals, plants, and microorganisms) consumption.

Regarding bulk supplements, these are supplement powders sold as loose powders and are commonly mixed into a beverage/water and consumed. Bulk supplement powders may also be dissolved in liquids and used for consumption by animals, plants, and other organisms. Such powders are often sold direct-to-consumer in large quantities (e.g., 500 g-5 kg) within bulk packaging like bags and plastic containers. These powders are consumed in grams at a time, opposed to milligram pills.

Bulk supplement powders are readily available for purchase from stores and e-commerce websites, but have several drawbacks, including the following:

Clumping. Supplements with low solubility require vigorous mixing to avoid clumping.

The common method of consuming bulk supplements particles is to add the supplement particles to a solvent/liquid (e.g., water), and vice versa, within a standard shaker bottle (FIG. 19), secure the lid, then shake the bottle to mix the contents. Unfortunately, many commercial bulk supplements, such as protein powder (e.g., whey, casein, soy, hemp, and pea), are not highly soluble in water, and even with vigorous agitation the powder still has the tendency to clump in the water. Clumping may occur for several reasons, with one example being when the particle size of the powder is too fine, resulting in trapped air space that does not easily become hydrated.

When a new bag/container of bulk supplement powder is opened, moisture can enter the packaging, which is especially true if the packaging is not resealed well. This can result in the bulk supplement powder sticking together, resulting in clumps. This also results in reduced shelf life. In addition, when many bulk supplement powders (e.g., protein powders) are mixed with a beverage, clumps form in the beverage due to poor solubility of the bulk supplement powder. The clumps in suspension can be eaten but stick to the teeth. Clumping also occurs in the corners and sides of the mixing vessel (e.g., cup/glass/shaker bottle/blender); and on any objects used to improve mixing, such as a spoon or a whisk ball. When mixing bulk supplement powders, cold water typically increases clumping, while warmer water typically decreases clumping due to improved solubility. In general, clumping is the result of the bulk supplement powder sticking together, and not dispersing into solution. This is especially true for fine powders, which are more clumpy, contrary to them having more surface area compared to larger particles. Further, many proteins undergo high heat during the manufacturing process (e.g., drying the powder and granules), and this heat denatures the protein from its native state, often resulting in protein particles that are no longer as water soluble.

Methods to combat clumping include using a whisk ball to break up the floating clumps (although ineffective against clumping on the walls of the container), using warmer water to increase soluble (although this results in a less palatable final product), using a utensil (e.g., spoon, fork, knife, chopstick) and using an electric mixer (inconvenient for on-the-go use and the cleanup is timely).

Messiness and sticky hands. When scooping a bulk supplement powder (using the scoop tool) out of the bulk packaging and into a mixing vessel (e.g., cup/glass/shaker bottle/blender), the loose powder is easily split (accidental spillage), resulting in a mess. In addition, the scoop tool itself commonly has powder stuck to the handle or the scoop tool is buried within the powder, meaning the user has to dig around to find it. Thus, resulting in a power sticking to the hands. Supplement powders easily aerosolize in breezy conditions or during preparation resulting in an obvious mess, but also economic implications of lost protein for the consumer, and adding wasted materials to the carbon footprint of humankind. In addition, spilling powder means difficulties in tracking the dietary intake.

Inconsistent serving sizes. Bulk supplement powders, such as protein powders, will recommend on the packaging to take one to two scoops as a serving size, which serve as the basis of the nutritional facts printed on the packaging. Unfortunately, how a user measures a scoop will vary, meaning the serving size will vary. For example, a scoop tool can be used to scoop out a heaping scoop of powder, a level scoop of powder, and/or a packed scoop of powder. Although measuring the weight of the scoop can improve consistency in measuring an accurate serving size, measuring out an accurate serving size is hard if only using the scoop tool. Consistency and accuracy are especially important when strict servings (or dosings) are required, such as when using health supplements or complementary/alternative medicine powders and/or people on strict diets (e.g., bodybuilders and other athletes).

Standard bulk packaging format makes it difficult to use supplements on-the go, and takes up a lot of storage space. An example of a popular bulk supplement powder is protein powder. Protein powders are commonly sold as protein concentrates, protein isolates, protein hydrolysates, and may even be broken down further into peptides. Animal derived proteins may include whey protein, whey protein isolate, whey protein concentrate, whey protein hydrolysate, milk protein, infant formula, casein protein, egg white protein, egg protein, insect derived proteins (e.g., roaches, earthworms, fruit flies, grasshoppers, crickets, hornworm, black soldier flies), shellfish derived proteins (e.g., molluscs and crustaceans), echinoderm derived proteins, collagen, collagen peptides and combinations of these. Plant derived proteins may include soy protein, soy protein isolate, soy protein hydrolysate, pea protein, hemp protein, brown rice protein, rice protein, and combinations of these. In addition, protein powders are commonly blended/mixed with other types of bulk supplement formulas such as meal replacement powders, meals-ready-to-eat (MRE) powders, weight gainer powders, weight loss powders, pre workout powders, intra workout powders, creatine powders, and post workout powders.

Protein powder is widely used by health enthusiasts, athletes and the aging populations as an easily digestible source of protein. This powder is normally sold in bulk to consumers (i.e., bulk supplement powder), typically 500 grams to 5 kilograms per package. It is most commonly sold in cylindrical containers or bags, making personal transportation a burden. Consumers are thus forced to carry powder in smaller sizes for travel or use at the gym (e.g., putting it into a smaller container or little baggies). Such methods can become problematic at an airport or border crossing (the powder may appear as an illegal substance to security officers). Shaker bottle companies have made attempts in recent years to address this problem by adding a smaller chamber that screws onto the bottom of the shaker bottle for holding pills and powders; however, the contents of the chamber are still easily split (accidental spillage), namely, when unscrewing the smaller chamber from the shaker bottle. Another problem with bulk packaging is that there are a variety of protein powder types, and thus to sample a protein powder means a user must invest in half a kilogram or more of the powder (albeit a small number of companies are now selling single serving packets for select flavors). A common serving size for protein powder is 20 grams. It would be challenging, if not impossible, for a human to consume a 20 gram swallowable tablet, which excludes the additional excipients needed in tableting. Converting this into multiple tablets (e.g., 20 one-gram tablets) would likely have low compliance as it would require swallowing a lot of tablets. Furthermore, protein powders are more easily digested when consumed as a dissolved/disintegrated beverage opposed to a solid tablet that requires dissolving inside the body. Such bulk supplement powders, like protein powder, may be infused into foods, snacks, beverages, ice creams, jellies, gummies, bars, and added to sachets and ready-to-drink (RTD) containers. RTDs and sachets are especially easier to consume on-the-go as compared to making a traditional supplement powder shake and are becoming commercially available in select countries. Another type of product is the single use protein powder bottle that only requires the addition of powder.

### Supplement Particles

The drawbacks associated with handling and consuming bulk supplement powders are numerous, e.g., powder clumps, it is messy and makes your hands sticky, serving sizes are inconsistent, hard to sample bulk supplement powders since they are sold in bulk, and the bulk packaging format makes it challenging to take on-the-go. One solution is to convert the supplement powders into tablets. However, given that serving sizes are large (e.g., 20 grams of protein powder per serving) would require either one large tablet (impossible to swallow) or many small tablets (e.g., 40×five-hundred-milligram tablets) which may also become difficult to swallow after a few. The ideal solution would be a large tablet that dissolved in beverage/water, creating a single serving drink. One tablet technology that dissolves well is the effervescent tablet, but these are normally small (e.g., <5 g), densely compacted, and contain a high percentage of additives/excipients like effervescent ingredients.

Tablet compaction technologies currently used teach and recommend using particles that are homogeneous in physical properties, namely, size and shape. For example, combining ingredients into a formula is typically followed by a granulation step to create a nearly uniform particle size (normal distribution curve), and a nearly spherical shaped particle, which is considered ideal for tablet compaction. What currently does not exist is a method of engineering supplements particles that vary in size (non-uniform particle size), among other physical properties (e.g., shape), to facilitate an improved compaction and/or encapsulation of a formula to produce large effervescent tablets (relative to the standard size). Such a large effervescent tablet may be referred to as a pod, rather than a tablet, since tablets have the connotation of being small compactions. Ideally, an existing bulk supplement and/or formulated bulk supplement, such as a flavored protein powder, could be converted into a pod that attempts to maintain the original taste and flavor of the starting protein powder. Such a pod would need to contain minimal additives, minimal additional calories, and/or other ingredients that could alter the organoleptic profile of the original bulk supplement powder. Furthermore, such a pod would dissolve/disintegrate in a beverage (e.g., water), and/or even be edible.

### SUMMARY OF THE INVENTION

Using supplements is associated with a variety of drawbacks including messy to use, form clumps when mixing in water, the scoop tool results in inconsistent serving sizes, and supplements are hard to take on-the-go due to the common bulk packaging format. The present invention seeks to address these issues by incorporating supplement particles (e.g., protein powder) into large effervescent tablets or pods. As outlined above, using conventional methods of making effervescent tablets results in pods that taste bad once dissolved in water. This is due in part because the effervescent ingredients necessary for making an effervescent tablet (organic acids and bicarbonate salts/carbonate salts) produce a bad taste in combination with protein powders. The amount of effervescent ingredients may be reduced in an attempt to preserve the original flavor and taste, but the tablet then no longer dissolves well. Conventional methods require enough effervescent ingredients to dissolve the tablet. The amount of effervescent ingredients needs to be increased as pods are made larger than 10 grams in size. Thus, there is a need to discover a way to create pods, especially ones exceeding 10 grams, that dissolve/disintegrate well with reduced effervescent ingredients.

The present invention incorporates the novel and nonobvious method of varying particle size of the supplement (e.g., protein powder), which results in a highly soluble pod that withstands a one meter drop without catastrophic failure. Such engineered powder also allows for compaction/encapsulation at lower densities. Pods with lower densities dissolve/disintegrate faster, which means less dissolution agents (e.g., effervescent ingredients) are required to dissolve/disintegrate the pod. Using less dissolution agents in the pod means less negative effect on flavor and taste.

The present invention describes engineering supplement particles to create more varied physical properties (e.g., size) and converting the particles into pods via compaction and/or encapsulation. The supplement particles may be combined with additives (e.g., dissolution agents) to create a formula which is then converted into the pod. These engineered supplement particles create a pod that dissolves/disintegrates faster in a liquid (or the mouth), while maintaining strength, as compared to not engineering the supplement particles. The present invention teaches at least three methods to generate supplement particles with more varied properties as a precursor to compaction and/or encapsulation:
Layer removal method—The removal of a layer(s) of particles, with the purpose of creating a gap within the PSD. Layers may also be called fractions, particle ranges, particle size range, sections, size intervals, or size classes. A layer can be completely removed or partially removed.
Combination method—The combining of at least two particle samples to achieve a new sample, which results in a (i) bimodal or a multimodal PSD and/or (ii) more skewed PSD, for example, a positively skewed PSD.
Redistribution method—The (i) removal (of all or a portion) of at least one layer of particles within a sample, (ii) resizing the particles from that one layer of particles, and then (iii) adding the resized particles back to the sample. Resizing may be increasing and/or decreasing the particle size.

Once supplement particles of varying physicalproperties are engineered, the supplements particles, in solid forms (e.g., powders, granules, pellets, dust, crystals, flakes, fibers) and/or liquids (e.g., pre-dissolved solid forms), may be formulated further with additives (e.g., effervescent ingredients), and/or can be compacted or encapsulated into a pod. Pods reduces messes and wastes during handling, while being soluble (related to dissolving/disintegrating/dissociating) in liquid solutions, with or without agitation from a mixing tool (e.g., spoon, fork, or knife) and/or shaking in a closed container (e.g., shaker bottle). The invention of this pod is comprised of (a) supplements, with particles of varying properties, (b) combining “a” with additives to create a formula; additives are any particles that maintain the pod's structure, such as imparting cohesion and/or adhesion properties; and/or any particles that aid in regulating dissolution/disintegration of the pod when its placed into a beverage, (c) processes for converting “a” into a pod or (d) processes for converting “a+b” into a pod, and (e) adding to the outside of the pod, such as a coating, coloring, texts, labels, embossments, films, capsules, capsule components, hard shells, or packaging. Step “c” can stand alone as the invention because it is sufficient to create a pod, with steps “d” and “e” being optional but still part of the invention as they may be necessary. The resulting pod allows for the creation of a solid structure that is strong enough to be held and manipulated in the hand and/or withstand a one meter drop without breaking, while still being able to readily dissolve/disintegrate (like a bath bomb or effervescent tablet). This description of supplement particle engineering for manufacturing pods is distinct from simply compacting supplements and excipients into tablets using known devices (e.g., pill-press, punch-and-die, or mold), as is typically found in industry (e.g., nutritional supplement industry, dietary supplement industry, effervescent tablet industry, and pharmaceutical industries) for compacting powders. This application covers the methods of creating pods for all forms of supplements.

Accordingly, the present invention overcomes significant problems with the prior art, in at least the following ways.

First, effervescent ingredients (e.g., organic acids and bicarbonate salts/carbonate salts) negatively impact the original flavor of a supplement. This is especially true for protein powders and meal replacement powders. Flavor is important for finished bulk supplement powders (formulated, and ready for sale), evidenced by the variety of flavors available to consumers (e.g., chocolate, vanilla, coffee, and a variety of fruits (strawberry, shikuwasa, yuzu, mango and pineapple)). The present invention allows the original flavor of the supplement to be minimally affected following compaction/encapsulation into a soluble pod.

Related to flavor, a majority of effervescent tablets are made with additional ingredients, a majority of which contribute to the effervescent effect and/or are ingredients used as excipients to improve the reaction and solubilize the tablet. Pods are different as they are made using a majority of the supplement (protein powder) with minimal effervescent ingredients/other additives.

Second, there is a high manufacturing cost associated with compacting/encapsulating bulk supplement powders into pods. Many supplement powders are sold ready to mix into a drink, and adding any additional manufacturing step (e.g., compaction and/or encapsulation) would increase the costs. This is especially true when considering the custom manufacturing equipment required for pods since existing tablet compression equipment is for smaller tablets. In addition, use of additives increases costs. The present invention allows improved compaction/encapsulation due to a more varied particle size, but at a cost.

Third, many supplement powders, such as protein powders, form colloids/suspensions and are not fully dissolved in water. Because of the poor solubility as a powder, compacting this powder directly into a standard tablet results in a near insoluble product. By varying particle physical properties, such as size (i.e., varying particle size), the present invention reduces solubility problems. One way solubility is improved is that pods require less dense compactions (compared to standard tablets), which have more spaces for water to penetrate into the pod's outer surface, which is especially beneficial if the pod contains effervescent ingredients which react in the presence of water. This can be further enhanced by adding particles that have wicking effects. In addition, less dense means the particles have less contact with one another resulting in less bond formation. Thus, as pods hydrate, the particles dissolve/disintegrate outward and into the water, not forming clumps.

Fourth, supplement powders that are commonly converted into tablets, such as vitamins and minerals, are dense. These are meant for swallowing and are hard enough to stand up to the rough handling during manufacturing, packaging, and shipping processes. Effervescent tablets are also dense. Supplements, especially formulated supplements containing fruit bits and seeds, contain particle sizes larger than one millimeter. With respect to standard tablets, it is known that when particle size is larger, compaction force requirements are higher. This reduces the disintegration and/or dissolution rates of particles within the tablets. This is one of the reasons particle size is kept below one millimeter in standard/effervescent tablets because the force to compress would be so high that the tablet would not dissolve well. The present invention allows for compacting at low densities (e.g., pods that float in water), which aids in dissolution/disintegration, and is optimized through combining with a gentle manufacturing process and/or additive(s) and/or coating. and can handle particle sizes larger than one millimeter.

Related to density, as the volume (size) of a compaction (tablet or pod) increases so may the force required to make the compaction. One difference between the tablet and pod is the slope of the line, with Volume on the x-axis and Force on the y-axis, with the pod having a smaller slope (less steep) compared to a tablet. Thus, further explaining that pods are less dense than tablets, and that pods scale up in volume (size) differently compared to tablets.

Fifth, current effervescent tablets are small. The mold designs are universal and cannot be used to make pods, which are much larger.

Sixth, effervescent tablets, or oral dissolving tablets, are not meant to be eaten, but rather dissolved/disintegrated and drunk as a liquid. Pods can be eaten and/or drunk (following dissolution/disintegration) using the same formula.

Seventh, the current scoop tool, which is included with most bulk supplement powders, cannot be used alone as an accurate measuring device. The scoop tool is meant to produce a relatively similar serving size, but it will vary depending on how the tool is used. Pods are designed to provide the same, consistent dose/serving size.

### BRIEF DESCRIPTION OF THE DRAWINGS

Preferred and alternative examples of the present invention are described in detail below with reference to the following drawings:

FIG. 1: Illustrates a layer removal method to create a gap in the PSD

FIG. 2: Illustrates a layer removal method to create a gap in the PSD

FIG. 3: Illustrates a combination method to create a bimodal or multimodal PSD

FIG. 4: Illustrates a combination method to create a bimodal particle distribution that varies in at least one physical property (e.g., size)

FIG. 5: Illustrates a redistribution method to create a wider PSD from a narrow PSD by decreasing the particle size homogeneity

FIG. 6: Illustrates a redistribution method to generate particles that vary in at least one physical property (size)

FIG. 7: Illustrates a process of using the compaction method to manufacture a compacted pod comprising at least one type of particles, which vary in at least one physical property

FIG. 8: Illustrates a process of using the compaction method to manufacture a compacted pod comprising at least one type of supplement particles, which vary in at least one physical property, and at least one additive

FIG. 9: Illustrates a process of using the encapsulation method to manufacture an encapsulated pod comprising at least one type of particles, which vary in at least one physical property

FIG. 10: Illustrates a process of using the encapsulation method to manufacture an encapsulated pod comprising at least one type of supplement particles, which vary in at least one physical property, and at least one additive

FIG. 11: Illustrates a process of using the compaction method followed by the encapsulation method to manufacture an encapsulated-compacted pod comprising at least one type of particles, which vary in at least one physical property

FIG. 12: Illustrates a process of using the compaction method followed by the encapsulation method to manufacture an encapsulated-compacted pod comprising at least one type of supplement particles, which vary in at least one physical property, and at least one additive

FIG. 13: Illustrates a process of using the segmentation method to manufacture a segmented pod comprising at least one type of particles, which vary in at least one physical property

FIG. 14: Illustrates a process of using the segmentation method to manufacture a segmented pod comprising at least one type of supplement particles, which vary in at least one physical property, and at least one additive

FIG. 15: Illustrates a process of using the segmentation method followed by the encapsulation method to manufacture an encapsulated-segmented pod comprising at least one type of particles, which vary in at least one physical property

FIG. 16: Illustrates a process of using the segmentation method followed by the encapsulation method to manufacture an encapsulated-segmented pod comprising at least one type of supplement particles, which vary in at least one physical property, and at least one additive

FIG. 17: Illustrates a process of combining the segmentation method and encapsulation method to manufacture a semi-encapsulated-segmented pod comprising at least one type of particles, which vary in at least one physical property

FIG. 18: Illustrates a process of combining the segmentation method and encapsulation method to manufacture a semi-encapsulated-segmented pod comprising at least one type of supplement particles, which vary in at least one physical property, and at least one additive

FIG. 19: Illustrates making a protein shake from protein powder and water

Demonstrates how to make a standard protein shake. Starting with an open protein powder container and a shaker bottle with the top removed, a full scoop of protein powder is removed from the container and added to the shaker bottle, which results in some accidental spillage. Water is then added to the shaker bottle and the lid is screwed on. The bottle is then shaken to mix the protein powder with the water, resulting in partial dissolution/disintegration of the protein powder along with remaining undissolved/undisintegrated clumps of protein powder.

FIG. 20: Illustrates making a pod

Pods may be created from the compaction of supplements. First, the supplement type(s) is selected, e.g., a nutrient that may be in the form of a micro/nanoemulsion(s), micelles, powder(s), granule(s), pellet(s), and/or liquid(s), and in any combination of these. Second, the nutrient is mixed/blended with at least one additive (e.g., a pod-ingredient). Note that heat can be applied to the formula at this step. Third, the formula is packed into a mold and pressure (e.g., including, but not limited to, mechanical pressure, vacuum pressure, air pressure, and/or electrostatic pressure) is applied to compact the formula into a pod. Fourth, drying and/or solvent removal (e.g., a solvent contained in a binding agent) from the pod may occur within or outside of the mold using a variety of methods (e.g., using heating/dehydrating, a vacuum oven, freeze-drying, microwaves, centrifugation, a gas (e.g., nitrogen), and/or other methods involving gases with or without pressure).

FIG. 21: Illustrates making a pod by coating

Pods may be created from the compaction of supplements. First, the supplements type(s) is selected, e.g., a nutrient that may be in the form of a micro/nano emulsion(s), micelles, powder(s), granule(s), a pellet(s), and/or liquid(s) and in any combination of these. Second, the nutrient is mixed/blended with at least one additive (e.g., a pod ingredient) to create a formula. Note, heating may also be applied to the formula at this point. Third, the formula is packed into a mold and pressure (e.g., including forms, but not limited to, mechanical pressure, vacuum pressure, air pressure, centrifugation, and/or electrostatic pressure) is applied to compact the formula into a pod. Fourth, drying and/or solvent removal (e.g., a solvent contained in a binding agent) from the pod may occur within or outside of the mold using a variety of methods (e.g., using heating, dehydrating, a vacuum oven, freeze-drying, microwaves, centrifugation, a gas (e.g., nitrogen), and/or other methods involving gases with or without pressure). Fifth, a coating is added using methods that include, but are not limited to, spraying, brushing, dipping, pouring, dry application of coating particles, and/or vapor deposition. This coating may completely or incompletely cover the surface of the pod.

FIG. 22: Illustrates making a pod by encapsulation

Pods may be created from the compaction of supplements. First, the supplements type(s) is selected, e.g., a nutrient that may be in the form of a micro/nano emulsion(s), micelles, powder(s), granule(s), a pellet(s), and/or liquid(s) and in any combination of these. Second, the nutrient is mixed/blended with at least one additive (e.g., a pod ingredient) to create a formula. Note, heating may also be applied at this point. Third, the formula is packed into a mold and pressure (e.g., including forms, but not limited to, mechanical pressure, vacuum pressure, air pressure, centrifugation, and/or electrostatic pressure) is applied to compact the formula into a pod. Fourth, drying and/or solvent removal (e.g., a solvent contained in a binding agent) from the pod may occur within or outside of the mold using a variety of methods (e.g., using heating, dehydrating, a vacuum oven, freeze-drying, microwaves, centrifugation, a gas (e.g., nitrogen), and/or other methods involving gases with or without pressure). Fifth, assembly of a hard-shell capsule (e.g., using capsule components as used in the encapsulation method) onto the pod, which may be water soluble or non-water soluble, and may completely or incompletely cover the surface of the pod. This hard-shell capsule application may be referred to as a type of dry encapsulation of the pod.

FIG. 23: Illustrates a schematic of a mold system that can generate a capsule or pill-shaped pod (FIG. 23A: Punch; FIG. 23B: Die; FIG. 23C: Magazine)

The mold consists of three parts: Punch, Die, and Magazine. The Magazine fits on top of the Die through four small pegs. The Punch is designed to fit into the Magazine. The mold parts may be fabricated from plastics (including, but not limited to, PLA, ABS, and PET), bio-fibers, bio-composites, ceramics, metals (including, but not limited to, aluminum, stainless steel, alloys, magnesium, and copper alloys), carbon fiber, silicones, naturally occurring polymers, semisynthetic/synthetic polymers, and/or other materials that would maintain shape in the form of a mold as described in this specification for creating a pod. The mold can be scaled up or down for producing a pod of a desired final volume. This figure displays numbers that are in units of millimeters (mm) The mold in this figure is designed to create a single compacted pod, but molds can be assembled in a series for producing more than one pod. To create a pod with the mold, the order of assembly is as follows:
1. Place the Magazine onto the Die. The Magazine acts as a chamber for holding the formula prior to compaction.
2. Add the formula (wet, dry, or some combination of the two) into the Magazine. At this point, the formula should be in the Die and the Magazine.
3. The Punch is then inserted into the Magazine and pressed/forced down (can be for a short or long period), compacting the formula into a pod.
4. The Punch can then be removed, exposing the pod. The pod can then be left to dry within the Magazine and Die or the Magazine can be removed and the pod can be left to dry in the Die, or the pod can be removed from the Magazine and Die to dry by itself, not touching the mold at all.
5. After drying the pod, further processing can be carried out on the pod, including but not limited to, further drying/dehydration steps and/or the addition of a coating and/or encapsulation (e.g., assembly of a hard-shell/capsule component).

This mold produces pods with a capsule-shape that is 23.8 mm in diameter (11.9 mm radius) and 52.89 mm long, with a volume of around 20 mL.

Sphere Volume+Cylinder Volume=total volume

(4/3)(π)(r³)+(π)(r²)(h)

(4/3)(π)(11.9³)+(π)(11.9²)(29.09)

7058.77751+12941.58642

˜20,000 mm³ or 20 mL=total volume

Note: This same mold can be scaled up. For example, the numbers used in the calculation could have been in other units, such as centimeters, instead of millimeters.

FIG. 24: A schematic of a mold system that can generate a Reuleaux tetrahedron-shaped pod (FIG. 24A: Punch; FIG. 24B: Die; FIG. 24C: Magazine)

The mold consists of three parts: Punch, Die, and Magazine. The Magazine fits on top of the Die through four small pegs. The Punch is designed to fit into the Magazine. The mold parts may be fabricated from plastics (including, but not limited to, PLA, ABS, and PET), bio-fibers, bio-composites, ceramics, metals (including, but not limited to, aluminum, stainless steel, alloys, magnesium, and copper alloys), carbon fiber, silicones, naturally occurring polymers, semisynthetic/synthetic polymers, and/or other materials that would maintain shape in the form of a mold as described in this specification for creating a pod. The mold can be scaled up or down for producing a pod of a desired final volume. This figure displays numbers that are in units of millimeters (mm) The mold in this figure is designed to create a single compacted pod, but molds can be assembled in a series for producing more than one pod. To create a pod with a mold, the order of assembly is as follows:
1. Place the Magazine onto the Die. The Magazine acts as a chamber for holding the formula prior to compaction.
2. Add the formula (wet, dry, or some combination of the two) into the Magazine. At this point, the formula should be in the Die and the Magazine.
3. The Punch is then inserted into the Magazine and pressed/forced down (can be for a short period or long period), compacting the formula into a pod.
4. The Punch can then be removed, exposing the pod. The pod can then be left to dry as is within the Magazine and Die or the Magazine can be removed and the pod can be left to dry in the Die, or the pod can be removed from the Magazine and Die to dry by itself, not touching the mold at all.
5. After drying the pod, further processing can be carried out on the pod, including but not limited to, further drying/dehydration steps and/or the addition of a coating and/or encapsulation (e.g., assembly of a hard-shell/capsule component).

This mold produces pods with a Reuleaux tetrahedron-shape and a volume of around 20 mL.

((8/3)π−(27/4)cos⁻¹(⅓)+(√2/4))r³=volume

˜20 mL=volume

Note: This same mold can be scaled up. For example, the numbers used in the calculation could have been in other units, such as centimeters, instead of millimeters.

FIG. 25: A schematic of a mold system that can generate a ball or sphere-shaped pod (FIG. 25A: Punch; FIG. 25B: Die; FIG. 25C: Magazine)

The mold consists of three parts: Punch, Die, and Magazine. The Magazine fits on top of the Die through four small pegs. The Punch is designed to fit into the Magazine. The mold parts may be fabricated from plastics (including, but not limited to, PLA, ABS, and PET), bio-fibers, bio-composites, ceramics, metals (including, but not limited to, aluminum, stainless steel, alloys, magnesium, and copper alloys), carbon fiber, silicones, naturally occurring polymers, semisynthetic/synthetic polymers, and/or other materials that would maintain shape in the form of a mold as described in this specification for creating a pod. The mold can be scaled up or down for producing a pod of a desired final volume. This figure displays numbers that are in units of millimeters (mm) The mold in this figure is designed to create a single compacted pod, but molds can be assembled in a series for producing more than one pod. To create a pod with a mold, the order of assembly is as follows:
1. Place the Magazine onto the Die. The Magazine acts as a chamber for holding the formula prior to compaction.
2. Add the formula (wet, dry, or some combination of the two) into the Magazine. At this point, the formula should be in the Die and the Magazine.
3. The Punch is then inserted into the Magazine and pressed/forced down (can be for a short period or long period), compacting the formula into a pod.
4. The Punch can then be removed, exposing the pod. The pod can then be left to dry as is within the Magazine and Die or the Magazine can be removed and the pod can be left to dry in the Die, or the pod can be removed from the Magazine and Die to dry by itself, not touching the mold at all.
5. After drying the pod, further processing can be carried out on the pod, including but not limited to, further drying/dehydration steps and/or the addition of a coating and/or encapsulation (e.g., assembly of a hard-shell/capsule component).

This mold produces pods with a sphere-shape that are 36.7 mm in diameter (18.35 mm radius), with a volume of around 25.9 mL.

(4/3)(π)(r³)=volume

(4/3)(π)(18.35³)

˜25,882 mm³ or 25.9 mL=volume

Note: This same mold can be scaled up. For example, the numbers used in the calculation could have been in other units, such as centimeters, instead of millimeters.

FIG. 26: A schematic of an open-end mold system designed for centrifugation packing

This 2-piece mold is designed to be used in combination with a standard 50 mL centrifuge tube. The design depicts a capsule shape, but almost all 3-dimensional shapes are possible. The female-half of the mold (panels 480 and 490) is combined with the male-half of the mold (panels 482 and 492), to create the mold (panels 484 and 494). Male parts 424 and 426, fit into the female parts 414 and 416. The mold is placed into a 50 mL centrifuge tube, which holds the female and male halves in place. A particle formula and/or formula is added to the top of the funnel, created by combining halves 410+412. The 50 mL centrifuge tube, containing the mold, is spun in a centrifuge, which pulls the particle formula and/or formula through the hole 402 at the base of the funnel and into the packing chamber 420. A reservoir below the mold 432+422, is a space for capturing solvent (e.g., any solvent that was part of the particle formula and/or formula and/or binding solution), and also for collecting some fine particles, during centrifugation. The male part 426 and/or reservoir (432+422) can be further modified to have one or more openings (e.g., holes and/or slits) to allow for more drainage of solvent and/or particles into the reservoir 432+422, during centrifugation. Following centrifugation, the mold is removed from the 50 mL centrifuge tube, the halves of the mold are separated to expose the pod, which is then removed. Note, panels 480, 482, and 484 are two-dimensional drawings and panels 490, 492, and 494 are three-dimensional drawings.

This 2-piece mold design makes it easier to (a) remove the pod following centrifugation of the particle formula and/or formula and (b) clean. This design has dimensions which allow the mold to fit into a standard 50 mL centrifuge tube, a common plastic tube used in research. The 50 mL centrifuge tube fits the rotor of many centrifuges. If the aim is to achieve a more even packing of particles within a given dimensional plane, it is recommended to use this mold in combination with a swing-bucket rotor. Using this mold, packing and/or compaction can be modulated through the speed and/or length of the spin cycle. For example, unequal packing may be desired to modify the density across the pod. Further, such uneven particle packing can be used as a feature to make the pod sink or float in a specific orientation. It is possible to add a liquid into the hole 402 (onto a pod in the packing chamber 420), which will spread through the pod during an additional centrifugation step (similar to chromatography). The liquid may contain a binder, solvent, coloring, nutrient, supplement, or other material required for the pod.

This 2-piece mold design can be scaled up or down to achieve a pod of a desired volume, e.g., using centrifuges tubes larger than 50 mL centrifuge tubes.

FIG. 27: A schematic of a closed-end mold system designed for centrifugation packing.

This 2-piece mold is designed to be used in combination with a standard 50 mL centrifuge tube. The design depicts a capsule shape, but almost all 3-dimensional shapes are possible. The female-half of the mold (panels 460 and 470) is combined with the male-half of the mold (panels 462 and 472), to create the mold (panels 464 and 474). Male parts 424 and 426, fit into the female parts 414 and 416. The mold is placed into a 50 mL centrifuge tube, which holds the female and male halves in place. A particle formula and/or formula is added to the chamber 444. The punch 450 is put into the chamber 444. The 50 mL centrifuge tube, containing the mold, is spun in a centrifuge to pack the particle formula and/or formula, further aided by the punch 450, which creates the packing chamber 420, providing shape features to the pod. A reservoir below the mold 432+422, is a space for capturing solvent (e.g., any solvent that was part of the particle formula and/or formula and/or binding solution), and also for collecting some fine particles, during centrifugation. The male part 426 and/or reservoir (432+422) can be further modified to have one or more openings (e.g., holes and slits) to allow for more drainage of solvent and/or particles into the reservoir 432+422, during centrifugation. Following centrifugation, the mold is removed from the 50 mL centrifuge tube, the punch and halves of the mold are separated to expose the pod, which is then removed. Note, panels 460, 462, 464, and 466 are two-dimensional drawings and panels 470, 472, 474, and 476 are three-dimensional drawings.

This mold design has dimensions which allow the mold to fit into a standard 50 mL centrifuge tube, a common plastic tube used in research. The 50 mL centrifuge tube fits the rotor of many centrifuges. If the aim is to achieve a more even packing of particles within a given dimensional plane, it is recommended to use this mold in combination with a swing-bucket rotor. Using this mold, packing and/or compaction can be modulated through the speed and/or length of the spin cycle. For example, unequal packing may be desired to modify the density across the pod. Further, uneven particle packing can be used as a feature to make the pod sink or float in a specific orientation. Also the weight of the punch 450, and its depth into the chamber 444, can be modified to achieve a specific particle packing and/or compaction. It is possible to add a liquid into the chamber 444 (onto a pod in the packing chamber 420), which will spread through the pod during an additional centrifugation step (similar to chromatography). The liquid may contain a binder, solvent, coloring, nutrient, supplement, or other material which is required for the pod.

This 2-piece mold design can be scaled up or down to achieve a pod of a desired volume, e.g., using centrifuge tubes larger than 50 mL centrifuge tubes.

### DETAILED DESCRIPTION OF THE PREFERRED EMBODIMENT

The invention described here details methods for engineering supplement particles with more varied physical properties and compacting and converting supplements into single pods that may be dissolved into beverages.

Engineering Particles into Varying Properties

Engineering supplement particles to have varying physical properties is a valuable precursor to converting particles into pods, as these physical properties impact performance of the pod. Particle size is one physical property. Other physical properties that may impact performance include volume, weight, density, porosity, texture, shape, cohesiveness, and morphology (i.e., form, shape, size, and structure), among others.

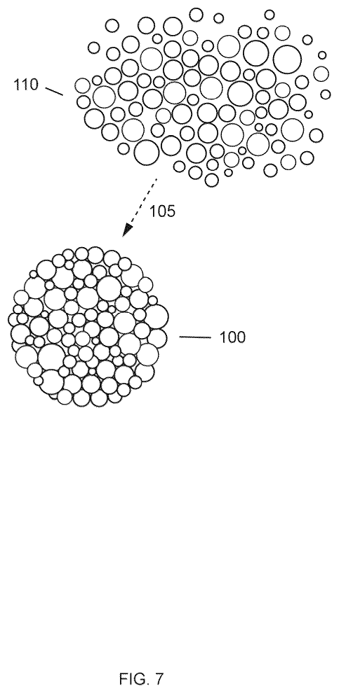

This invention describes engineering particles to have varying physical properties and converting them into pods via compaction and/or encapsulation (FIGS. 7-18). The present invention teaches away from traditional concepts of making compactions (e.g., tablets) which focus on compacting particles that are described as being unimodal with respect to the PSD, such as those having a normal distribution curve, and having a mostly homogeneous particle size and shape. This present invention represents a paradigm shift to achieve improved dissolution/disintegration of particles tightly packed (through compaction and/or encapsulation). More specifically, the present invention teaches at least three methods to generate particles with more varied physical properties as a precursor to compaction and/or encapsulation:
Layer removal method—The removal of a layer(s) of particles, with the purpose of creating a gap within the PSD. Layers may also be called fractions, particle ranges, particle size range, sections, size intervals, or size classes. A layer can be completely removed or partially removed.
Combination method—The combining of at least two particle samples to achieve a new sample, which results in a (i) bimodal or a multimodal PSD and/or (ii) more skewed PSD, for example, a positively skewed PSD.
Redistribution method—The (i) removal (of all or a portion) of one layer of particles within a sample, (ii) resizing the particles from that one layer of particles, and then (iii) adding the resized particles back to the sample. Resizing can be increasing or decreasing the particle size.

One embodiment of the present invention is described with reference to the particle engineering of an exemplary bulk supplement powder, which may be single ingredients or off-the-shelf direct to consumer supplement products or formulated supplement powders. In this example, the focus is using Protein-rich formulated Bulk Supplement Powder (PBSP), although other types of supplement powders may be used.

In a preferred embodiment, the desired formula uses minimal additives (e.g., acids, bicarbonate salts/carbonate salts, and binder) to conserve the original flavor, ideally containing between 80%-95% of the original PBSP contents. In certain embodiments, only 5% additives of effervescent ingredients and optional binder is used. In other embodiments, closer to 20% effervescent ingredients and optional binder is used for enhancing solubility performance with certain supplement powders.

A pod may exist as a highly concentrated form of PBSP. Compare that with other products that are marketed as protein-rich products, which have been infused with PBSP such as protein bars, ready-to-drinks (RTDs), yogurts, and jellies. Such products contain other ingredients besides PBSP, which may include unwanted calories and macronutrients, e.g., more carbohydrates (such as simple sugars). Pods allow for PBSP consumption in nearly the original formula without compromising the macronutrient composition and overall formula. In addition, PBSP may contain small/trace amounts of water introduced from manufacturing. Trace amounts of water create an environment for effervescent reactions to occur. Thus, combining effervescent ingredients and PBSPs is problematic if (a) too much water is present in the PBSP and/or (b) a high percentage of effervescent ingredients is required to manufacture a pod. In the present invention, because these effervescent ingredients are only 5-20% of the formula, they are further apart in the pod and are less likely to react with one another in the presence of trace water from the BPSP, and efforts are preferably made to reduce water content from supplements and additives prior to conversion into pods. In addition, these pods are lower in density (protein-containing pods float in water) compared to commercially available effervescent tablets (which sink in water).

Use of pods according to the present invention solves the problems of using particles such as powders (e.g., messy and inconsistent scoop sizes), while adding value in the form of ease of handling, portability, novel consumption methods, and entertainment in watching the pods dissolve in water. Pods are designed to be consumed in multiple ways, and it is up to the consumer to choose how they want to consume the pod, for example by:
dissolving in water or a beverage, then drinking
fully and/or partially dissolving in the mouth, chewing up and then eating
adding to a meal (e.g., yogurt or bowl of cereal) or adding to an electric mixer with other ingredients to make a smoothie

Using the present invention, pods have been made from 0.1-25,000 grams in weight, with spherical-shaped pods having sizes capable of exceeding 15 cm in diameter. This is a much larger weight and size (volume) range compared to standard effervescent tablets.

Pods containing protein may be developed to float so as to make them less dense than water. This has two benefits:
Entertains the users at the water's surface. Users may watch the pod dissolve across the surface and/or may watch particles, from the side, as they sink down to the bottom of the vessel from the surface; and
Allows water to penetrate the pod and/or be wicked into the pod and disperse the particles more easily. A lower density also decreases the probability of unwanted chemical reactions within the pod that would reduce shelf life (e.g., organic acids reacting with bicarbonate salts/carbonate salts).
   This is in contrast with other standard effervescent tablets, which are denser than water and sink in water.

By use of the methods of the present invention described herein, the resulting engineered particles of PBSP consist of varying particle sizes, e.g., having at least one distinct gap in the PSD, having a bimodal or a multimodal distribution, and/or having a wide PSD range (as opposed to a narrow normal distribution). A wide PSD range may include a unimodal distribution skewed with a distribution range >800 microns between the D10 and D90. The particle sizes may be as large as 3 millimeters in diameter or more.

The present invention overcomes disadvantages of using conventional methods for manufacturing effervescent tablets containing supplements (e.g., PBSP), namely, the commonly used nearly uniform particle size (normal distribution curve), with respect to PSD. Varying the supplement particle size is an important advantage of the present invention, and a distinguishing feature from conventional methods of making effervescent tablets. Packing (either through compaction or encapsulation) of particles that have been engineered to be more varied in size results in pods that can be packed less densely and with less effervescent ingredients, while maintaining flavor and strength and an improved solubility (dissolves faster than without engineering particles). The present invention produces yet an additional advantage, namely, larger size/volume range capabilities for pods (i.e., pods may exceed 15 cm in diameter if using a spherical shape) and/or larger weight ranges capabilities (i.e., pods may exceed 25,000 grams)—something unheard of for standard effervescent tablets meant for dissolving and drinking Larger pods are even convenient for gyms, caterers, hospitals, and commercial kitchens requiring consistency in large quantities.

Note, larger sized (volume) pods inherently have less surface area to volume, especially when using a spherical shape. This makes it hard for water to penetrate to the center of the pod during dissolution in water. Ergo, as pods are made larger, it is recommended to reduce the pod's density, while potentially increasing the binder. In alternative embodiments, a heat-activated binder such as HPMC may be activated through heat to further strengthen the pod. In addition, increasing the time of applying compression force greatly improves pod performance (with respect to strength and solubility). For example, applying a given force for 10 minutes will result in a stronger pod than the same force for 10 seconds.

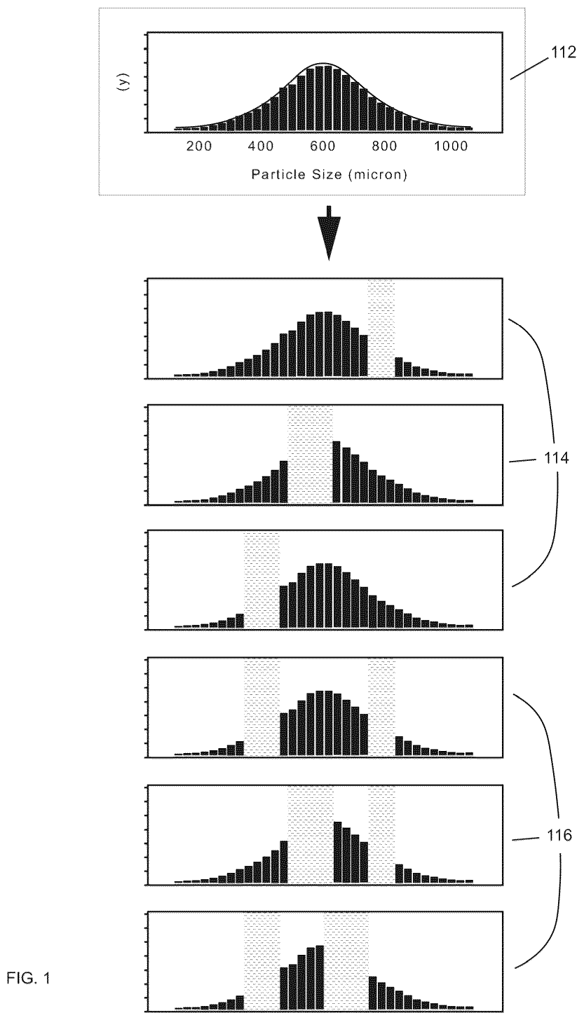

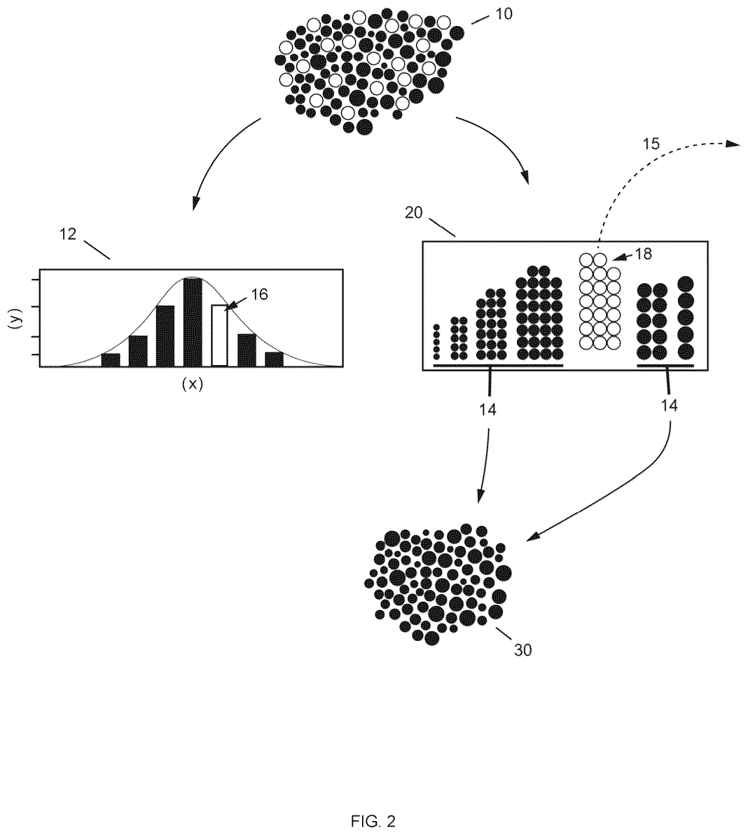

The particle engineering methodology is further described with reference to FIGS. 1-6. FIG. 1 illustrates a layer removal embodiment of the present invention to generate particles that vary in particle size by creating a gap within the PSD. Histogram 112 is a theoretical example of a PSD based on data generated from sieve analysis of a granulated protein powder sample. The x-axis represents a particle size range in microns and the y-axis represents the percentage of the protein powder by weight (using arbitrary tick marks), but other measures could be used for the y-axis, such as volume, volume fraction, frequency, frequency volume weighted, cumulative distribution, differential distribution, probability density, probability, area, weight intensity, particle concentration, etc.

Three histograms 114 provide examples of one layer of particles being removed from the starting sample shown in histogram 112. This results in a gap (represented by a horizontal dotted line pattern) in the PSD (not affecting total size distribution range).

Three histograms 116 provide examples of two layers of particles being removed from the starting sample shown in histogram 112. This results in two gaps (represented by a horizontal dotted line pattern) in the PSD, and thus a more varying particle size with respect to the total number of particles (not affecting total size distribution range).

Generating more than two gaps using this layer removal method is possible. Note that the layer removal (gap) occurs from within the particle distribution, not from the ends.

While histogram 112 shows a normally distributed particle size, the layer removal method applies to non-normal distributions as well. It should be noted that layer removal may be partial (i.e., reducing a portion of the particles within a layer without removing them all to create a complete gap in the PSD) and still show improved pod performance (i.e., faster rate of dissolution/disintegration of the particles into solution and maintained strength) once converted into a pod. Still, this is considered an intermediate effect compared to removing the entire layer and creating a gap as is shown in histograms 114 and 116.

FIG. 2 illustrates a layer removal embodiment of the present invention to create a gap within the PSD. The solid white and black circles represent a type of particle 10. The one-hundred individual particles 10 are shown by PSD in two ways for clarity, a histogram 12 and a particle-size plot 20. The histogram 12 shows particle size range from smaller diameter (left side) to larger diameter (right side) on the x-axis with the percentage of particles (particle %) on the y-axis. This histogram 12 shows a normal distribution, with seven layers (six black bars and one white bar 16). The particle % has arbitrary tick marks along the y-axis to make relative comparison among the seven layers. The white bar 16 represents one specific layer.

The particle plot 20 represents the one-hundred individual particles 10, grouped by size from smaller diameter (left side) to larger diameter (right side). The six black bars from the histogram 12 are represented by solid black circles 14 in the particle plot 20. The one white bar 16, from the histogram 12, is represented by solid white circles 18 in the particle plot 20.

The layer removal method 15 is the process of removing at least one layer or particles. In this example, one layer 18 is being removed. The remaining layers 14 (i.e., the six layers containing solid black circles 14), now have a gap within the PSD resulting in particles 30. This example shows the particles 10 being separated into seven layers for clarity but this is not necessary when removing a specific layer or layers; and note that seven layers was arbitrary, as it could have been less layers (i.e., resulting in larger size ranges across a size distribution) or more layers (i.e., resulting in smaller size ranges across a size distribution). The particles are represented as circles which can be inferred as spheres if in 3-dimensions; however, this is just an example and particles are rarely, if ever, perfect spheres. In addition, non-spherical particles may improve pod performance. The physical properties of particles may vary in size, volume, weight, density, porosity, texture, shape, cohesiveness, and morphology (form, shape, size, and structure).

This layer removal method 15 can be applied to more than one particle layer. In addition, this same layer removal method 15 can be applied to at least one additive to generate an additive that varies in at least one physical property, such as size.

The particles 30 can be used to make pods, e.g., compacted pods, encapsulated pods, encapsulated-compacted pods, segmented pods, encapsulated-segmented pods, and semi-encapsulated pods.

It should be noted that layer removal can be partial or incomplete (i.e., reducing a number of the particles within a layer without removing them all to create a complete gap in the PSD) and still show improved pod performance (i.e., faster solubility/disintegration of the particles in solution and maintained strength) once converted into a pod. Still, this is considered an intermediate effect compared to removing the entire layer and creating a gap as is shown in FIG. 2.

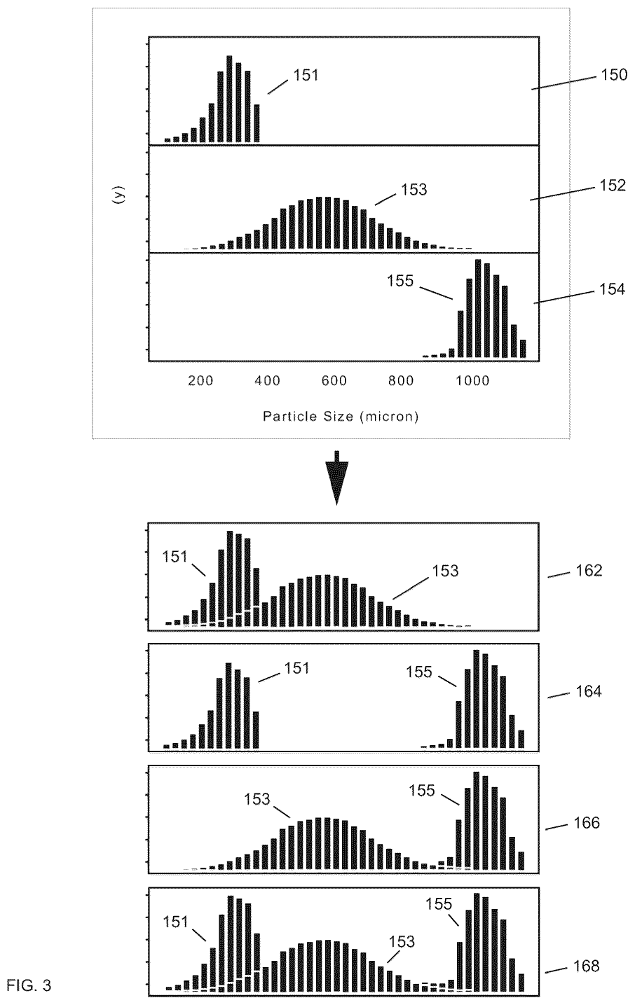

FIG. 3 illustrates an embodiment of the present invention that combines particles as to vary the PSD. Histograms 150, 152, and 154 are theoretical examples of PSDs based on data generated from sieve analysis of different pre-workout creatine supplement powders. This single type of powder was manufactured in three different ways (e.g., varying types of granulation), resulting in differing PSDs all with a single, major peak.

The x-axis represents particle size range in microns; and the y-axis represents the percentage of the powder by weight (using arbitrary tick marks), but other measures could be used, such as volume, volume fraction, frequency, frequency volume weighted, cumulative distribution, differential distribution, probability density, probability, area, weight intensity, particle concentration, etc.

Using the combination method, powders can be combined to make bimodal particle distributions and/or multimodal particle distributions, resulting in a final powder with more varying particle sizes and a wider PSD range. For example, a bimodal particle distribution can be made by combining powder 151 (smaller median particle size) and powder 153 (medium median particle size), see histogram 162. In another example, a bimodal particle distribution can be made by combining powder 151 and powder 155 (larger median particle size), see histogram 164. In another example, a bimodal particle distribution can be made by combining powder 153 and powder 155, see histogram 166. A multimodal particle distribution can be made by combining powder 151, powder 153 and powder 155, see histogram 168.

More than three powders can be combined to make a multimodal particle distribution of varying PSD. Histograms 150, 152 and 155 each show normally distributed particle sizes, but the combination method applies to non-normal distributions as well.

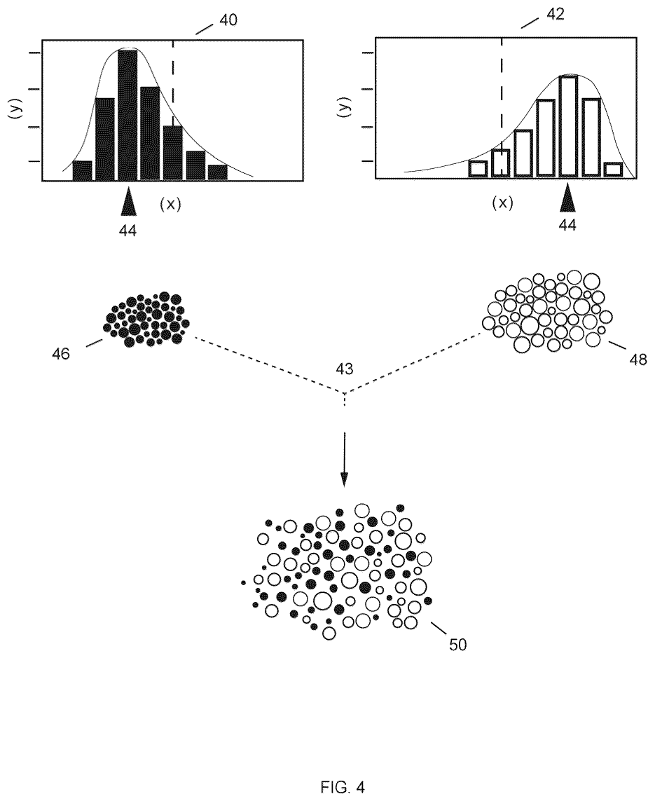

FIG. 4 illustrates an embodiment of the present invention to generate particles that vary in at least one physical property. The average and/or the median particles 46 (solid black circles) have a smaller diameter relative to particles 48 (solid white circles), which are represented in histograms 40 and histogram 42, respectively. The histograms show PSD from smaller diameter (left side) to larger (right side) on the x-axis with a large black arrow pointing to the mode 44; the percentage of particles (particle %) is represented on the y-axis, which uses arbitrary tick marks for relative comparisons. A vertical dotted-lines represents the same layer, with respect to particle size, in histogram 40 and histogram 42, as to make relative comparisons. Based on the histograms, particles 46 and particles 48 show differing PSDs, evidenced by the differing mode relative to the vertical dotted-line and general shape of the distribution.

A combination method 43, the process of combining particles 46 and particles 48, results in a new type of particle 50. Particles 50 are more varied in particle size (wider distribution) compared to either of the individual PSDs (narrower distributions) of particles 46 and particles 48. Particles 50 can be used to make pods, e.g., compacted pods, encapsulated pods, encapsulated-compacted pods, segmented pods, encapsulated-segmented pods, and semi-encapsulated pods.

This combination method 43 can be applied to more than two types of particles, as long as the final combination of particles differ in PSD more than the individual types of particles. Ideally, the resulting final combination contains a complete gap or dip across the distribution. In addition, this combination method 43 can be applied to additives to generate an additive that varies in at least one physical property.

The particles are represented as circles, which can be inferred as spheres if in 3-dimensions; however, this is just an example and particles are rarely, if ever, perfect spheres. In addition, non-spherical particles may improve pod performance. The physical properties of particles may be varied in size, volume, weight, density, porosity, texture, shape, cohesiveness, and morphology (form, shape, size, and structure), even within a given sample type.

The particles 50 can be used to make pods, e.g., compacted pods, encapsulated pods, encapsulated-compacted pods, segmented pods, encapsulated-segmented pods, and semi-encapsulated pods.

The combination method may be useful for combining larger supplement particles (e.g., granules; that may or may not have varying particle sizes) with smaller additive particles (e.g., powder, fine powder, or dust; that may or may not have varying particle sizes) as this results in an overall more varied PSD for the final formula.

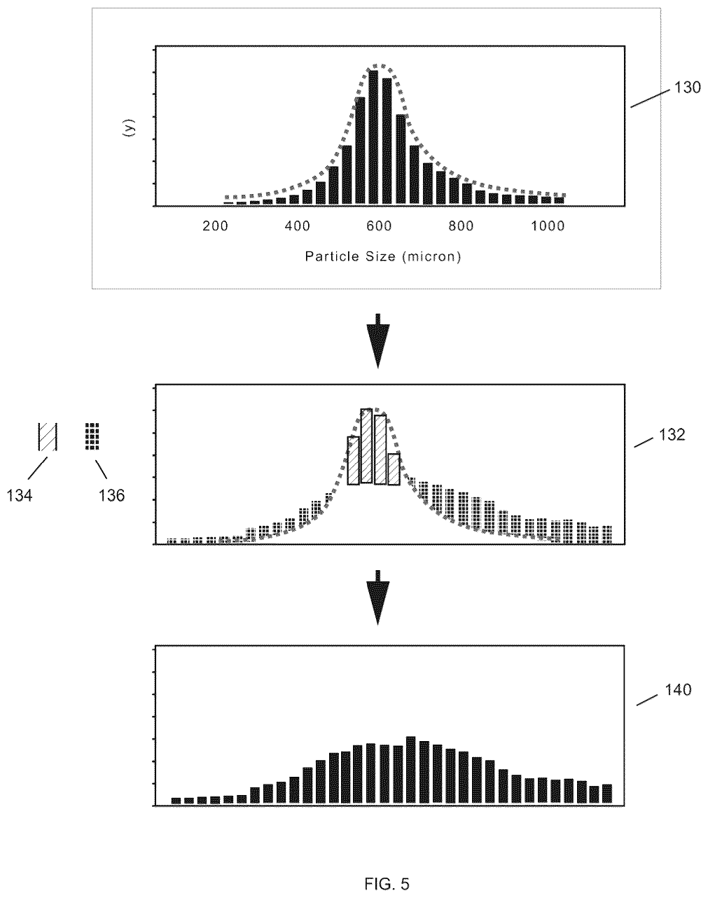

FIG. 5 illustrates an embodiment of the present invention, namely, a redistribution method to create a wider PSD from a narrow PSD by decreasing the particle size homogeneity. Histogram 130 is a theoretical example of a narrow PSD (single high peak) based on data generated from sieve analysis of a branched-chain amino acid supplement powder sample. The x-axis represents an arbitrary particle size range in microns, and the y-axis represents the percentage of the supplement powder by weight (using arbitrary tick marks), but other measures could be used, such as volume, volume fraction, frequency, frequency volume weighted, cumulative distribution, differential distribution, probability density, probability, area, weight intensity, particle concentration, etc.

Histogram 132 is a redesign of the particles shown in histogram 130. The highest percent particle size shows a portion 134, represented by a slanted lines pattern, which is to be removed and resized (increased and decreased). The resized portion 136, represented by a repeating square pattern, is redistributed by particle size.

Histogram 140 is the result of using the redistribution method, which results in a more varied particle size, i.e., more of the particles are distributed across a wider range of sizes compared to them being concentrated in a single peak like in histogram 130. Histogram 130 shows a normal distribution, but the redistribution method applies to non-normal distributions as well. In addition, although only a portion of a particle size range (i.e., layer) was resized and redistributed, that same entire particle size range could have been resized and redistributed, resulting in a gap within the PSD; and having such a gap in particle size is similar to the layer removal method. Furthermore, that portion could be removed completely from the particle sample.

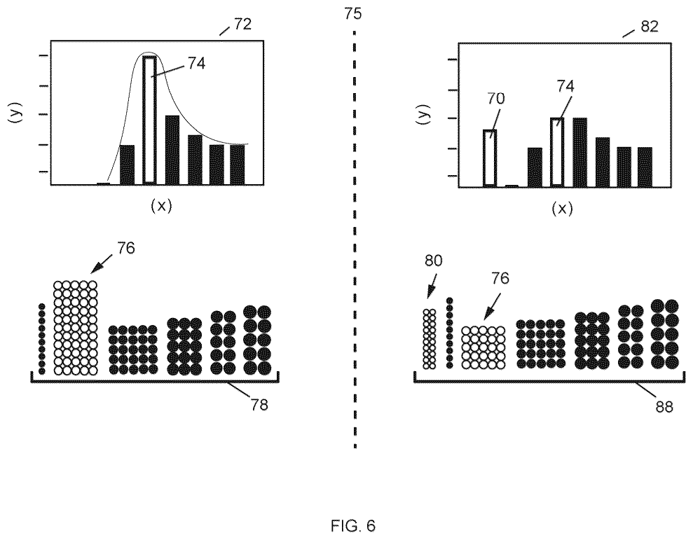

FIG. 6 illustrates an embodiment of the present invention, namely, a redistribution method to generate particles that are more varied in at least one physical property. A type of particle is shown by PSD in two ways, histograms and particle plots. The histograms show a particle size range from smaller diameter (left side) to larger diameter (right side) on the x-axis and the percentage of particles (particle %) on the y-axis, which has arbitrary tick marks for relative comparisons. The particle plots represent the same data from the histograms, but show the individual particles, which are grouped by particle size from smaller diameters (left side) to larger diameters (right side). The vertical dotted-line 75 divides the particle data, from before (left) to after (right) applying the redistribution method, i.e., the process of removing a portion of at least one particle layer, changing at least one physical property (e.g., size; increasing and/or decreasing the medium particle size and/or widening the PSD range), then adding this newly made particle layer back in with remaining particle layers. This method results in generating particles that vary in at least one physical property (size). Note, the newly changed particle layer can be the same as an existing one in the PSD as long as it differs from its starting state and results in an overall PSD that has more variation than it started with.

In this example, histogram 72 depicts the PSD of the particles, comprising six arbitrary particle layers (five black bars, 1 white bar 74). The most abundant particle layer is represented by the white bar 74. Comparing histogram 72 to particle plot 78, the black bars are analogous to the solid black circles and the white bar 74 is analogous to the solid white circles. A portion of the white particle layer (white bar 74 or solid white circles 76) is removed and the particles of this layer are resized, e.g., decreased in particle size, as shown to the right of the vertical dotted-line 75. The smaller resized particles create a new particle layer represented in histogram 82 as white bar 70, and represented in particle plot 88 as solid white circles 80. This new particle layer is added back to the other layers, resulting in a more varied PSD (6 layers before, 7 layers after). These particles, that vary in size, can be used to make pods, e.g., compacted pods, encapsulated pods, encapsulated-compacted pods, segmented pods, encapsulated-segmented pods, and semi-encapsulated pods.

This redistribution method can be applied to more than one layer as long as the final combination of particles differ in the PSD from the starting particles, namely, the particles are engineered to be non-uniform, with the best pod performance seen when creating gaps within the PSD. In this example, a portion of a particle layer was reduced in size, but increasing this size is also an option; also increasing and decreasing (at the same time) size of a given particle layer may result in more varied particles across the PSD. The same method may be applied to other physical properties such as increasing or decreasing the density or porosity of a given portion of a given particle layer or layers. The particles are represented as circles that can be inferred as spheres if in 3-dimensions; however, this is just an example and particles are rarely, if ever, perfect spheres. In addition, non-spherical particles may improve pod performance. The physical properties of particles may vary in size, volume, weight, density, porosity, texture, cohesiveness, shape, and morphology (form, shape, size, and structure).

In addition, although only a portion of a particle size range was resized and redistributed, the entire particle size range could have been resized and redistributed, resulting in a gap in the PSD; and having such a gap within the PSD is similar to the layer removal method, but combines the potential benefits of the redistribution method as well.

Desired particle size is achieved in multiple ways and/or combinations of ways. While this example focuses on the average and/or median size of the particle size, other physical properties, including volume, weight, density, porosity, texture, shape, cohesiveness, and morphology (form, shape, size, and structure), may be important and may likewise be varied to facilitate improved compaction and/or encapsulation. In general, standard tablets, including effervescent tablets, are made through the compaction of particles that are nearly uniform in size (normal distribution curve), and the shape is nearly spherical. Particle size uniformity is commonly achieved through granulation of the final formula, with a majority of the finer and coarser particles being removed through meshes prior to compaction. Such nearly uniform particles, especially once granulated, are nearly uniform in other physical properties as well, including size, volume, weight, density, porosity, texture, cohesiveness, shape, and morphology (form, shape, size, and structure). Changing the size of a particle may affect some and/or all of these other physical properties. Furthermore, these other physical properties are routinely measured in tablet compaction assays and analyses during research-and-development and quality control, thus providing evidence of their importance in tablet manufacturing. Ergo, varying particle size also varies these other physical properties and may be important factors affecting a pod's strength and dissolution/disintegration.

As mentioned, standard tablets, which include effervescent tablets, require particles (e.g., granules) that are nearly uniform in particle size (normal distribution curve) and shape (ideally being nearly spherical). In such normal distribution curves, the small tails on either side of the major peak are considered important in tableting. Although a majority of fine particles and coarse particles are removed prior to compaction, some remain. It is known that tablets not containing a small amount of fine particles (small tail to the left of the curve) result in tablets that are striated. In contrast, pods require particle distributions to be more varied than this, e.g., making a deliberate gap within the PSD, or having particles with multiple peaks in a size distribution (bimodal and multimodal curves). These particles can also be more varied in morphology and may not be uniform in particle shape. Furthermore, tablets are highly compacted and can be handled immediately after compaction, whereas pods are soft and delicate and require drying before they can become hard enough for handling. In general, pods are lower in density compared to standard tablets. And although decreasing the density results in decreasing the strength, it also results in a more porous pod which wicks up water more readily and thus improves dissolution/disintegration rate (i.e., it dissolves faster). The weakness in strength can be overcome with a highly soluble binder and/or packaging solution.

In this example, the desired particle size may be achieved by one or more of the following techniques:
Particle size is increased via granulation methods.
Particle size is increased via granulation methods, then decreased, using milling methods, to achieve the desired size.
Starting with larger particle sizes, then milling down to the desired size.

In practical and preferred application, these methods are applied to supplement powders, but they can equally be applied to the other dry powder additives, e.g., effervescent ingredients and binders.

In a preferred embodiment, mesh screens are used for sieving the various particle sizes into layers (also called particle ranges, sections, size intervals, size classes, or fractions). Then the layers are organized by weight into at least two median particle sizes of the supplement powder. The supplement powder is then blended/mixed with effervescent ingredients (or other dissolution agents) and an optional binder (wet or dry), and then compacted and/or encapsulated.

When blending the layers together before compaction and/or encapsulation, care is taken to achieve an equal blend of particles and to avoid any given particle type becoming concentrated together in the formula. This is to ensure an equal balance of particle types per pod. Particles/formulas cannot be over blended/mixed or blended/mixed with too much force or granular convection may occur (affected by the ratio of acceleration to gravity). Granular convection (also called the Brazil nut effect and muesli effect) is the phenomenon observed when shaking, or vibrating, granular materials/object (e.g., mixed nuts and breakfast cereals), namely, the granular materials/object exhibit circular patterns of movement similar to fluid convection. This results in larger particles moving to the top of the container and the smaller particles moving to the bottom. Even when force is applied in the horizontal plane, patterns emerge, where like-particles collect together. Granular convection can be avoided using known manufacturing methods, although the individual products can still experience granular convection once packaged. For example, canned mixed-nuts and breakfast cereals add various individual ingredients (of varying shapes and sizes) together in small batches to ensure each serving/package is consistent (e.g., same amount of peanuts, cashews, and Brazil nuts; or same amount of wheat bran flakes and raisins). This is usually achieved through combining dividers on a conveyor belt system while the individual ingredients are fed in by volume or mass overhead or from the side. This same method can be applied for pods, namely, small batch formulas are prepared and mixed/blended with care to avoid granular convection.

### Optional Pod Coating

Pods may be further strengthened with an optional coating, but this will normally result in a slower dissolving pod. Various coating solutions may be used, such as mochigome, propylene glycol, paraffin wax, soy wax, HPMC, and HPC. HPMC and HPC are polymers that result in a smooth film finish and provide pods with more plastic deformation, reducing friability. Another coating option is citric acid. When sprayed onto the outer surface, citric acid coats and seeps into the pod, resulting in increased strength, while maintaining brittleness. A single coating, multiple coatings and coatings of various types, may be used to achieve a particular function, such as optimizing solubility or strength. The coatings may be perforated using various methods, e.g., mechanical methods or laser methods, which may be used to aid in pod solubility.

In cases where a coating is not used, various forms of packaging of the pod may be used to increase pod strength and reduce its friability during shipping and handling. Thus, packaging can be used in place of a pod coating, especially if friability is the main issue, which does not affect solubility like a pod coating

Conversion into Pods

FIG. 7 illustrates an embodiment of the present invention, namely, the process of using a compaction method to manufacture a compacted pod comprising at least one type of particle that varies in at least one physical property. The solid white circles represent at least one type of particle 110 that varies in at least one physical property. The compaction method 105 forces the particles 110 closer together, resulting in a compacted pod 100.

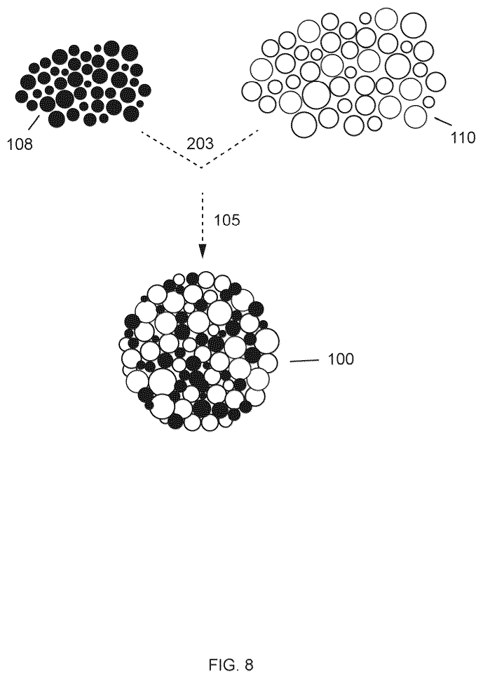

FIG. 8 illustrates an embodiment of the present invention, namely, the process of using a compaction method to manufacture a compacted pod comprising at least one type of particle that varies in at least one physical property, and at least one additive. The solid white circles represent at least one type of particle 110 that varies in at least one physical property. The solid black circles represent at least one additive 108. The particles 110 and the additive 108 are combined 203 into a formula. The compaction method 105, forces the contents of the formula closer together, resulting in a compacted pod 100.

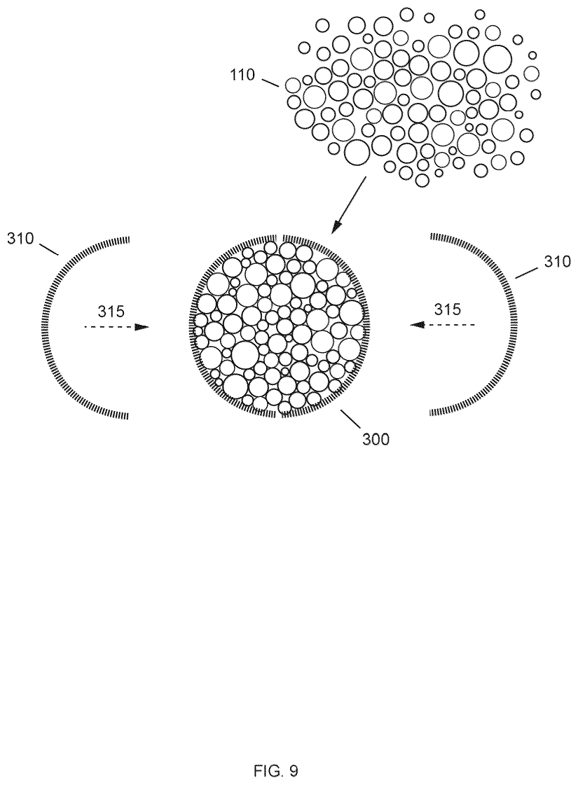

FIG. 9 illustrates an embodiment of the present invention, namely, the process of using an encapsulation method to manufacture an encapsulated pod comprising at least one type of particle that varies in at least one physical property. The solid white circles represent at least one type of particle 110 that varies in at least one physical property. Using the capsule component 310 to surround the particles 110, the encapsulation method 315 results in the encapsulated pod 300.

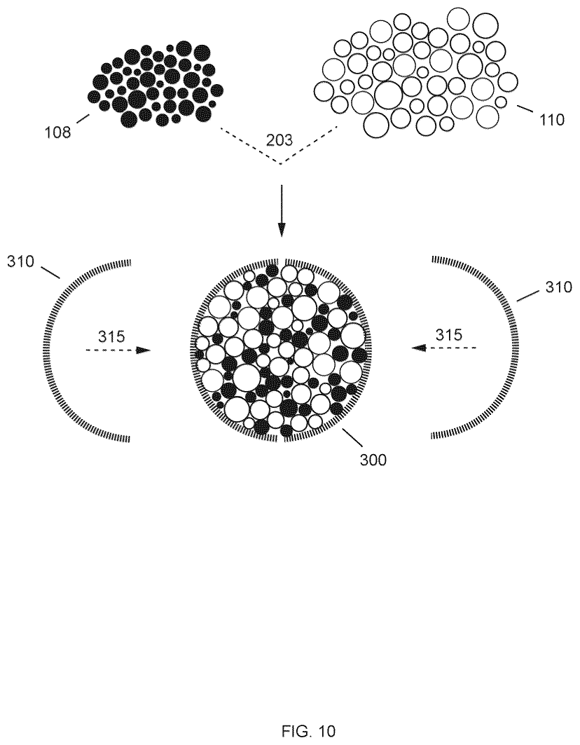

FIG. 10 illustrates an embodiment of the present invention, namely, the process of using an encapsulation method to manufacture an encapsulated pod comprising at least one type of particle that varies in at least one physical property, and at least one additive. The solid white circles represent at least one type of particle 110 that varies in at least one physical property. The solid black circles represent at least one additive 108. The particles 110 and the additive 108 are combined 203 into a formula. Using the capsule component 310 to surround the formula, the encapsulation method 315 results in the encapsulated pod 300.

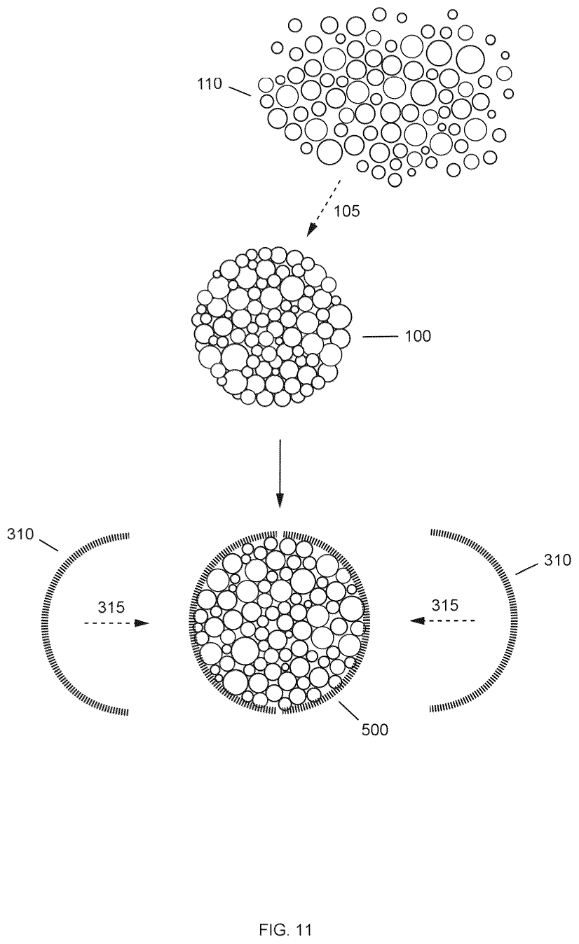

FIG. 11 illustrates an embodiment of the present invention, namely, the process of using the compaction method followed by the encapsulation method to manufacture an encapsulated-compacted pod comprising at least one type of particle that varies in at least one physical property. The solid white circles represent at least one type of particle 110 that varies in at least one physical property. By forcing the particles 110 closer together, the compaction method 105 results in a compacted pod 100. Using the capsule component 310 to surround the compacted pod 100, the encapsulation method 315 results in the encapsulated-compacted pod 500.

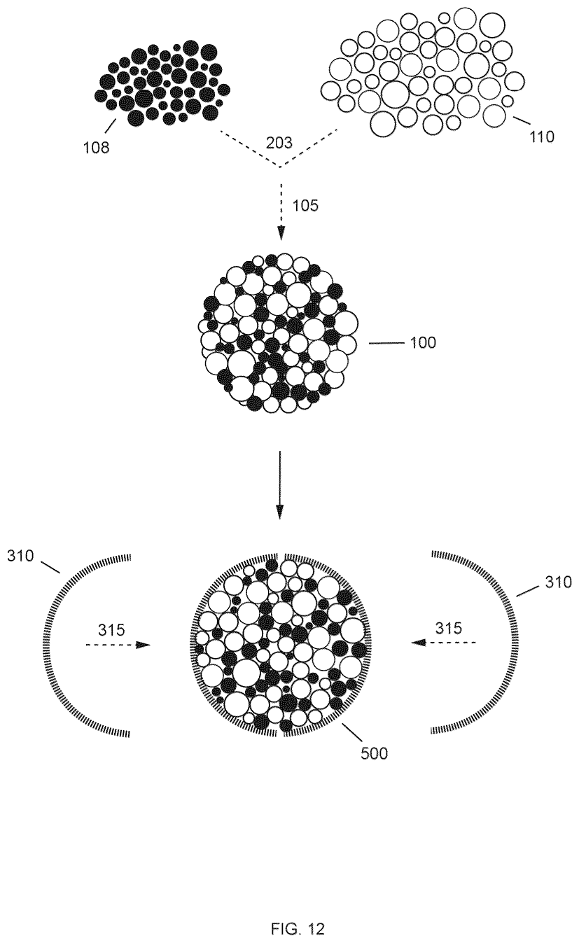

FIG. 12 illustrates an embodiment of the present invention, namely, the process of using the compaction method followed by the encapsulation method to manufacture an encapsulated-compacted pod comprising at least one type of particle that varies in at least one physical property, and at least one additive. The solid white circles represent at least one type of particle 110 that varies in at least one physical property. The solid black circles represent at least one additive 108. The particles 110 and the additive 108 are combined 203 into a formula. The compaction method 105, forcing the formula closer together, results in a compacted pod 100. Using the capsule component 310 to surround the compacted pod 100, the encapsulation method 315 results in the encapsulated-compacted pod 500.

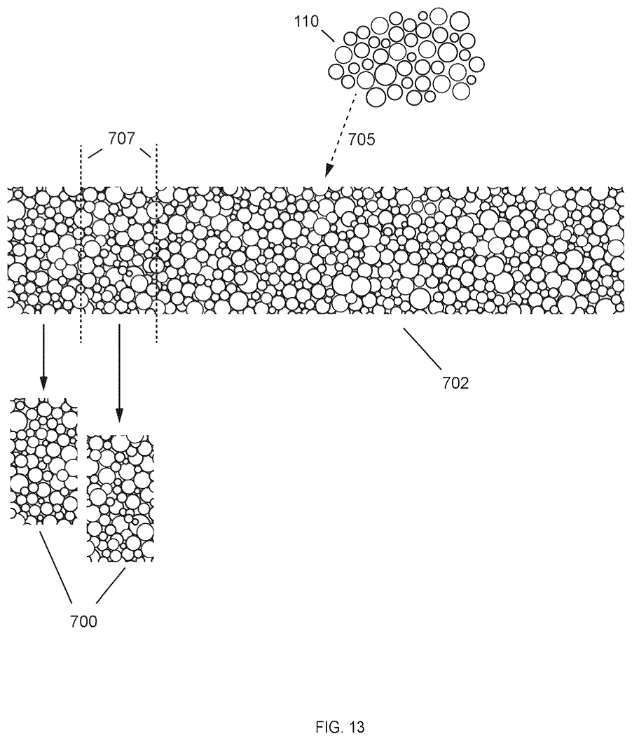

FIG. 13 illustrates an embodiment of the present invention, namely, the process of using a segmentation method to manufacture a segmented pod comprising at least one type of particle that varies in at least one physical property. The solid white circles represent at least one type of particle 110 that varies in at least one physical property. The slab compaction method 705, which is the process of forcing the particles 110 closer together, results in a slab 702. The segmentation method 707, which is the process of segmenting the slab 702, results in a plurality of segmented pods 700.

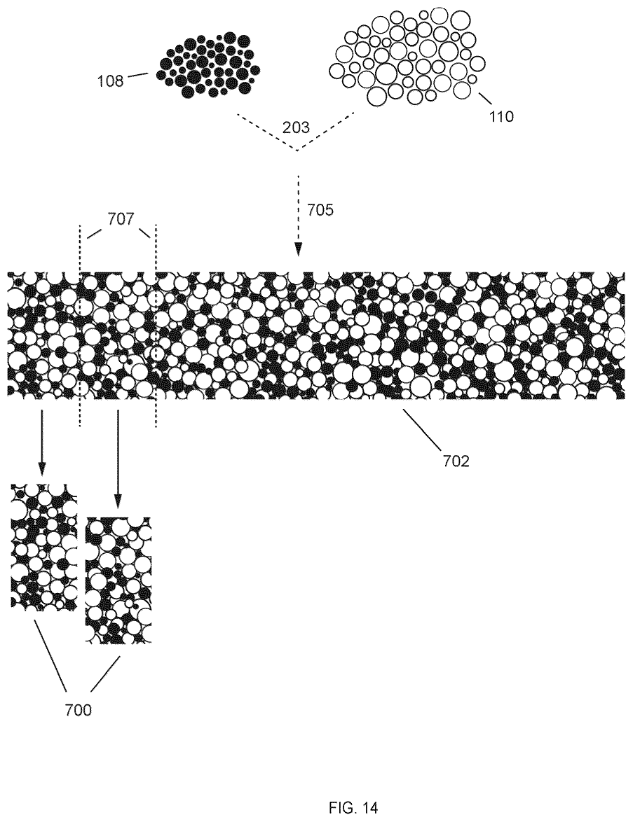

FIG. 14 illustrates an embodiment of the present invention, namely, the process of using a segmentation method to manufacture a segmented pod comprising at least one type of particle that varies in at least one physical property, and at least one additive. The solid white circles represent at least one type of particle 110 that varies in at least one physical property. The solid black circles represent at least one additive 108. The particles 110 and the additive 108 are combined 203 into a formula. The slab compaction method 705, or the process of forcing the formula closer together, results in a slab 702. The segmentation method 707, or the process of segmenting the slab 702, results in a plurality of segmented pods 700.

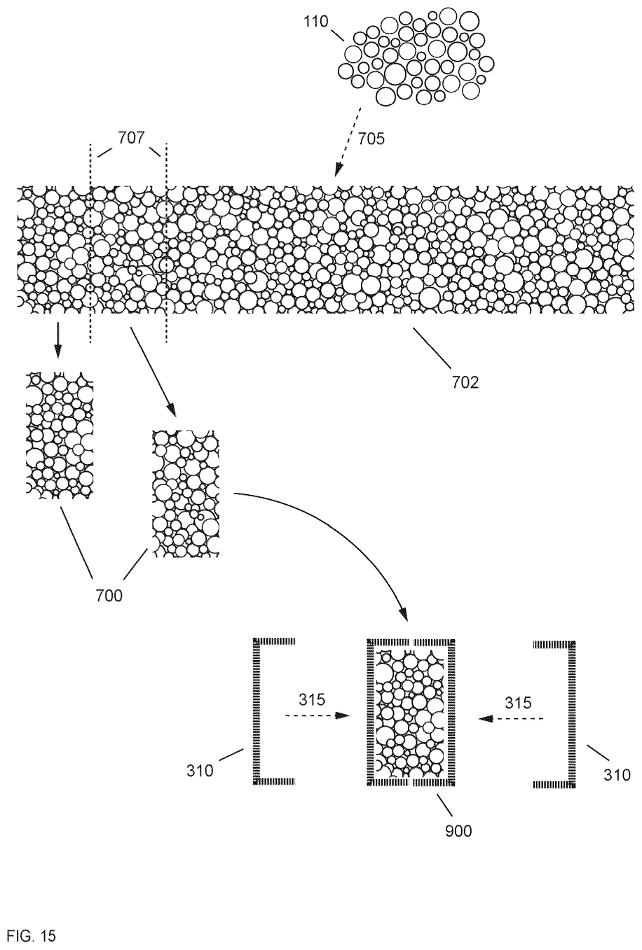

FIG. 15 illustrates an embodiment of the present invention, namely, the process of using a segmentation method followed by an encapsulation method to manufacture an encapsulated-segmented pod comprising at least one type of particle that varies in at least one physical property. The solid white circles represent at least one type of particle 110 that varies in at least one physical property. The slab compaction method 705, or the process of forcing the particles 110 closer together, results in a slab 702. The segmentation method 707, or the process of segmenting the slab 702, results in a plurality of segmented pods 700. Using the capsule component 310 to surround the segmented pods 700, the encapsulation method 315 results in the encapsulated-segmented pod 900.

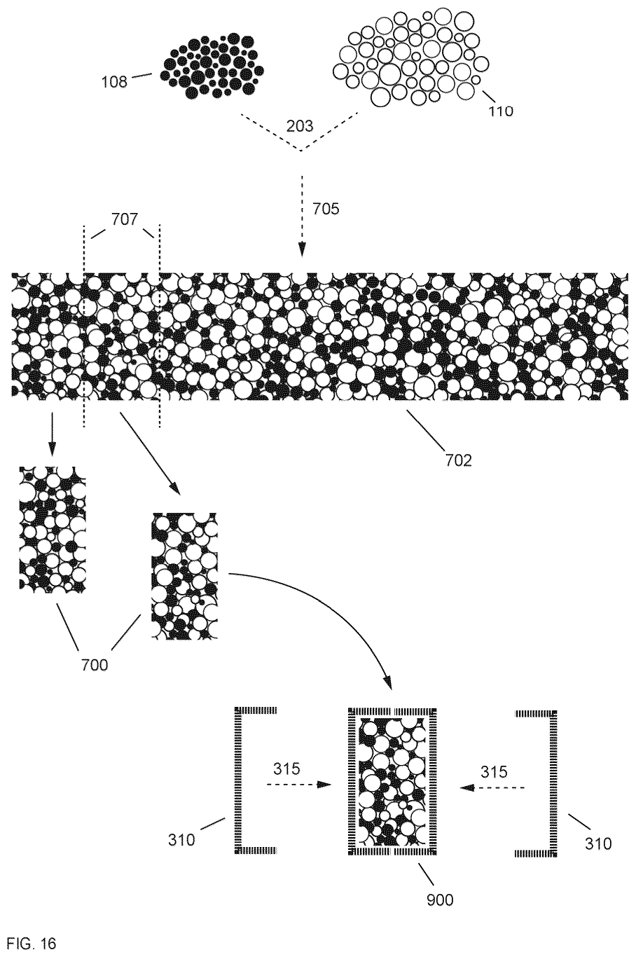

FIG. 16 illustrates an embodiment of the present invention, namely, the process of using a segmentation method followed by an encapsulation method to manufacture an encapsulated-segmented pod comprising at least one type of particle that varies in at least one physical property, and at least one additive. The solid white circles represent at least one type of particle 110 that varies in at least one physical property. The solid black circles represent at least one additive 108. The particles 110 and the additive 108 are combined 203 into a formula. The slab compaction method 705, or the process of forcing the formula closer together, results in a slab 702. The segmentation method 707, or the process of segmenting the slab 702, results in a plurality of segmented pods 700. Using the capsule component 310 to surround the segmented pods 700, the encapsulation method 315 results in the encapsulated-segmented pod 900.

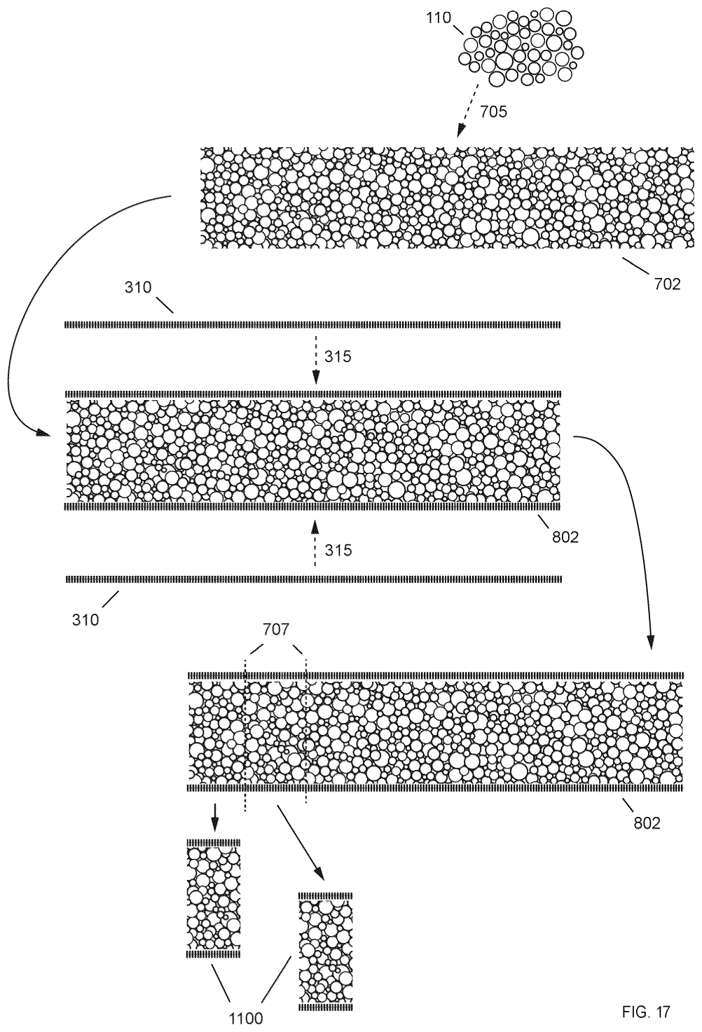

FIG. 17 illustrates an embodiment of the present invention, namely, the process of combining a segmentation method and an encapsulation method to manufacture a semi-encapsulated-segmented pod comprising at least one type of particle that varies in at least one physical property. The solid white circles represent at least one type of particle 110 that varies in at least one physical property. The slab compaction method 705, or the process of forcing the particles 110 closer together, results in a slab 702. Using the capsule component 310 to surround the slab 702, the encapsulation method 315 results in an encapsulated-slab 802. The segmentation method 707, or the process of segmenting the encapsulated-slab 802, results in a plurality of semi-encapsulated-segmented pods 1100.

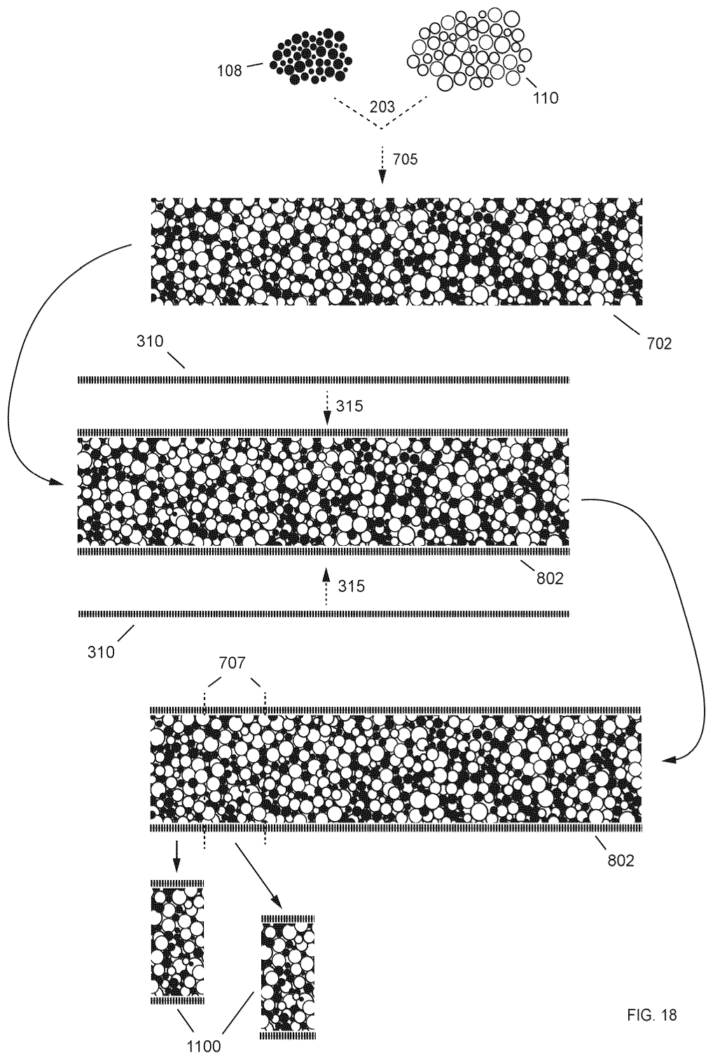

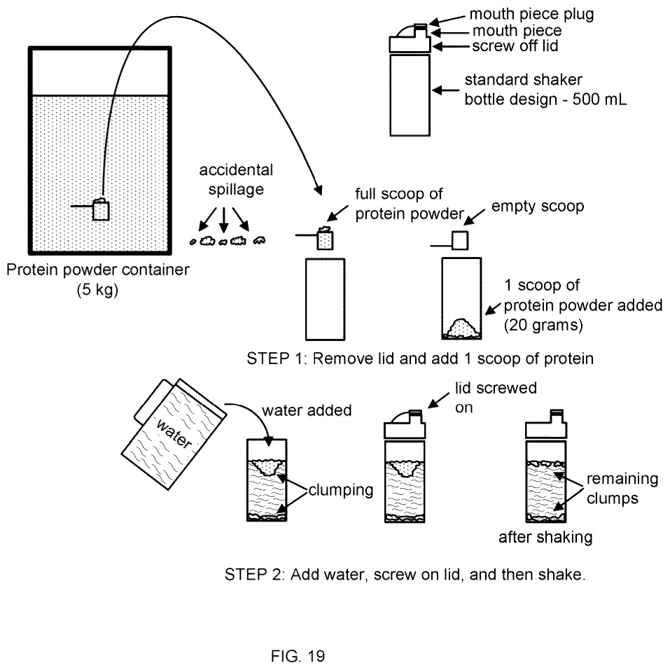

FIG. 18 illustrates an embodiment of the present invention, namely, the process of combining a segmentation method and an encapsulation method to manufacture a semi-encapsulated-segmented pod comprising at least one type of particle that varies in at least one physical property, and at least one additive. The solid white circles represent at least one type of particle 110 that varies in at least one physical property. The solid black circles represent at least one additive 108. The particles 110 and the additive 108 are combined 203 into a formula. The slab compaction method 705, or the process of forcing the formula closer together, results in a slab 702. Using the capsule component 310 to surround the slab 702, the encapsulation method 315 results in an encapsulated-slab 802. The segmentation method 707, or the process of segmenting the encapsulated-slab 802, results in a plurality of semi-encapsulated-segmented pods 1100.

Converting Supplements into Pods

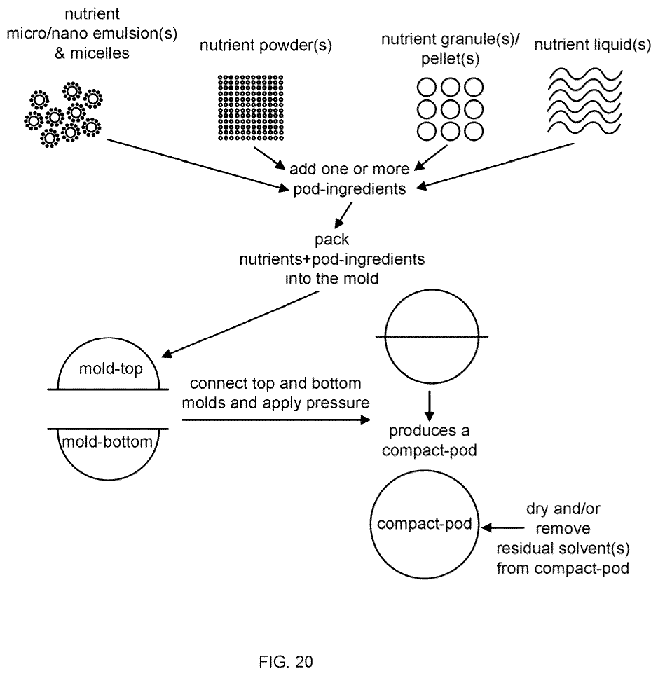

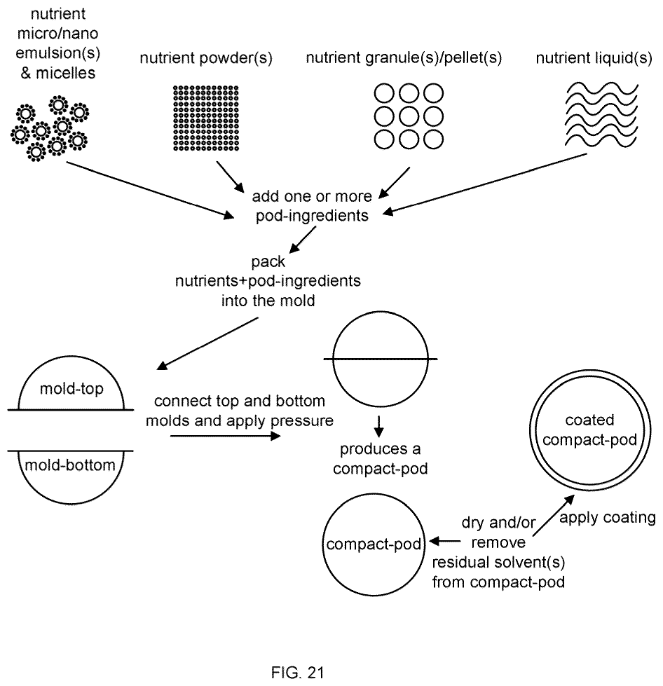

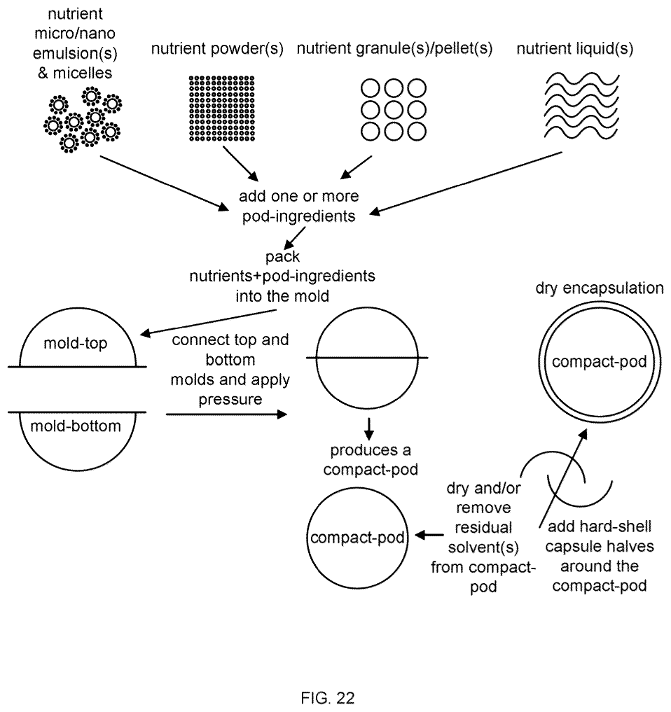

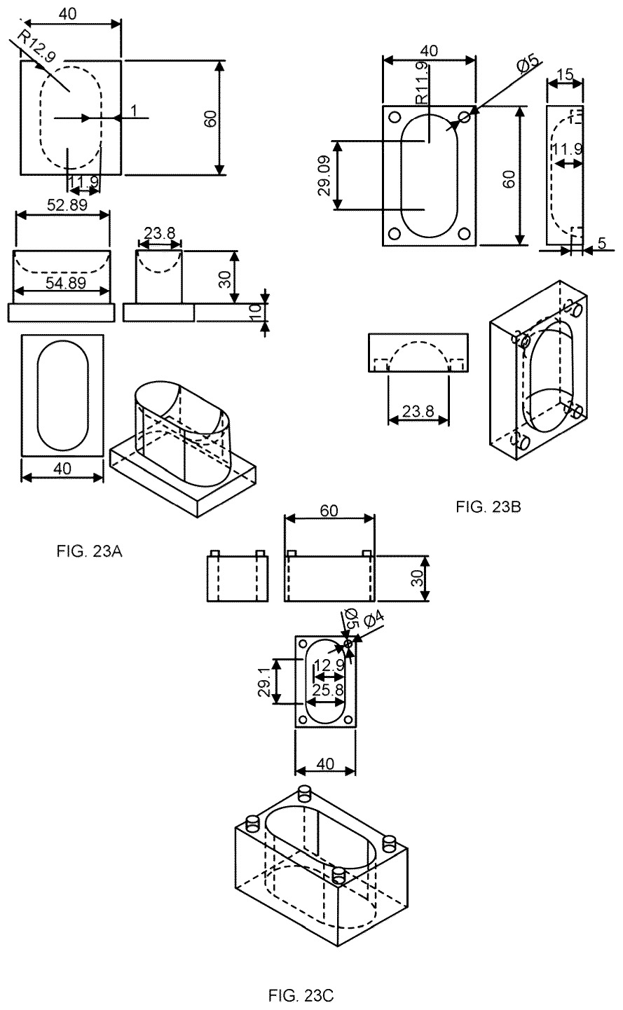

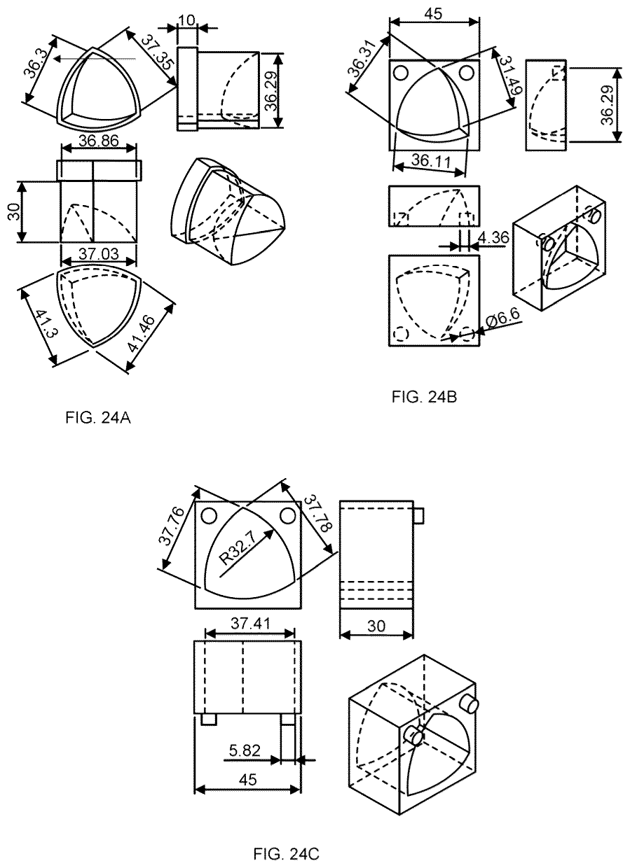

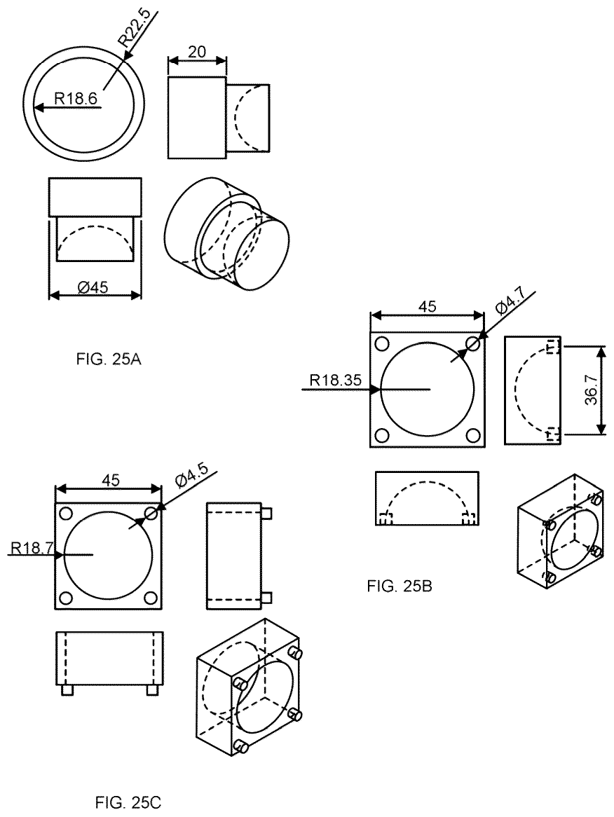

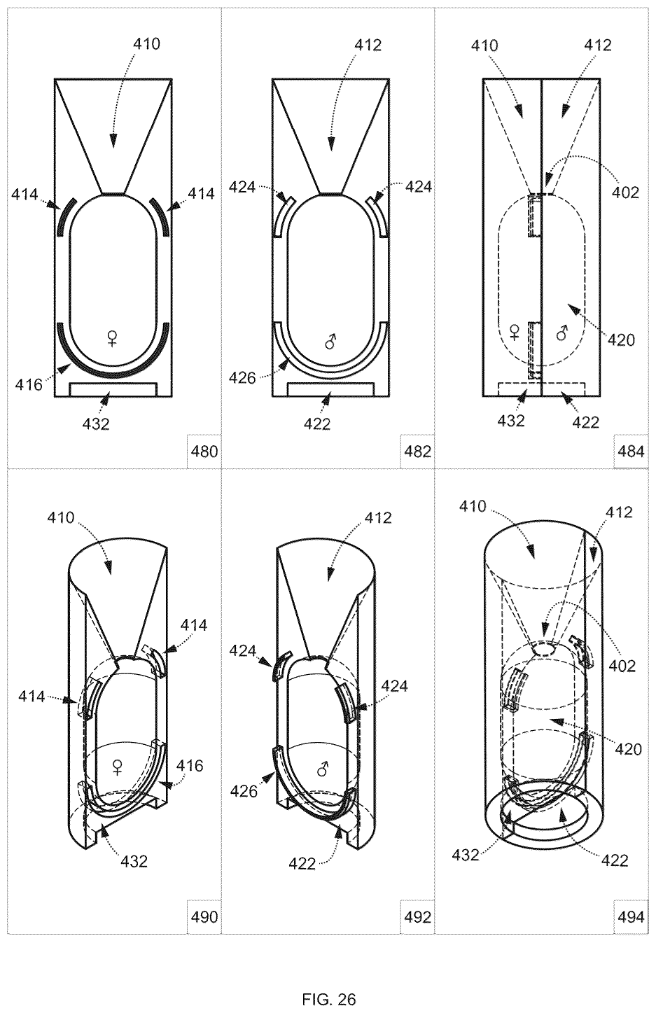

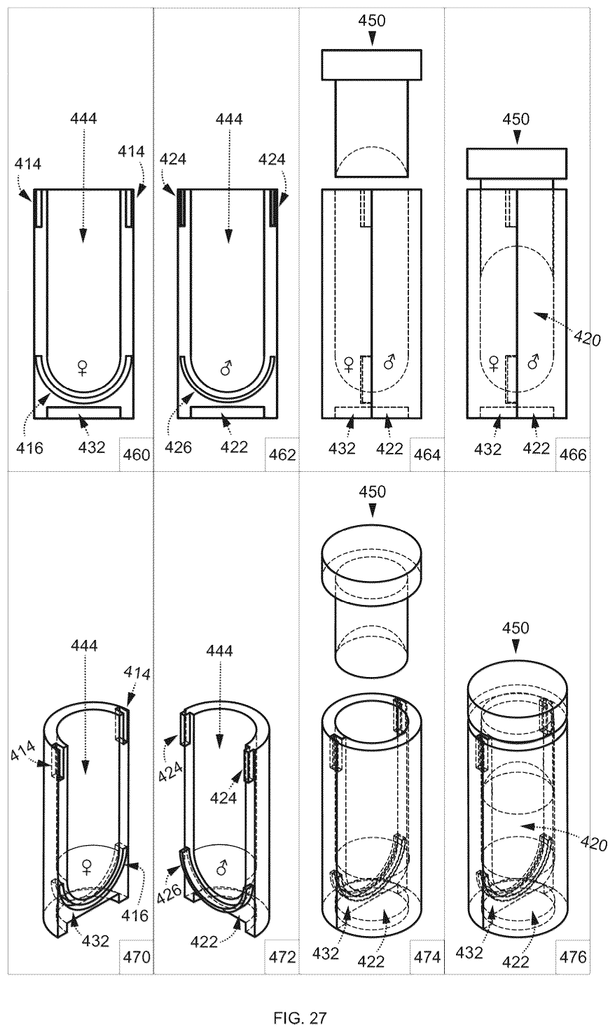

The invention teaches converting supplements into single compacted pods and/or encapsulated pods that may be dissolved into beverages. A preferred embodiment of this pod is comprised of (a) supplements, with particles of varying properties, (b) combining “a” with additives to create a formula; additives are any particles that maintain the pod's structure, such as imparting cohesion and/or adhesion properties; and/or any particles that aid in regulating dissolution/disintegration of the pod when its placed into a beverage, (c) processes for converting “a” into a pod or (d) processes for converting “a+b” into a pod, and (e) adding to the outside of the pod, such as a coating, coloring, texts, labels, embossments, films, capsules, capsule components, hard shells, or packaging. Step “c” can stand alone as the invention because it is sufficient to create a pod, with steps “d” and “e” being optional but still part of the invention as they may be necessary. The resulting pod uses compaction and/or encapsulation in a way that allows for the creation of a solid structure that is strong enough to be held and manipulated in the hand and/or can withstand a one-meter drop without breaking, while still dissolving/disintegrating (like a bath bomb or effervescent tablet) in a liquid; and/or the resulting pod may be eaten directly, allowing for dissolving/disintegration to occur in the mouth. This description of supplement particle engineering for manufacturing pods is distinct from simply compacting supplements+additives into tablets using known devices (e.g., pill-press, punch-and-die, or mold), as is typically found in industry (e.g., nutritional supplement industry, dietary supplement industry, effervescent tablet industry, and pharmaceutical industries). This application covers the methods of creating pods for all forms of supplements. See FIGS. 20-22 as examples of the potential variety of combinations of supplements (e.g., nutrients), additives (e.g., pod ingredients), compaction processes, coatings, and encapsulation processes (e.g., using hard-shell capsule halves, which are a type of capsule component) for creating a pod.

The solubility/disintegration of select supplements (e.g., those existing as hydrophobic particles or oils) may be enhanced by:
dissolving the supplements in a solvent creating a solution/suspension/colloid. Examples of solvents may include organic solvents, such as methanol, ethanol, pentane, and/or hexane. Then adding the resulting solution/suspension/colloid to the pod formula and/or adding as part of the pod coating. Residual solvents may be removed through additional steps, e.g., drying, desiccation, and vacuum oven drying;
combining the supplements with amphipathic molecules in solution to form a solution/suspension/colloid of hydrophilic nanoparticles or microparticles of supplements (i.e., emulsions of micelles, liposomes, or pro-liposomes). The amphipathic molecules encapsulate the supplements. Examples of amphipathic molecules may include hydrophobia proteins, casein proteins, late embryogenesis abundant proteins (LEA proteins), cholesterol, surfactants, emulsifiers, detergents, phospholipids, fatty acids, bile acids, glycolipids, saponins, bolaamphiphilic molecules, pepducins, AP proteins, and a variety of proteins and peptides considered amphiphiles;
the hydrophilic nanoparticles and/or microparticles may remain in liquid form and be added to the pod formula and/or added to the pod coating. Alternatively, the hydrophilic nanoparticles and/or microparticles may be subsequently dried (e.g., freeze dried), resulting in dry particles. The resulting dry supplement nanoparticles and/or microparticles may be added to the pod formula or be added to the pod coating;
combining dry particles, the supplements with amphipathic molecules, may also be used to improve pod solubility/disintegration;

The above methods can vary or be combined depending on the supplement(s) being formulated into a pod to improve dissolution/disintegration rate and/or increase mechanical strength. Examples of pods formulas are listed below in EXAMPLE FORMULAS.

### Example of Molds

Mold designs can vary widely depending on the compaction method. For example, 3-piece mold systems may be made using a 3D-printer and a CNC machine, see FIGS. 23-27 as examples. Other designs may work as well, but the 3-piece design, as shown in FIGS. 23-25, is sufficient to produce a pod and is included in the process portion of the present invention. FIGS. 26-27 illustrate two alternative embodiments for use with a centrifuge.

### EXAMPLE FORMULAS

The formulas in the examples below were determined to be optimal for compaction, strength and dissolution/disintegration-rate. In a first example for a given pod volume, increasing the dissolution agents in the formula typically results in a pod that dissolves faster, but this is at the cost of using a lower percentage of supplement(s) per pod and altering the flavor away from the supplement's original flavor. In a second example for a given pod volume, decreasing the dissolution agents in the formula typically results in a pod that dissolves slower (e.g., >2 minutes), although the amount of supplement(s) could be increased in lieu of the space no longer taken up by the dissolution agents (as in the first example) for the given volume, and the flavor is less altered from the supplement's original flavor.

### Example 1: Three Commercially Available Whey Protein Powders Purchased in Japan (Strawberry Flavor, Chocolate Flavor or Vanilla Flavor)

Twenty-five (25) grams of whey protein powder were engineered to be more varied in particle size via the layer removal method of the present invention, and then formulated into a pod by the addition of the following additives, by mass:
dissolution agent(s), e.g., an organic acid(s) and/or bicarbonate salt(s)/carbonate salt(s) (1-20% by mass); and
binding agent(s), e.g., HPMC and/or HPC dissolved in a solvent such as 1-5% solute-to-solvent solution (0.1-10 mL of the binding agent was used per 25 grams of dry formula ingredients).

This mixture was then mixed while wet/damp (but not granulated) and added to a mold, and compacted. The pod was then removed from the mold and dried to remove (i.e., evaporate) some, or all, of the solvent (i.e., the solvent contained in the binding agent). The pod was then spray-coated with the following coating to enhance structure and appearance:
cellulose derived viscoelastic polymer in solution, e.g., HPMC and/or HPC dissolved in solvent (1-5% in water and ethanol)

The coated pod was then dried. The resulting pod self-dissolved/disintegrated, at least partially, into water in ˜2 minutes (experimentally determined). Note that the binding agent and coating were the same in this example

### Example 2: Commercially Available Soy Protein Meal Replacement (a Granulated Powder) Purchased in Japan (Mixed Berry Flavor)

Fifty (50) grams of soy protein meal replacement was formulated into a pod by the addition of the following additives:
dissolution agents (5-15% final mass); and
binding agent(s), e.g., HPMC and/or HPC dissolved in a solvent (1-5% in water and/or ethanol; 0.1-15 mL of the binding agent was used per 25 grams of dry formula materials.

This mixture was then mixed while wet/damp and a portion of the formula was further granulated. The formula had a particle size mode (major peak) of ˜180 mm and the further granulated portion had a particle size mode (major peak) of ˜800 mm. These were mixed/blended at a 5:1 ratio (180 mm sized particles:800 mm sized particles) and then added to a mold and compacted. Note, this is a variation of the combination method.

The pod was then removed from the mold and dried to remove (i.e., evaporate) some, or all, of the solvent (i.e., the solvent contained in the binding agent). The pod was then spray-coated with the following coating to enhance structure and appearance:
cellulose derived film-forming polymer (1% in solvent) and/or cannabidiol dissolved in ethanol (1-10% solute to solvent)

The coated pod was then dried. The resulting pod self-dissolved/disintegrated, at least partially, into a liquid solution in ˜2 minutes (experimentally determined).

### Example 3: Vitamin D2 (Ergocalciferol in Casein Micelles)

Hydrophobic molecules (e.g., fat soluble vitamins) or cannabinoids like cannabichromene, cannabidivarin and/or cannabidiol were encapsulated into nano-microparticles (to make them water-soluble) using known methods.

The resulting nano/microparticles were then filtered and freeze-dried to create dry particles. These dry particles were formulated by the addition of the following:
dissolution agents (1-10% final mass)
supplement(s) of varying particles sizes (70-95%)
binding agent in solvent (1-5%)

This formula was then mixed and added to a mold. The pod was then removed from the mold and dried to remove (i.e., evaporate) some, or all, of the solvent (i.e., the solvent contained in the binding agent). The resulting pod self-dissolved, at least partially, into a liquid solution in ˜5 minutes.

### Example 4. High-Protein Meal Replacement Powder (Protein-Meal Powder) Engineered Using the Layer-Removal Method

This method teaches the importance of varying particle size within the PSD when manufacturing pods meant for dissolving in aqueous solutions.

A Protein-Meal powder used for patients in a hospital setting requires a controlled caloric and nutrient diet. Patients are prescribed one serving of Protein-Meal powder per day (one scoop should equal 25 grams of total powder). In this example, the macronutrient content is:
14 g protein (56% by weight and 55% by calorie)
2.3 g fat (9.2% by weight and 20.3% by calorie)
6.2 g carbohydrates (24.8% by weight and 24.3% by calorie)
2.5 g remaining weight comes from micronutrients and other trace nutrients.

Patients were given a 1 kg bag of the powder and were required to prepare the 25 grams of the powder (1 scoop full) by mixing it with 500 mL of water, to create a beverage, 2× per day. Patients were found to routinely consume less than 25 grams due to (1) the powder sticking to the cup once mixed with water, (2) powder sticking to the spoon used for mixing the powder with water, and (3) powder being spilt on the table surface during the preparation process (accidental spillage). In addition, patients did not consume the clumps of powder left after drinking the beverage. Clumps floated at the liquid surface, but ended up at the bottom and sides of the cup as the beverage was consumed. This Protein-Meal powder served as a real world application for conversion into pods because pods were developed to resolve these problems surrounding proper dosage and ease of preparation.

The Protein-Meal powder was obtained from the manufacturer and the particle size was found to be less than 150 microns. The powder was resized (engineered) via a combination of wet and dry granulation techniques and/or milling Four separate particle sizes were engineered (e.g., to create a varying particle size) and size ranges were selected based on available sieve meshes:

| Layer | Micron Range |
|---|---|
| A | 50-199 (149 micron range) |
| B | 200-299 (99 micron range) |
| C | 300-699 (399 micron range) |
| D | 700-1000 (300 micron range) |

These 4 layers of engineered particles were blended to create a Protein-Meal formula, which consisted of these layers and percentages, A(30%)+B(30%)+C(30%)+D(10%), which became the control formula.

Two hypotheses were tested related to the layer-removal method: (1) Compared to using the control formula, pod performance would be improved by removing one or more layers from within the PSD, e.g., removing layers B, C, or B+C; and (2) Compared to using the control formula, pod performance would be decreased by removing one or more layers from the ends of the PSD, e.g., removing layers A, D, or A+D.

In a first round of testing using the control formula as the starting point (i.e., layers A+B+C+D), one or more layers were removed to create 6 additional formula variants for comparisons, namely, A+D, A+C+D, A+B+D, A+B+C, B+C+D, and B+C. Note that as a layer(s) was removed from the control formula, the percentage was adjusted commensurately.
A (30%)+B (30%)+C (30%)+D (10%)—control formula
A (75%)+D (25%)
A (43%)+C (43%)+D (14%)
A (43%)+B (43%)+D (14%)
A (33.3%)+B (33.3%)+C (33.3%)
B (43%)+C (43%)+D (14%)
B (50%)+C (50%)
   Additives included:
dissolution agents, two organic acids (citric acid and ascorbic acid) and a bicarbonate salt (sodium bicarbonate)
binding agent, a solution of 1-10% HPMC.

The steps required to make pods using Protein-Meal formula (control formula and formula variants) were as follows:

STEP 1. The Protein-Meal powder and dissolution agents were weighed out and blended to create a dry formula, in the following order:
Protein-Meal (80-95%)
citric acid (1-10%)
ascorbic acid (1-10%)
sodium bicarbonate (1-10%)
   Note, comparisons among the control formula and formula variants used the same percentage of additives.

STEP 2. 1-6 mL binding agent solution was added per 25 g of the dry formula and the resulting formula was mixed.

STEP 3. The formula was heated between 50-70° C. for 1-5 minutes. The heat was used to evaporate some of the solvent contained in the binding agent solution and start the solidification process of the binding agent.

STEP 4. The formula was put into a capsule shaped mold and compacted for 1-10 minutes to create a 25 g pod, the serving size. Note, the addition of the HPMC adds a negligible amount of additional weight to the pod.

STEP 5. The pod was demolded (taken out of the mold), allowed to dry (remove residual solvent from the binding agent solution), and sit to solidify. Drying occurred in a desiccation chamber for up to 24 hrs. at 20° C. with a relative humidity less than 10%. This temperature improved the pod's shelf life.

STEP 6. The resulting pod was performance tested, which included standard assays for strength and disintegration in solution. In addition, novel methods were developed for assaying the rate of disintegration, which combined audio and video data.

Results. Compared to pods made using the control formula, strength was maintained within an acceptable range for all formula variants. Additionally, pod strength was further improved by adding a coating containing 0.1-10% HPMC-EtOH-solution and/or 0.1-10% citric acid-EtOH-solution. The disintegration performance was more variable among the groups, and the outcome measure became the focus. Compared to a pod made using the Protein-Meal control formula, removing a single layer (B or C), from within the PSD range (A-B-C-D), resulted in improved performance (i.e., the pod disintegrated faster). Furthermore, removing two layers (B and C), from within the PSD range, resulted in even better performance. Compared to the pod made using the Protein-Meal control formula, removing a single layer (A or D) from either end of the PSD range resulted in worse performance (i.e., the pod disintegrated slower). Furthermore, removing two layers (A and D), from both ends of the PSD range, resulted in even worse performance. Note, the layer removed is on the microns (or micrometers) scale.

In a second round of testing, the control formula was compared to additional formula variants, see here:
Another formula variant of A+D included using A at 85% and D at 15%.
Another formula variant of A+D included using A at 70% and D at 30%.
Another formula variant of A+D included using A at 50% and D at 50%.
Another formula variant of A+C+D included using A at 50%, C at 40%, and D at 10%.
Another formula variant of A+B+D included using A at 46%, B at 46%, and D at 8%.
Another formula variant of A+B+C included using A at 35%, B at 35%, and D at 30%.
Another formula variant of A+B+C included using A at 35%, B at 35%, and D at 30%.
Another formula variant of B+C+D included using A at 50%, B at 40%, and D at 10%.
Another formula variant of B+C included using B at 70% and C at 30%.
Another formula variant of B+C included using B at 30% and C at 70%.

The results were consistent, and similar, to the first round of testing, namely, removing a layer (i.e., creating a gap) from within the PSD range improved performance compared to the control. Furthermore, this layer-removal method was repeated for several supplement particle types (e.g., protein isolates (whey and soy) and collagen peptides) and the results were similar. Pods with a density between ˜550 kg/m3 and 675 kg/m3, performed best for all performance tests. Note, water's density is 1000 kg/m3, thus explaining why these pods floated in water.

All disintegration performance results are summarized below, ranked from best (top—disintegrated fastest) to worst (bottom—disintegrated slowest):

| | Gap between |
|---|---|
| Formula | Layers (μm) |
| A (85%) + D (15%) | 499 |
| A (75%) + D (25%) | 499 |
| A (70%) + D (30%) | 499 |
| A (50%) + D (50%) | 499 |
| A (50%) + C (40%) + D (10%) | 99 |
| A (43%) + C (43%) + D (14%) | 99 |
| A (46%) + B (46%) + D (8%) | 399 |
| A (43%) + B (43%) + D (14%) | 399 |
| A (30%) + B (30%) + C (30%) + D (10%) − Control | 0 |
| A (35%) + B (35%) + C (30%) | 0 |
| A (33.3%) + B (33.3%) + C (33.3%) | 0 |
| B (50%) + C (40%) + D (10%) | 0 |
| B (43%) + C (43%) + D (14%) | 0 |
| B (70%) + C (30%) | 0 |
| B (50%) + C (50%) | 0 |
| B (30%) + C (70%) | 0 |

Evidence was found to support Hypothesis 1, namely, improved performance compared to the control group because the removal of a middle layer (B, C, or B+C) leaves a gap in the PSD range, which resulted in pods that disintegrated faster.

Evidence was found to support Hypothesis 2, namely, decreased performance compared to the control group because the removal of an outer layer (A, D, or A+D) resulted in pods that disintegrated slower.

### Overview of Each Performance Test

Strength was assayed in the following way: A pod was weighed. The pod was dropped from a 1 meter height onto a plastic tray, and then reweighed. This was repeated 9 more times or the assay was stopped if more than 10% of the weight was lost from chips and breaks (i.e., changed by more than 10% from the starting weight). The percentage of remaining particles were calculated ((ending weight/starting weight)*100).

Disintegration rate was assayed in the following way: A pod was weighed. A pod was placed into 25° C. tap water for 2 minutes. The major pieces of the remaining pod, floating on top, were removed, dried, and weighed. The percentage of remaining pod was calculated ((ending weight/starting weight)*100). A lower remaining weight was considered good performance, with complete disintegration being the ideal performance.

Disintegration rate was assayed using audio-video analysis in the following way: A hydrophone (e.g., Ambient ASF-a MK II or ASF-2 MKII) was placed into a beaker containing water. The sound recorder (e.g., ZOOM H6) was turned on. A pod was put into the beaker. As the pod disintegrated, the hydrophone recorded the sound data of the disintegrating pod (e.g., effervescent reactions). Using the sound data, select properties of sound (e.g., wavelength, amplitude, frequency, time period, and velocity) were correlated to the pod's rate of disintegration using the naked eye (overall time to disintegrate and any changes in rate). This audio data was further enhanced when combining with video data, especially when the camera was viewed overhead (or underneath) the beaker as the pod dissolved across the water's surface. A side view of the beaker was also useful to record characteristics of the particles that fall to the bottom of the beaker (those that do not dissolve). Using an in-house program, the audio and video recordings were integrated to provide a more precise measure of the pod as it disintegrated. This method was found to be faster in obtaining informative data on pod disintegration performance as compared to existing known methods. In addition, this method was shown to be helpful in assaying tablets that sink in water, e.g., standard effervescent tablets that are denser than pods. The model was further improved when including data from the rate of CO2 production using a sensor (e.g., detecting dissolved CO2 and/or CO2 measured from near the water's surface).

### Example 5. Creatine Containing Pods Manufactured Using Ion-Induced (Ionotropic) Gelation

This method teaches the manufacturing method of 30 gram pods containing a pre-workout supplement (with creatine), calcium, and alginate.

Combine water with sodium alginate and mix to make a 0.1-20% sodium alginate solution. In this example, sodium alginate is used as the polymer. Add the pre-workout supplement (0.01-80% by weight), of varying particle size, to the sodium alginate solution and mix to create a formula. Supplement particles do not have to be soluble in the sodium alginate solution, and may remain as a suspension and/or colloid.

Add an additive to the formula (e.g., final additive percentage 0.01-50%) and mix. The additive does not have to be soluble in the sodium alginate solution, and may remain as a suspension and/or colloid.

Add the formula to a calcium chloride solution (0.1-2 molar concentration or 0.1-50%). Calcium acts as the crosslinker, although other monovalent, divalent or trivalent cations may suffice. Increasing the molar concentration, or percentage, of calcium in solution may be manipulated to control the gelation rate of the gel formation. In addition, other sources of calcium may be used, as this process is not limited to calcium chloride. The formula may be injected, dropped, or submerged into the calcium chloride solution. The formula may also be put into a mold, and the calcium chloride be added to the formula, e.g., sprayed on, soaked in, or poured onto the formula.

The result is a wet poly-pod (polymer pod), which may be in any 3-dimensional shape. Poly-pods solidification may be modified with heating and/or cooling.

The wet poly-pod is further dried to remove a majority of the water content, which produces the final dry poly-pod. Drying methods include using heating/dehydrating, desiccation, a vacuum oven, freeze-drying, microwaves, centrifugation, a gas (e.g., nitrogen), and other methods involving gasses with or without pressure).

The resulting dry poly-pod can be rehydrated by putting it into a beverage and consuming.

### Other Findings Worth Mentioning

The type of effervescent ingredients were shown to affect the solubility of compacted pods. For example, compacted pods were made from combining sodium bicarbonate (as the bicarbonate salt), with two organic acids, either citric acid or ascorbic acid. Pods were made with a variety of protein supplements, of varying particle sizes (e.g., engineered particles using previously described methods including layer removal, combination, or redistribution). Pods made with citric acid were stronger compared to pods made with ascorbic acid, assayed via dropping the pod from a distance of 1 meter onto the ground (measuring the breaks per drop). Meaning, the inclusion of citric acid resulted in less pod breaks compared to the inclusion of ascorbic acid. Pods made using ascorbic acid dissolved/disintegrated faster compared to pods made using citric acid. Thus, combining the two acids was shown to have the optimal balance between solubility/disintegration of the pod (gained from the ascorbic acid) and strength (gained from the citric acid). Interestingly, citric acid and bicarbonate salts are the more common reactants in standard effervescent tablets. It is thought that pods behave differently compared to standard effervescent tablets because pods contain mostly supplement particles (like protein), and/or because the particles have been purposely engineered to be varying particle sizes. Cannabinoids, e.g., cannabidiol, may also be used to modulate the strength of the pod, as was described for citric acid. Spraying citric acid onto a compacted pod, as coating, was also shown to improve the pod's strength.

When comparing the volume (size) of standard tablets (e.g., effervescent tablets) to pods, pods are less dense, and on average require less effervescent ingredients. Supplements with varying particle size can be compacted at low densities, which in turn results in a compacted pod that requires less effervescent ingredients to solubilize/disintegrate the pod when the pod is placed into a solution, e.g., water. This also allows pods to be made much larger than standard effervescent tablets (i.e., those <35 mm in diameter). For example, using standard effervescent tablet methods, there is a positive correlation between volume and compression force, namely, as a tablet's volume increases so does the force required to compress the formula ingredients into the tablet. There is also a positive correlation between force and amount of effervescent ingredients, namely, as a tablet requires more compression force, the more effervescent ingredients are required to solubilize/disintegrate the tablet (if trying to maintain a similar rate of dissolving/disintegration). As a pod volume increases, so does compression force, but the amount is less relative to tablets, i.e., the slope of the line is less steep (smaller). This means the amount of effervescent ingredients required for a given volume is also lower for pods. It is these features that allow pods to scale up in size while maintaining acceptable rates of solubility/disintegration when the pod is placed into water. Density for some supplement powders (e.g., protein supplements) is less than water when converted into a pod and the pod will float at the water's surface as it dissolves/disintegrates. In addition, pods made with larger particles (e.g., those >800 microns) can further enable pods to scale up in volume; whereas increasing particle size with standard tablets is known to require increased compression forces to the point the dissolution/disintegration is negatively impacted.

### Definitions

[a] Supplements are defined here as any natural, synthetic, or semi-synthetic (a) macronutrient (protein(s), carbohydrate(s), lipid(s), nucleic acid(s)), (b) micronutrient(s) (vitamin(s) and/and mineral(s)), or other compound used by living organisms to maintain homeostasis and/or cellular function. ‘Supplements’ can be derived from any bacteria and/or fungus and/or plant and/or animal, or be a byproduct of any bacteria and/or fungus and/or plant and/or animal. Note that ‘supplement(s)’ can include dehydrated and/or liquid cannabis-derived compound(s) (e.g., macronutrient(s) and/or micronutrient(s) and/or terpinoid(s) and/or flavonoid(s), and/or phytocannabinoid(s) and/or wax(s) and/or lipid(s)) from any cannabis plant(s); these may be included as ‘supplement’ in this definition. ‘supplement(s)’ include anything regarded as a nutritional supplement(s), whether mentioned above or not. Note that additives differ from supplements by their purpose of use, see definition of additives. Note, the supplement is equivalent to the API discussed in drug formulas as the supplement is the substance that is desired for delivery to the body. It is possible that some supplements may serve the role as an additive (e.g., an excipient), but would not be considered a supplement in that context.

Supplements can take the form of:
solids (e.g., powders and/or granulated powders and/or granules and/or pellets and/or dust and/or fibers and/or crystals and/or flakes and/or slugs)
liquids (whether in solution and/or suspension)
semisolids (e.g., hydrogels, aerogels, gels, jellies)
emulsions/micelles/liposomes/pro-liposomes
nanopowders/nanoparticles and/or micropowders/microparticles
supplement(s) encased/entrapped in hydrophilic particles/amphiphilic particles/amphipathic particles
emulsions that have been cross-linked and dried
absorbent materials
processed whole foods (plant, animal, and/or microorganisms-derived)
gas, for infusing into the pod, e.g., through adsorption and/or absorption.

Supplements may be in a pure, isolated form (i.e., a single ingredient) or be formulated or adulterated (i.e., one or more other ingredients). Supplements in particle form can be covered using microencapsulation and/or spray agglomeration, e.g., microencapsulation of citric acid to reduce its reactivity during manufacturing and formulation.

Supplement examples: Whey is a supplement and may include one or more components, such as bovine colostrum, beta-lactoglobulin proteins, alpha-lactalbumin proteins, bovine serum albumin proteins, lactoferrin, and immunoglobulins. Soy is a supplement and may include isoflavones. Microorganisms (bacteria, fungal, archaea), microalge, and/or their byproducts are considered supplements (which may be in dry form); these organisms may be naturally occurring, be engineered, and/or selected for desirable traits. Branched chain amino acids (BCAA) are a supplement and may include essential amino acids such as leucine, isoleucine, and valine Amino acids, the building blocks of proteins are a supplement and may include creatine, glutamine, and beta-alanine. Sweeteners are supplements and may include sugar, herbal sugar, monk fruit, syrup, glucose, aspartame, acesulfame potassium (Ace-K), sucralose, neotame, advantame, saccharin, stevia, black sugar, brown sugar, brazzein, monellin, thaumatin, miraculin, fungal derived proteins (naturally occurring or engineered), yeast and yeast byproducts (naturally occurring or engineered), bacteria and bacterial byproducts (naturally occurring or engineered), Okinawan brown sugar (kokuto or kuromitsu), sweet proteins, sweet amino acids, and other artificial sweeteners. Plants are a supplement and may include materials derived from whole plants, plant parts (roots, leaves, flowers, stems, trunks), parts produced by plants (e.g., fruits and seeds), and anything considered a vegetable. Examples include brown rice, pea, hemp, alfalfa, chia, flax, artichoke and quinoa. Plant extracts (those derived from plants but are a subset of molecules) are a supplement and may include beet root extract, cannabinoids, tea extracts, coffee extracts, oxyresveratrol, resveratrol, cannflavins (including cannflavin A, cannflavin B, and cannflavin C) and caffeine. All forms of plant extracts, using extraction methods such as solvent, mechanical, supercritical CO2, solid phase, soxhlet, steam distillation, ultrasound assisted, liquid-liquid, acid-base, solid-liquid, maceration, microwave assisted, heat reflux, pressure, etc. Products sold and/or marketed using language such as “pre workout”, “intra workout”, “post workout”, “sport powder”, “performance supplements, or “performance drugs” are considered supplements. Dried protein is considered a supplement and may be derived from any organism. For example animal tissue derived protein would include red meat, fish, poultry, and eggs. Supplement includes foods that have been processed and reduced to a dry form that can be used in pods. Products sold as “protein powder” are considered supplements and may include whey protein, whey protein concentrate (WPC), whey protein isolate (WPI), whey protein hydrolysate, soy protein, soy protein concentrate, soy protein isolate, pea protein, hemp protein, oat protein, rice protein, casein protein, collagen protein (and collagen peptides and hydrolysed collagen protein), egg protein, egg white protein, peanut butter protein, milk protein, dietary protein, plant protein, animal protein, enzymes, insect protein, cricket protein, black soldier fly protein, black soldier fly larvae protein, mealworm protein, baby formula, infant formula, protein-rich (>20% of the dry formula), super protein-rich powders (>80% of the dry formula), and formulas such as sport powders, meal replacement powders, powdered diets meant for young children and infants. Product sold for “joint health” are considered supplements and may include glucosamine (amino sugar) and chondroitin. Metabolites formed in the body after consuming a supplement are also considered supplements, which may include betaine (a metabolite) and cannabinoid metabolites; thus the supplement serves as a pro-drug that is meant for further processing in the body for achieving its functional form. Supplements also include spore powder, vitamins, minerals, alpha-GPC (cholinergic), biotin/vitamin B7, zinc, anabolic steroids, simulants, L-citrulline, black pepper extract, creatine, nucleic acids (e.g., Deoxyribonucleic acid, DNA, mitochondrial DNA, double stranded DNA, single stranded DNA, Ribonucleic acid, RNA, messenger RNA, transfer RNA, ribosomal RNA, miRNA, microRNA, small nuclear RNA, small nucleolar RNA, SnoRNA, lncRNA, Long non-coding RNA, piRNA, Piwi-interacting RNA, non-coding RNA), inulin, cannabinoids, phytocannabinoids, and their metabolites are considered supplements and may include cannabidiol, CBD, delta-9-tetrahydrocannabinol, H4CBD, HHC, HHCH, CBC, cannabichromene, CBDV and cannabidivarin. Psychedelic drugs are considered supplements and may include mescaline, LSD, psilocybin, psilocin, MDMA, DMT, MeO-DMT, THC, THC-O, and other tryptamines and related compounds that produce a classical psychedelic trips. Psychedelic drugs may be derived from plants (peyote cactus, cannabis), fungi (magic mushroom), and animals (e.g., amphibians) or synthesised using other precursor molecules. Any molecule with activity at the 5-HT 2A receptor is considered a supplement. Compounds considered a psychoactive drug, psychopharmaceutical, psychoactive agent, or psychotropic drug in the form of powder are considered supplements and include anxiolytics, benzodiazepines, Xanax, Valium, barbiturates, empathogen-entactogens, MDMA (ecstasy), MDA, 6-APB, AMT, stimulants, amphetamine, methamphetamine, methadone, caffeine, cocaine, nicotine, modafinil, depressants, sedatives, hypnotics, opioids, morphine, fentanyl, codeine, cannabis, barbiturates, benzodiazepines, hallucinogens, psychedelics, dissociatives, deliriants, psilocybin, psilocin, LSD, DMT (N,N-Dimethyltryptamine), ayahuasca, mescaline, Salvia divinorum, and scopolamine; cholinergics (acetylcholine receptor agonists), e.g., arecoline, nicotine, and piracetam; muscarinic antagonists (acetylcholine receptor antagonists), e.g., scopolamine, benzatropine, dimenhydrinate, diphenhydramine, trihexiphenidyl, doxylamine, atropine, quetiapine, olanzapine, and tricyclics; nicotinic antagonists (acetylcholine receptor antagonists), e.g., memantine and bupropion; adenosine receptor antagonists, e.g., caffeine, theobromine, and theophylline; dopamine reuptake inhibitors, e.g., cocaine, bupropion, methylphenidate, St John's wort, and certain TAAR1 agonists like amphetamine, phenethylamine, and methamphetamine; dopamine releasing agents, e.g., Cavendish bananas, TAAR1 agonists like amphetamine, phenethylamine, and methamphetamine; dopamine agonists, e.g., pramipexole, Ropinirole, L-DOPA (prodrug), memantine; dopamine antagonists, e.g., haloperidol, droperidol, and many antipsychotics (e.g., risperidone, olanzapine, quetiapine); dopamine partial agonists, e.g., LSD and aripiprazole; GABA reuptake inhibitors, e.g., tiagabine, St John's wort, vigabatrin, and deramciclane; GABAA receptor agonists, e.g., ethanol, niacin, barbiturates, diazepam, clonazepam, lorazepam, temazepam, alprazolam and other benzodiazepines, zolpidem, eszopiclone, zaleplon and other nonbenzodiazepines, muscimol, and phenibut; GABAA receptor positive allosteric modulators; GABA receptor antagonists, e.g., thujone, and bicuculline; GABAA receptor negative allosteric modulators; norepinephrine reuptake inhibitors, e.g., St John's wort, non-SSRI antidepressants such as amoxapine, atomoxetine, bupropion, venlafaxine, quetiapine, the tricyclics, methylphenidate, SNRIs such as duloxetine, venlafaxine, cocaine, tramadol, and certain TAAR1 agonists like amphetamine, phenethylamine, and methamphetamine; norepinephrine releasing agents, e.g., ephedrine, PPA, pseudoephedrine, amphetamine, phenethylamine, and methamphetamine; adrenergic agonists, e.g., clonidine, guanfacine, phenylephrine; adrenergic antagonists, e.g., carvedilol, metoprolol, mianserin, prazosin, propranolol, trazodone, yohimbine, and olanzapine; serotonin receptor agonists, e.g., triptans (e.g. sumatriptan, eletriptan), psychedelics (e.g. lysergic acid diethylamide, psilocybin, mescaline), and ergolines (e.g. lisuride, bromocriptine); serotonin reuptake inhibitors, e.g., most antidepressants including St John's wort, tricyclics such as imipramine, and SSRIs (e.g. fluoxetine, sertraline, escitalopram), SNRIs (e.g. duloxetine, venlafaxine); serotonin releasing agents, e.g., fenfluramine, MDMA (ecstasy), and tryptamine; serotonin receptor antagonists, e.g., ritanserin, mirtazapine, mianserin, trazodone, cyproheptadine, memantine, and atypical antipsychotics (e.g., risperidone, olanzapine, quetiapine); AMPA receptor positive allosteric modulators, e.g., aniracetam, CX717, and piracetam; AMPA receptor antagonists, e.g., kynurenic acid, NBQX, and topiramate; Cannabinoid receptor agonists, e.g., JWH-018; Cannabinoid receptor partial agonists, e.g., anandamide, THC, cannabidiol, and cannabinol; Cannabinoid receptor inverse agonists, e.g., Rimonabant; Anandamide reuptake inhibitors, e.g., LY 2183240, VDM 11, and AM 404; FAAH enzyme inhibitors, e.g., MAFP, URB597, and N-Arachidonylglycine; NMDA receptor antagonists, e.g., ethanol, ketamine, deschloroketamine, 2-Fluorodeschloroketamine, PCP, DXM, Nitrous Oxide, and memantine; GHB receptor agonists, e.g., GHB, and T-HCA; Sigma-1 receptor agonists, e.g., cocaine, DMT, DXM, fluvoxamine, ibogaine, opipramol, PCP, methamphetamine; Sigma-2 receptor agonists, e.g., methamphetamine; μ-opioid receptor agonists, e.g., codeine, morphine, hydrocodone, hydromorphone, oxycodone, oxymorphone, heroin, and fentanyl; opioid receptor partial agonists, e.g., buprenorphine; μ-opioid receptor inverse agonists, e.g., naloxone; μ-opioid receptor antagonists, e.g., naltrexone; K-opioid receptor agonists, e.g., salvinorin A, butorphanol, nalbuphine, pentazocine, and ibogaine; K-opioid receptor antagonists, e.g., buprenorphine; H1 receptor antagonists, e.g., diphenhydramine, doxylamine, mirtazapine, mianserin, quetiapine, olanzapine, meclozine, and tricyclics; H3 receptor antagonists, e.g., pitolisant; indirect histamine receptor agonists, e.g., modafinil; Monoamine oxidase inhibitors (MAOIs), e.g., phenelzine, iproniazid, tranylcypromine, selegiline, rasagiline, moclobemide, isocarboxazid, Linezolid, benmoxin, St John's wort, coffee, and garlic; melatonin receptor agonists, e.g., agomelatine, melatonin, ramelteon, and tasimelteon; Imidazoline receptor agonists, e.g., apraclonidine, clonidine, moxonidine, and rilmenidine; Indirect Orexin receptor agonists, e.g., modafinil; Orexin receptor antagonists, e.g., SB-334,867, SB-408,124, TCS-OX2-29, and suvorexant. Medicines and pharmaceuticals are considered supplements and may include efavirenz, metformin, baby aspirin, and rapamycin. Plant derived compounds, or synthetic variants of terpenes, terpinoids, polyphenols, stilbenoids, and flavonoids are considered supplements and may be derived or inspired from cannabis, although these compounds are found in many plants. Peptides are considered supplements and may include polypeptides, dipeptides, tripeptides, urotensin peptides, urotensin 2 peptides, somatostatins, cholecystokinin, oxytocin, peptides targeting the GLP-1 receptor (e.g., exenatide, liraglutide, lixisenatide, albiglutide, dulaglutide, semaglutide), peptides targeting the GLP-2 receptor (teduglutide), and peptides targeting the GC-C receptor (linaclotide). Supplements may also include mushrooms and their extracts such as those from Antrodia mushroom, Chaga mushroom, Cordyceps mushroom, King Trumpet mushroom, Lion's Mane mushroom, Maitake mushroom, Oyster mushroom, Reishi mushroom, Shiitake mushroom, Tremella mushroom and Turkey tail mushroom. Supplements may also include enzymes, polypeptide, NSAIDs, Ozempic, berberine, aspirin ibuprofen, spermidine, vitamin A, vitamin B12, vitamin C, vitamin D3, vitamin E, vitamin C, taurine, glycine, turmeric, beta alanine, 5-HTP, nootropics, sleep aids, tart cherry extract, paraxanthine, GABA, melatonin, probiotics, over-the-counter medicines/drugs/medications, prescription medicines/drugs/medications, plant-based medicine, anxiolytics, empathogen, zembrin, entactogen, stimulant, depressant, hallucinogen, saffserene, hyperzine A, biopharmaceutical, biosynthesized drug, biosynthesized compound, biosynthesized enzyme, biosynthesized peptide, antipsychotic, dissociative, deliriant, psychedelic, baby food powder, lysergic acid diethylamide, instant formula used for feeding babies, electrolytes, Meal Ready-to-Eat (MRE), L-theanine, L-citrulline malate, L-tyro sin, magnesium citrate, magnesium threonate, branched-chain amino acid (BCAA), L-tyrosine, MCT (medium chain triglyceride), DHA, pea syrup, Acacia confusa extract, lemon balm, biotin, boswellia, essential amino acid (EAA), amino acid, vitamin, fenugreek, lemon balm, kanna, kava, mineral, multivitamin, sports nutrition powder, botanical, jujube seed extract, live microbe, microbial compounds, yeast, bacteria, microalgae, herbs, nutraceuticals, neurotransmitters, hormone activators, hormones, carbohydrate, fiber, beta glucans, creatine, curcumin, theobromine, caffeine, phytocannabinoid, cannabinoid, cannabis-derived compounds, valerian, yerba mate, saffron extract, pectin, astaxanthin, goji berry, alpha keto-glutarate, alpha glycerophosphocholine, damiana, gemfibrozil, Urolithin A, nicotinamide mononucleotide (NMN), nicotinamide riboside (NR), nicotinamide adenine dinucleotide (NAD+), Alpinia galanga, CoQ 10, fish oil, peanut butter, Morus alba, Sceletium tortuosum, Rhodiola rosea, Ginseng, Acai, mulberry derived compounds, echinacea, passionflower, lemongrass, maca root, beet root, theacrine, coffee, alcohol containing powders, alcohol powder/powdered alcohol/dry alcohol (e.g., the produce “Palcohol”, with tradename “SureShot”, developed by Sato Foods Industries Co., Ltd., “ [symbol] [symbol] ”), teas, green tea, matcha tea, oolong tea, rooibos tea, butterfly pea flower tea, tisanes, herbal tea, Earl Grey tea, Chamomile, Yellow tea, White tea, Black tea, lactase, 1-tyrosine, and ashwagandha.

[b] Dissolution agents are defined here as anything added to the pod formula with the intention of (but not limited to) any of the following (whether individually or in any combination):
aiding in the breakup (mechanically and/or chemically) of clumps of solid supplements
increasing the overall solubility of the supplements in a given liquid solution
causing pod disintegration and/or pod dissolution and/or pod dissociation and/or pod particle dispersion
producing an effervescing effect in water (or any other liquid)
causing any change in state (i.e., between solid, liquid and gaseous states)

Dissolution agents include (but are not limited to) the following classes of components (whether individual or combined in any manner):
disintegrant(s) or superdisintegrant(s) [d]
organic acid(s) [e]
bicarbonate salt(s) and carbonate salts [f]
dispersants
branched-chain amino acids
creatine (e.g., creatine monohydrate, creatine ethyl ester, creatine hydrochloride, buffered creatine, liquid creatine, creatine magnesium chelate).

[c] Binding agents or binders are defined here as any agent(s) employed to impart cohesiveness to the supplements (solids, nanoparticles, nanopowders, etc.) or in any blends/mixtures (e.g., supplements only; supplements+additive) being formulated into the pod during wet or dry granulation (particles sticking together). Binding agents can be wet binders and dry binders. Binding agents ensure that the pod particles remain intact following compression. Natural, semisynthetic, or synthetic polysaccharides may be used as binding agents. Binding agent(s) may also be referred to as agglomeration agent(s) or agglomerates. Changing the temperature may be used to adjust the viscosity of the binder, while preparing in a solution or once the binder is mixed into the formula as to control the hardness of the pod (solidification process) or to increase or decrease the cohesion of the particles.

Examples of binding agent(s) may include (but are not limited to) individual or any combination of compound such as:
gellan gum
xanthan gum
calcium silicate
hydroxypropyl methylcellulose (HPMC)—a methylcellulose ether
hydroxypropyl cellulose (HPC)—a cellulose derivative with water and organic solvent solubility
Hydrated chia seeds, or their components, may be partially or fully hydrated for use as binders. Other seeds that show similar properties, e.g., dragon fruit seeds, may be used for the same binding purpose.
Pullulan, sorbitol, microcrystalline cellulose, dicalcium phosphate, maltodextrin, corn syrup solids, dextrose, sucrose, polyvinyl alcohol, polyvinyl pyrrolidone, sodium sulfate, lignin, polyvinylpyrrolidone, methacrylate-based binding agents
A liquid that activates the binding property of an additive

[d] Disintegrant(s) (or superdisintegrant(s)) are defined here as any agent(s) added to the pod formulas which promote the breakup of the solid, i.e., pod, into smaller fragments in any aqueous environment(s); or nonaqueous liquid environment(s); thereby increasing the available surface area of the pod as it breaks down and/or promoting a more rapid release of the supplements. Their actions work through promoting moisture penetration and/or expansion and/or dispersion of the pod formula and/or coating matrix. Combinations of swelling and/or wicking and/or deformation are mechanisms of disintegrant action (Remya et al., 2010).

Examples of disintegrant(s) include (but are not limited to) individual or any combination of compound such as:
sodium starch glycolate
croscarmellose sodium
Plant seeds that swell as they hydrate and/or produce a gel when hydrated (e.g., chia seeds and dragon fruit seeds).
May be of varying particles sizes
May be encapsulated to protect the particles/granules (prior to converting into the pod)
Includes effervescent ingredients, e.g., acids (e.g., organic acids like citric acid, acetic acid, malic acid, folic acid, and ascorbic acid) and bases (e.g., bicarbonate salts like sodium bicarbonate and potassium bicarbonate; carbonate salts like potassium carbonate and calcium carbonate). Acids and bases may be combined in a way, e.g., stoichiometrically balanced, to achieve a particular dissolving performance. Effervescent ingredients may also be used to enhance the smell and flavor as the fizziness can make the fragrance stronger than without.

[e] Organic acids are defined here as any organic compound with acidic properties. The relative stability of the conjugate base of the acid determines its acidity. Examples of organic acids include (but are not limited to) individual or any combination of acids such as:
citric acid, malic acid, tartaric acid, ascorbic acid, acetic acid, Citrocoat® N, fumaric acid, tartaric acid, succinic acid, adipic acid and lactic acid

[f] Bicarbonate salt and carbonate salt are defined here as any salts of carbonic acid. The bicarbonate ion being HCO₃⁻ (−1 charge) and carbonate ion being CO₃²⁻ (−2 charge). Examples of bicarbonate salts/carbonate salts include (but are not limited to) individual or any combination of compounds such as:
sodium bicarbonate, potassium bicarbonate, magnesium bicarbonate, calcium bicarbonate, ammonium bicarbonate, sodium carbonate, sodium sesquicarbonate, potassium carbonate, potassium sesquicarbonate, magnesium carbonate, calcium carbonate, calcium sesquicarbonate, ammonium carbonate

[g] An ‘amphipathic molecule’ is defined here as a chemical compound containing both polar (water-soluble) and nonpolar (non-water-soluble) portions in its structure, otherwise defined as a chemical compound having hydrophobic and hydrophilic regions. These may include for example hydrophobias, which are a large family of amphipathic/amphiphilic fungal protein(s) (˜100 amino acids) that are cysteine-rich. Within the fungus, these are extracellular surface-active proteins which fulfill a broad spectrum of functions in fungal growth and development (Valo et al., 2010). Whilst these naturally occur in fungi, they may be included in the definition and any same or similar protein derived from prokaryotic and/or bacteria and/or plant and/or animal source(s). Another example of an amphipathic molecule is casein, commonly derived from mammalian milk Late embryogenesis abundant (LEA) proteins are yet another example of amphipathic molecules.

[h] Pod is defined as compacted or encapsulated supplement particles, which includes supplements of any form, with or without additives, whether achieved via compression and/or encapsulation and/or any other means not mentioned here; including or excluding a coating. Other methods include extrusion, direct compression filler, non-direction compression filler, lower compression forming.

Pods may be further modified, e.g., adding a coating. Pods can weigh as much as 25,000 grams and be of any shape (e.g., capsule, sphere, tetrahedron, turtle, and cylinder (as to fit into a PET bottle or be sized to mimic a stick of chalk). Pods may be derived via segmentation of a compacted slab. Pods may include compacted pods, encapsulated pods, encapsulated-compacted pods, segmented pods, encapsulated-segmented pods, semi-encapsulated-segmented pods, and poly-pods.

Pods are (i) not similar to protein bars or energy bars or meal replacement bars, (ii) are not confectionary products and (iii) are not related to other products considered a convenience food that contain mostly whole foods and/or contain high water content. Pods consist of mostly dry particles, and are more similar to pharmaceutical tablets or nutraceutical tablets.

[i] Liquid or liquid solution are defined as any aqueous solution. This includes water or other liquid drinks/beverages, including, but not limited to, juices, teas, coffees, milks (animal milk and alternative milks including but not limited to soy, oat, and rice), soft drinks, fruit punch, energy drinks, non-alcoholic beers, alcoholic beers, and all other non-alcoholic and alcoholic drinks, etc. Beverages are anything in liquid form that can be consumed or drunk, and includes water. This covers any solution or suspension which may be consumed by humans and/or plants and/or microorganisms. Once a pod disintegrates/dissolves in a beverage, this newly created solution is also considered a beverage.

[j] Cannabinoid is defined as any single molecule which binds to one or multiple “cannabinoid receptor(s)” found in any animal and/or plant and/or microorganism (as agonists, antagonists, partial agonist, inverse agonist, or allosteric regulators). In addition, any molecules that have a structural similarity to phytocannabinoids from cannabis (e.g., THC and CBD) are also considered as cannabinoids, which may not show activity at cannabinoid receptors Similar molecules, from other plants, which have similar structural similarities to cannabis derived cannabinoids and/or show activity at cannabinoid receptors, are considered cannabinoids. Small peptides, pre propeptides, and propeptides, called pepcans (e.g., pepcan-12, RVD-hemopressin, and pepcan-23) are also considered cannabinoids.

[k] Cannabinoid receptors (or endocannabinoid receptor(s)) are defined as any naturally occurring protein or genetically modified protein which is now or may in the future come to be regarded in any peer-reviewed medical and/or scientific publication as an analog and/or homolog and/or ortholog and/or paralog, as the aforementioned “naturally occurring proteins” described above as “cannabinoid receptors.” For example:
Cannabinoid receptor 1 (CB1)
Cannabinoid receptor 2 (CB2)
Cannabinoid receptor-interacting protein 1a (CRIPa)
N-Arachidonyl glycine receptor (NAGly receptor; also termed G protein-coupled receptor 18; GPR18)
G protein-coupled receptor 55 (GPR55)
G protein-coupled receptor 119 (GPR119)
members of the transient receptor potential cation channel subfamily V (TRPV, e.g., TRPV1, TRPV2, TRPV3, TRPV4, TRPV5, TRPV8) members
Any other protein—unstated in this patent application—which is now or may in the future come to be regarded in any peer-reviewed medical and/or scientific publication and/or patent as a “cannabinoid receptor” or “endocannabinoid receptor”

[1] An additive is any ingredient added to a supplement, including all ingredients used to convert supplements into pods. Additives may be part of the formulation, manufacturing or post processing of pods. Additives may including, but are not limited to, ingredients that act as dissolution agents, excipients, binding agent/binder, acids (i.e., chemical used for decreasing pH), bases (i.e., a chemical for increasing pH), disintegrants, superdisintegrants, encapsulation, coatings, ingredients referred to as a pod ingredient, encapsulation shells, capsule component, dissolution agent, organic acid, bicarbonate/carbonate salt, effervescent ingredients, liquid solution, solvent, coating/coating agent (e.g., HPMC, HPC, LEA proteins, hydrophobia proteins, mochi flour), encapsulation ingredient, encapsulation component(s), wicking agents, wetting agents, diluent, thickener/thickening agent (mochiko (mochi) white flour derived from glutinous/sweet rice to mack mochi desserts), anti-caking agent, magnesium stearate, adhesion agent, cohesion agent, acidifying/alkalizing agent, aerosol propellant, antifoaming, antimicrobial preservatives, antioxidant, buffering agent, bulking agent (freeze-drying), chelating/sequestering agent, coloring, flavor, perfume, diluent, emulsifying agent (e.g., sucrose acetate isobutyrate), solubilizing agent, wetting agent, wax (e.g., non aqueous material, semisolid; examples include petroleum, paraffin, soy, plant rosin, polymer), glidant, anticaking agent, humectant, lubricant (e.g., polyethylene glycol, magnesium stearate, stearic acid, sucrose stearate, sodium stearyl fumarate, various silicone oils, vegetable oils, mineral oils and sodium benzoate), ointment/suppository base, plasticizer, resistant starches (cassava, cassava root, taro, taro root), gelatin, pectin, carrageenan, tapioca, alginate, cellulose, gellan gum, chitosan, (co)solvent, stiffening agent, suspending/viscosity-increasing agent, amphipathic molecule, cannabinoid, sweetening agent/sweetener, tonicity agent, filler, bulking agent, diluents, sorbents, absorbent materials, and vehicle. Supplements that may be used as additives include those that are highly water soluble that may be useful as a dissolution agent, (e.g., BCAA and creatine). Additives include common excipients. Still, additives, in many cases, have biological activity and are not always inert. Additives may be engineered to be more varied in physical properties (e.g., size), especially to improve or modify the pod's performance with respect to dissolution/disintegration/dissociation rate and/or strength. Additives may be encapsulated, e.g., microencapsulation of powders and granules. Additives may take all the same forms mentioned for supplements. Additives include the capsule component, which is a material that covers the outside of the compacted pod.

[m] A cannabis-derived compound(s) is any chemical(s)/molecule(s) found within the cannabis plant (e.g., Cannabis sativa, Cannabis indica, and Cannabis ruderalis), e.g., proteins, fibers, cannabinoids, terpenoids, terpenes, flavonoids, waxes, and lipids from the cannabis plant.

[n] Granulation is defined here as a process of binding smaller particles (e.g., powder) into larger particles called granules (sometimes called grains). This includes at least wet granulation methods and dry granulations methods.

[o] Granule is defined here as any particle formed by the progressive enlargement of primary particles via granulation or other methods. Granules made through granulation may vary in size, e.g., 200 micrometers to 4 millimeters. Granules also include crystals in the same size range, e.g., table sugar in the form of sugar crystals is called granulated sugar or sugar granules. Granules may also include any particles larger than dust or powder consisting of a single type of ingredient (e.g., whey proteins) or multiple types of ingredients (e.g., whey proteins+organic acid).

[p] Pellet is defined here as any particle formed by compactions of smaller particles (e.g., powders, granules, fibers, flakes) into particles that can be larger than granules, but still overlap in size. Thus, pellets are similar to granules, but can be larger. The size of pellets vary, e.g., 0.3-10 millimeters. Pellets use processing like balling, compression, and spray congealing. Pellets are commonly spherical or cylindrical in shape and are common in the pharmaceutical, food, and animal feed industries. Spheronization is a technique used to manufacture pellets, and has applications in pellets designed for controlled release, multi particulate systems, sustained release polymer coats, and enteric coats.

[q] Capsule component is defined here as any material that goes on the outside of a pod and/or creates a vessel for holding supplements. A compacted-pod would fit inside one or more capsule components. An encapsulated pod could be created by filling one or more capsule components with supplements of varying particle sizes, e.g., a single capsule component that is flexible and then filled with a supplement of varying particles. A “capsule component” can be a standalone piece that is cleaned and refilled with supplement particles. In addition, a capsule component can be a closed vessel that is filled with supplement particles, either through piercing the outside of the capsule component for filling with supplement particles or through filling the capsule component with supplement particles and sealing. A capsule component(s) containing a pod or formula may be designed to open up when put into water/liquid, e.g., through a mechanism that pops the capsule component(s) open to allow the pod and/or supplements to be hydrated. A capsule component(s) containing a pod or formula may be designed to open up when shaking it in a shaker bottle, e.g., through a mechanism that pops the capsule component open when agitated through the shaking force.

[r] Coating is defined here as any layer of material added to a pod. Coatings may be of edible and non-edible materials. This may include a protective layer, packaging, encapsulation components, capsule components, and spray coatings. Coating may also include materials that are added to the outside of the pod, which then seep into the pod, e.g., using citric acid solution (citric acid dissolved in liquid) can be used to coat the pod, of which some percentage of the coating will be absorbed into the pod. Coatings may be used to strengthen or protect the pod as to reduce damage. Coatings may be used to add flavor, color, texture, or other chemicals (e.g., medications, additional supplements, drugs or cannabinoids) to the pod. Coatings may include supplements, chocolate, HPMC, HPC, citric acid, wax, rice derived compounds, proteins, and sugar. Coatings may also be added to pods in dry form, such as rolling a pod in a powder to create a powder coating. Particles requiring precision and accurate dosing (e.g., API) may be dissolved into a solvent and added dropwise to the surface of the pod as part of the coating process. The coating may be further modified, e.g., perforating the coating may be performed (e.g., using lasers or mechanical methods such as poking holes through the coating/pod), which may be used to increase solubility of the pod. Coatings may be applied by dipping the pod into coating, spraying the pod, and other methods that use photopolymerization, chelation, and vapor deposition.

[s] Encapsulate or encapsulated are defined here as any method to cover loose particles or a pod or a slab. As it relates to loose particles, this means the particles are added to, or encapsulated by, one or more capsule components. For clarity, consider adding particles into the halves of a plastic easter egg, then closing them. The easter egg would act as the capsule components, and the pod itself would be encapsulated. Thus the particles are packed, but not compacted, in this example. Still, softer/flexible materials, and edible materials, can be used to encapsulate pods or particles (uncompacted). A compacted pod or a segmented pod or a slab may also be encapsulated using one or more capsule components

[t] Encapsulated particles are defined here as covering individual particles, such as powder or granules, as to protect them. Individual particles may be supplements and/or additives. This may be to reduce unwanted chemical reactions during manufacturing (e.g., see the ingredient Citrocoat® N). Encapsulated particles may also be used to enhance solubility, improve compaction processes, and/or aid in manufacturing processes, e.g., flowability. Common methods include microencapsulation or nanoencapsulation of particles.

[u] Particle is defined here as an object with physical properties. Physical properties may include, but are not limited to size, volume, weight, density, porosity, texture, shape, cohesiveness, and morphology (form, shape, size, and structure). Examples of particles include, but are not limited to, dust, powder, granulated powder, granule, crystal, flake, fiber, pellet, and slug, which may or may not be in solution.

[v] Particle layer or layer is defined here as an arbitrary size range in a PSD. The particle layer is arbitrary because sieves, and other methods for sorting particles by physical properties, vary depending on the equipment available. Particle layer is easily visualized when viewing a histogram of PSD data based on sieving methods. Terms used synonymously with particle layer include particle size range, interval, size class, fraction and section.

[w] Layer removal is defined here as removing one or more particle layers. Various techniques and/or tools and/or devices and/or equipment may be used to remove a particle layer(s). For example, using sieves, one or more layers can be removed, e.g., 50 micron range or 100 micron range or 150 micron range or 200 micron range or 250 micron range, or 300 micron range or 350 micron range or 400 micron range or 450 micron range or 500 micron range or 550 micron range or 600 micron range or 650 micron range or 700 micron range or 750 micron range or 800 micron range or 850 micron range or 900 micron range or 950 micron range or 1000 micron range, etc. As a clear example, if a PSD showed particles ranging from 50 microns to 800 microns, a 100 micron range could be removed from particle size 300-400. Thus, the remaining particles would be 50-299 microns and 400-800 microns.

[x] Varying particle size(s) is defined here as a blend of particles that are non-uniform in size, as shown in a PSD curve. This is in contrast to being fairly homogeneous and/or uniform in size (normal distribution curve) as is recommended for standard tablet compactions, especially effervescent tablet manufacturing. Particles described as being “varying particle sizes” may include, (i) particles having a gap (e.g., 100-500 microns) in the PSD; (ii) particles having a bimodal and/or multimodal PSD; and (iii) particles having a total range exceeding 1000 microns that are highly skewed (e.g., positively skewed). Varying particle size can be achieved in a variety of way, including but not limited to:
Combining at least two supplement powders with varying d50s.
Combining at least two supplement powders with varying modes.
Combining at least two supplement powders with varying major peaks as shown in a PSD.
Removing one or more layers from at least one type of particle to create a gap in the PSD.
Removing a portion of particles from the particle size layer(s) with the highest percentage within a sample as to reduce homogeneity of the sample, e.g., reducing the peak height of a PSD.
Resizing a particle layer (all or portion of the particle layer) and redistributing it so as to increase non-uniformity in particle size.

[y] Compacted slab or slab is defined here as particles compacted into a large object, especially one that is flatter in one plane. The slab may be segmented further into pods, e.g., using a cutting tool or water jet. As an analogy, a whole pizza would be the slab, and the individually cut slices would be the pods.

[z] Loosening effect, a particle packing theory, is defined here as the disturbance on the arrangement of coarse particles by fine particles which leads to a lower packing density and leads to a lower sintering ability of powder.

[aa] Wall effect, a particle packing theory, is defined when fine particles are dominant and the size of the coarse particles are much larger than the fine particles. The surface of the coarse particle seems like a wall to fine particles. The voids caused by the ‘wall’ between coarse particles and fine particles are larger than the voids between fine particles. This so-called wall effect, the interaction between coarse particles and fine particles, also decreases the packing density.

[bb] Dissolve/dissolution is the process of particles (e.g., molecules) separating from one another due to the pull of a solvent, e.g., adding glucose particles in water. The molecules become part of a solution (uniform solution), without any visible small fragments remaining (as observed by the naked eye); suitable for a chemical test, e.g., analytical analysis instrument like HPLC. Note that dissociate/dissociation is the separation of ions that occurs when a solid ionic compound dissolves, e.g., adding NaCl in water. To avoid using the terms separately, dissolve/dissolution and dissociation/dissociation, dissolve/dissolution will be used to describe both in this application.

[cc] Disintegrate/disintegration is the process of breaking down larger fragments into smaller fragments, such as a tablet/pod breaking down into smaller particles; suitable for a physical test like the mesh method of analysis.

### Exemplar Applications and Configurations

The following are examples of methods and application configurations that may form embodiments of the present invention.

A method of converting existing supplements into a pod. The pod may or may not contain dispersal mechanism(s) to aid dissolution into any liquid. The method comprising:
one or more nutrient(s)
one or more supplement(s)
one or more additive(s)
addition of any dissolution agent(s), whether alone or in combination [b]
compaction into unit(s) of any shape or size
encapsulation into unit(s) of any shape or size; whether fully or partially
encapsulation of supplements into unit(s) of any shape or size without compaction;
addition of an optional protective coating

In this method, the dissolution agent may be one or more disintegrant(s) (or superdisintegrant(s)) as per definition [d]; may be one or more organic acid(s) as per definition [e]; may be one or more bicarbonate salt(s)/carbonate salts as per definition [f]; may be one or more binding and/or agglomeration agent(s) as per definition [c]; may comprise one, all or any combination or all of the dissolution agents; or additional dissolution agents or ingredients.

In alternative embodiments, the addition of a water-soluble or water-insoluble coating may be employed.

In alternative embodiments, a pod that is dissolved/disintegrated in water (or a beverage) includes ingredients that do not affect the final pH. It is known that humans can easily detect subtle differences in the pH of beverages, such as in coffee, tea and wine. Thus, the inclusion of effervescent ingredients (organic acids and bicarbonate salts/carbonate salts) can be adjusted in a way that does not affect the final beverage's pH created when dissolving the pod.

In alternative embodiments, a pod can be dissolved/disintegrated in any beverage considered milk (animal or plant derived). Such a pod may include protein particles, e.g., whey, soy, pea, hemp, oat, rice, insect, and/or other animal or plant derived proteins.

In alternative embodiments, one or more supplements may be encased in hydrophobin(s), and/or any other amphipathic molecule(s) i.e., soy lecithin as per definition [g]; whether processed afterwards (e.g., freeze-dried) or not; also, one or more supplements may be in any nano and/or microemulsion(s); also, one or more supplements) may be in any nano and/or microemulsion and freeze-dried; also, one of more of the included supplements may be a coffee, coffee extract, tea and/or tea extract.

Pods may be designed for consumption by any living organisms (e.g., drinking) For example:
Pods may be put into liquid solutions. Equally, liquid solutions may be added to pods to dissolve and/or suspend them;
When the pod is dropped/placed into any liquid; it is soluble and dissolves/disintegrates, and/or else forms a suspension, with or without agitation from a mixing tool (e.g., spoon);
When the pod is dropped/placed into liquid solutions; it partially dissolves/disintegrates or suspends, with or without agitation from a mixing tool (e.g., spoon);
When liquid solutions are poured onto the pod; it is soluble and dissolves/disintegrates, or else forms a suspension, with or without agitation from a mixing tool (e.g., spoon);
When liquid solutions are poured onto the pod; it partially dissolves/disintegrates or suspends, with or without agitation from a mixing tool (e.g., spoon).

These pods may be soluble in liquids, and/or form suspension(s), and can be used for absorbing topically or internally of organisms (animals, plants, fungi or microorganisms), whether living, deceased, or nonliving, or never considered to be alive. For example:
When the pod is dropped/placed into liquid; it is highly soluble and dissolves/disintegrates, and/or forms suspension(s), with or without agitation from a mixing tool (e.g., spoon).
Pods may be put into liquid solutions for soaking and/or cleaning skin (e.g., a ‘bath bomb’) or into other liquid solutions to soak or clean hair or fur.
When the pod is dropped/placed into liquid solutions; it is highly soluble and dissolves, and/or suspends, with or without agitation from a mixing tool (e.g., spoon).
When the pod is dropped/placed into liquid solutions; it partially dissolves, and/or suspends, with or without agitation from a mixing tool (e.g., spoon).
When liquid solutions are poured onto the pod; it is highly soluble and dissolves, and/or suspends, with or without agitation from a mixing tool (e.g., spoon).
When liquid solutions are poured onto the pod; it partially dissolves, and/or suspends, with or without agitation from a mixing tool (e.g., spoon).

These pods may be soluble in liquids, and/or form suspension(s), and may be used for killing organisms or used to enrich objects/materials (e.g., soil).

When the pod is dropped/placed into liquid solutions; it is highly soluble and dissolves/disintegrates, and/or forms suspension(s), with or without agitation from a mixing tool (e.g., spoon). For example:
When the pod is dropped/placed into liquid solutions; it partially dissolves, and/or forms suspension(s), with or without agitation from a mixing tool (e.g., spoon).
When liquid solutions are poured onto the pod; it is highly soluble and dissolves, and/or forms suspension(s), with or without agitation from a mixing tool (e.g., spoon).
When liquid solutions are poured onto the pod; it partially dissolves, and/or forms suspension(s), with or without agitation from a mixing tool (e.g., spoon).

These pods may be created using above-noted methods using pressure of 0.1 mPa or greater during the compaction process.

These pods may be created using above-noted methods in any type of mold, including, but not limited to, molds fabricated from plastics (including, but not limited to PLA, ABS, and PET), bio-fibers, carbon fiber, bio-composites, ceramics, metals (including, but not limited to, aluminum, stainless steel, alloys, magnesium, and copper alloys), silicones, naturally occurring polymers, or semisynthetic/synthetic polymers. The 3-piece mold design described in FIGS. 23-25 is part of this invention, namely, as a process step. The 3-piece mold design is sufficient, but is not the only type of mold system that can produce pods.

These pods may be created using the above-noted methods, using molds made from cutting into a larger starting material (e.g., a rectangular aluminum slab) to generate the desired shape using tools/instruments such as, but not limited to, a laser cutter, etcher, a CNC machine or a water jet cutter.

These pods may be created using the above-noted methods, using molds made from building the desired mold shape using a 3D printer or injection molding.

These pods may be created using the above-noted methods, namely, using any type of mold of any shape (including, but not limited to, molds constructed of metals, plastics, or silicon) using pressure to cause compaction including, but not limited to, in the form of mechanical pressure, air pressure, fluid pressure, vacuum pressure and/or electrostatic pressure.

In alternative embodiments, methods exist for measuring the dissolution and/or disintegration of tablets. Dissolution apparatuses and disintegration equipment are used to study in vitro release of drugs in order to predict their in vivo behavior. The U.S. Pharmacopoeia has defined multiple types of dissolution apparatuses (baskets, paddles, reciprocating cylinders, flow through cells, paddle over disk types, cylinders, and reciprocating holders) and at least one disintegration test that utilizes three baskets, with mesh bottoms, and a 37° C. water bath. Additional methods have been described by Oliveira et al. (2020) for assaying dissolution and/or disintegration of effervescent tablets, such as the spectrophotometric and titrimetric methods. Using commercially available equipment for dissolution and/or disintegration is expensive, challenging to set up, involves lots of parts that can break, and requires bench/tabletop space. These techniques, apparatuses and equipment have known drawbacks. Such methods may be useful for effervescent tablets, however, such methods do not collect data at a fast enough rate, or with enough precision, as to sufficiently determine the effect of (1) manipulating physical properties of particles, e.g., supplements particles and additives particles; and/or (2) manipulating parameters of compaction. To address the challenges of measuring dissolution and/or disintegration of tablets, especially effervescent tablets, the present invention further discloses a new method that analyzes the sounds produced during effervescent reactions.

The sound is recorded using a hydrophone, which is then correlated to the visible change in the effervescent tablet/pod (e.g., using high speed video recordings of the tablet/pod from multiple angles). Other measures may be used and/or incorporated, e.g., changes in the pod's weight and/or volume, amount of particles dissolved/disintegrated in solution, changes in the solution's pH as the pod dissolves/disintegrates, etc., as to improve the correlation model. After establishing a modeled curve, sound alone may be used as the predictor of dissolution/disintegration rate. Use of a hydrophone to record sounds as an analytical method of measuring rate of dissolution/disintegration of effervescent tablets or pods is novel for this industry. This aspect of the invention may serve as an important quality control instrument, especially for companies that manufacture effervescent tablets and/or for companies that manufacture manufacturing equipment to manufacture effervescent tablets. The benefits over existing methods/equipment/apparatuses include: providing unique multidimensional data type; data with high precision and accuracy with respect to rate of change in the dissolution/disintegration; a hydrophone is a small device, that can be easily wrapped up and stored in drawer or container; a hydrophone has no moving parts and simply plugs into a recording device; safer because it does not get hot when using and is not sharp; may be cheaper (<1000 USD), and analysis software may be downloaded for updates.

In alternative embodiments, decreasing the density of a compacted pod may be achieved following compaction via the creation of holes and/or pores into the pod. Methods may include, but are not limited to, blasting other particles through or into the pod, using lasers to create holes into or through the pod, using precision liquid streams to create holes into or through the pod, and/or using tools/tooling to create holes into or through the pod (e.g., drilling or piercing with one or more needle-like objects). Decreasing the density of the compact through these methods can aid in dissolution as it allows liquids, such as water or a beverage, to penetrate deeper into the compacted pod and start the dissolving/disintegration process from within and outside the pod. This is in contrast to the pod starting the dissolution/disintegration process from only the outer pod surfaces. In addition, holes may be made the appropriate size, which allows liquids (e.g., water) to be wicked into the central portions of the pod allowing the pod to dissolve/disintegrate faster, e.g., from swelling and/or starting an effervescent reaction within the pod. Such holes may also create more surface area for dissolution/disintegration to occur.

In alternative embodiments, dissolution agents (e.g., effervescent ingredients), are concentrated in the center of the tablet with a small hole, or holes, channeling to the outer surface. Upon contact with water, the dissolution agents would enter into the hole(s) and begin dissolving, causing the tablet to break/burst open. Such a pod may move around/be propelled (similar to rocket propulsion) when the pod is put into a liquid (e.g., water or beverage).

In alternative embodiments, dissolution agents (e.g., effervescent ingredients) may be unevenly distributed in the tablet, potentially enhancing the user experience. For example, one end of the pod may contain more of the effervescent ingredients causing the compact-pod to dissolve in a way that results in the pod moving around the surface of a beverage (e.g., water), or bobbing motion within the beverage.

In alternative embodiments, pods may be formulated to have an endothermic reaction in a liquid, resulting in a colder liquid. For example, a cold beverage may be desired. This is commonly achieved by using a refrigerator, cold incubator, cold pack, and ice, among others. Another unique feature of the pod is its ability to decrease a beverage's temperature (e.g., water). This is achieved by adding ingredients to the pod which react with each other as they dissolve and/or react with a liquid (e.g., water) resulting in an endothermic reaction, thus decreasing the liquid's temperature. Such a pod may also be used to deliver supplements to a liquid and/or flavor a liquid (e.g., water).

In alternative embodiments, pods may be formulated to have an exothermic reaction in a liquid, resulting in a warmer/hotter liquid. For example, a warm beverage may be desired. This is commonly achieved by using heating devices/appliances (e.g., convection oven, induction oven, warm incubator), boiling water, using fire, and using the sun, among others. Another unique feature of the pod is its ability to increase a beverage's temperature (e.g., water). This is achieved by adding ingredients to the pod which react with each other as they dissolve and/or react with a liquid (e.g., water) resulting in an exothermic reaction, thus increasing the liquid's temperature. Such a pod may also be used to deliver supplements to a liquid and/or flavor a liquid (e.g., water).

In alternative embodiments, pods are formulated to contain ingredients that make the mouth watery when eaten directly. For example, dissolving/disintegrating the pod into water is easy to consume by drinking. However, a pod developed for eating only (or one that has dual purpose of eating and drinking) should contain ingredients that cause the mouth to water as to make eating them easier and more desirable; and/or contain ingredients that avoid leaving the mouth dry when eating the pod.

In alternative embodiments, pods may be manufactured using extrusion methods, opposed to compaction. Supplement formulas, with varied particle sizes, can be extruded through a nozzle to create a physical self-holding shape and/or fill a space, e.g., an empty capsule or mold. Following extrusion, the supplement formula may become hard, become a gel-like material, and/or be in a liquid form. Supplement formulas may be used with 3D printing technologies to manufacture pods. Supplement formulas may be extruded into an edible capsule as part of the manufacturing process. Supplement formulas may be extruded into a mold, akin to injection molding. Supplement formulas may be extruded onto a flat surface as part of the manufacturing process.

In alternative embodiments, pods may be made into long, cylindrical shapes, which may be further segmented. Such pods may be made using extrusion methods, such as being passed through a hollow cylinder (e.g., pipe) to take shape and/or made in a mold using compaction methods and/or made using encapsulation methods and/or made using a gelation method (followed by dehydration). Long cylindrical shaped foods are attractive to consumers as they are easy to eat or easy to fit into a water bottle mouthpiece for dissolving. Such pods may appear as a stick of chalk.

In alternative embodiments, pods may be made of particles created using a hot melt extrusion method. This method is useful for non-water soluble compounds and pharmaceuticals. It may also be used for supplement particles and/or additive particles (regardless of solubility) as a means of generating novel particle sizes and unique formula blends. For example, (a) organic acids and supplements could be combined, extruded and converted into particles (e.g., pellets and/or granules) and (b) bicarbonate/carbonate salts and supplements could be combined, extruded, and converted into particles (pellets and/or granules). These two particle types (a and b) could then be used for making pods.

In alternative embodiments, particles used to make pods may include bits of whole fruit/vegetables/other plant matter, seeds, and other food materials (e.g., particles<5 mm). These are especially useful for creating a larger particle size range. This is because web granulating supplement powders (e.g., whey protein, soy protein, collagen peptide) to over 1 mm size is challenging and costly. Bits of fruit are also especially useful for manipulating the pod's density, as most fruits that are dehydrated are light in weight (or mass) for a given volume. Plant seeds may be used to modify a pod's performance, such as gelling effect (e.g., dragon fruit seeds and chia seeds) which may aid in particle dispersion, and/or selecting seeds that float, which aid in making a pod that floats. Pods may include particles as large as 5 mm in diameter, although larger sizes may also be acceptable. Standard effervescent tablets do not contain particles over 1 mm Note, pods made with such materials are distinct from bars (e.g., meal replacement bars and protein bars), which contain higher water content and are meant only for eating, not dissolving/disintegrating.

In alternative embodiments, encapsulation of supplements may be accomplished using one or more capsule components, which may consist of a variety of edible and inedible materials and/or water soluble and water insoluble materials. Capsule components can be designed in a way that, when a pod is put into a cup of water, the capsule components fall away from the supplement particles, leaving the supplement particles to dissolve; and the capsule component(s) sink to the bottom of the beverage, where they dissolve or remain in the cup. Encapsulation may include capsule components made of metals. Note, this is distinct from the whisk ball. For example, formulated supplement particles are put into a metal capsule component to create an encapsulated pod. Once the encapsulated pod is put into water, the pod has a mechanism that reacts with water to allow the pod to open up, allowing water to come in and dissolve the formulated supplement particles; the mechanism for the pod opening in water may be temperature dependent. Alternatively when the encapsulated pod is put into a shaker bottle, the act of shaking the encapsulated pod triggers a mechanism that opens the pod, allowing water to come in and dissolve the formulated supplement particles. Encapsulated pods may have two or more dividers/chambers to separate different formulated supplement particles and/or supplement particles and/or additives. Such separation allows for particles to be separated due to unwanted interactions and/or may have a timed release of the particles into the water, allowing one type of particle(s) to dissolve/exit the pod first, before another.

In alternative embodiments, pods may be made into a gel-like material. The compaction and/or encapsulation of particles varying size have been described for making pods, and gelation methods may be used as well. Such gelation methods result in a pod, made from particles of varying physical properties, including supplement particles and/or additive(s). Such pods may effervesce when put into water. Gelation is the process of polymers (or monomers) forming links to form larger polymers. As the links increase in number, gel formation occurs. Gelation methods may include ion-induced (ionotropic), chemical crosslinking, pH-induced, temperature induced sol-gel transition (thermotropic or cryo-gelation), non-solvent induced phase separation (NIPS), polymer based hydrogels obtained with ionotropic gelation and/or chemical crosslinking Additives that impart gel-like properties may include gelatin, pectin, carrageenan, tapioca, alginate, cellulose, gellan gum, chitosan or resistant starches. Resistant starches may include forms, such as solid particles and liquids. Gelation may be triggered with heating or cooling depending on the type of gelation formula and method used. Gelling agents may be used to create gels, which may be supplements or additives. Such pods may incorporate the methods described in other parts of this specification, e.g., the compaction method, the encapsulation method, the segmentation method, or a combination of at least two of these methods. The pod may also be formed using extrusion methods. The resulting pods have elasticity similar to a bouncy ball or gummy bear candy. The final step for the pods is dehydration as the final pod should be dry.

These pods may undergo biochemical and/or chemical reactions as part of the manufacturing process. These pods may be inoculated with microbes, which may be grown to produce desired nutrients and small molecules. For example, yeast may be formulated in a gel matrix and then converted into a pod. The pod may then be maintained under ideal growth conditions for the yeast (e.g., specific temperature, fed specific nutrients, and maintained in an environment that protects the yeast from other unwanted microbes/microbial growth), which express novel proteins and peptides (e.g., sweet proteins and sweet peptides for sweetness). Such proteins and peptides may remain within the yeast, or excreted from the yeast into the pod, or out of the pod and into the growth media. Pods containing microbes may need to be smaller to optimize microbial growth, and/or microbial metabolism. Microbial growth may be stopped as part of the manufacturing process, e.g., heating, autoclaving, or freezing the pod. The final step for the pods is dehydration as the final pod should be dry.

In alternative embodiments, a pod using the compaction method includes gelling agents as dry additives. When the compacted-pod comes in contact with water, e.g., the compacted-pod is dipped into water, the compacted-pod transforms into a jelly-like pod. This jelly-like pod may then be consumed. The mechanism may include a compacted pod wicking up a liquid (e.g., water), then the liquid reacts with the gelling agents to undergo a gelation reaction, becoming a jelly-like pod.

In alternative embodiments, a pod containing gelling agents (which may be considered supplement particles and/or additive particles) may be formulated to convert an aqueous solution into a gel once dissolved in water (or other liquid). For example, a formula consisting of protein particles, additive particles, dissolution agents (e.g., effervescent ingredients), and gelling agent(s) are converted into a pod. The pod is then put into a cup of water. As the dissolution agents (e.g., effervescent ingredients) react in water, the protein and gelling agents are dispersed throughout the cup. The solution then becomes a gel. This gel may then be consumed, or fed to an animal. The entire gel may be separated from the cup (would have taken the shape of the cup) and further segmented through cutting with a knife or other utensil.

In alternative embodiments, granulation may be used to vary physical properties like particle size. One way described was to combine supplement particles (of varying sizes), with additive particles (of near uniform size), to create a formula. A second way described was to combine supplement particles (of near uniform size) with additive particles (of varying sizes), to create a formula. For both, three methods were described for engineering particles to be more varied in size, namely, layer removal, combination, and redistribution. A third way would be to combine supplement particles (of near uniform size) with additive particles (of near uniform size) to create formula, then granulate the formula (e.g., in multiple separate batches) to create granules of varying sizes. Granulation methods (wet or dry) can be optimized to create varying particles (varying particle size) in a single granulation step process, or in a multistep process. For example, granulation could produce small and large particles with minimal intermediate sizes, or granulation could produce low and high dense particles with minimal intermediate densities, etc.

In alternative embodiments, pods may be developed for space travel. Astronauts exercise a lot in space and therefore need more dietary protein for adequate muscle and tissue recovery. For example, living in outer space requires strenuous daily exercise to maintain earthling-like bone density, muscle mass, and vascular health. On earth, protein shakes are consumed to aid in recovery from exercise. Ready-to-drink protein shakes do not require any prep work, but are quite heavy (already hydrated) and must be refrigerated to maintain the shelf life, and thus not ideal for space travel. Protein powders appear to be the better option since they are lighter (per gram of protein) and do not require refrigeration, although they do require preparation. Unfortunately, protein powders are messy on Earth and thus are not space-friendly either (for astronauts or for future space travelers). Pods are strong enough for space travel, have a stable shelf life given the low water content, and are mess free in addition to being highly soluble when placed into water.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method of converting particles into a pod, wherein the particles include a plurality of particle types having a particular size distribution, and each particle type includes a plurality of particle layers, comprising:
removing at least one particle layer from a first particle type to create a gap in the particle size distribution to form a modified first particle type, wherein the modified first particle type makes up at least 50% of the pod by dry weight;
combining the modified first particle type with a second particle type to create a formula; and
compacting the formula into a pod.

2. The method of claim 1, further comprising coating the pod.

3. The method of claim 1, wherein the first particle type is a supplement.

4. The method of claim 3, wherein the supplement is a protein powder.

5. The method of claim 1, wherein the second participle type is an additive.

6. The method of claim 5, wherein the additive is an effervescent ingredient.

7. The method of claim 1, wherein the size gap created by the particle layer removed from the first particle type is between 50 and 800 microns.

8. A method of converting particles into a pod, wherein the particles include a plurality of particle types having a particular size distribution, comprising:
combining a first particle type with a second particle type to create a first formula, wherein the first formula has a bimodal or multimodal particle size distribution and makes up at least 50% of the pod by dry weight;
adding a third particle type to the first formula to create a second formula; and
compacting the second formula into a pod.

9. The method of claim 8, further comprising coating the pod.

10. The method of claim 8, wherein the first and second particle types are a supplement.

11. The method of claim 10, wherein the supplement is a protein powder.

12. The method of claim 8, wherein the third participle type is an additive.

13. The method of claim 12, wherein the additive is an effervescent ingredient.

14. A method of converting particles into a pod, wherein the particles include a plurality of particle types having a particular size distribution, and each particle type includes a plurality of particle layers, comprising:
removing at least one particle layer from a first particle type to create a gap in the particle size distribution to form a modified first particle type, wherein the modified first particle type makes up at least 50% of the pod by dry weight;
resizing the particle layer to create a second particle type;
combining the modified first particle type with the second particle type to create a first formula;
combining the first formula with a third particle type to create a second formula; and
compacting the second formula into a pod.

15. The method of claim 14, further comprising coating the pod.

16. The method of claim 14, wherein the first and second particle types are a supplement.

17. The method of claim 16, wherein the supplement is a protein powder.

18. The method of claim 14, wherein the third participle type is an additive.

19. The method of claim 18, wherein the additive is an effervescent ingredient.
